(19) United States
(12) Patent Application Publication
(10) Pub. No.: US 2026/0330244 A1
(43) Pub. Date: Oct. 22, 2026

(54) Batched Tiling Execution of a Neural Network

(71) Applicant: Imagination Technologies Limited, Kings Langley (GB)

(72) Inventors: Javier Sanchez Bustamante, Hertfordshire (GB); Mario Camillo, Hertfordshire (GB); David Hough, Hertfordshire (GB); Xiran Huang, Hertfordshire (GB)

(21) Appl. No.: 19/552,189

(22) Filed: Feb. 27, 2026

(30) Foreign Application Priority Data
Feb. 28, 2025 (GB) 2502933.1
Feb. 28, 2025 (GB) 2502934.9
Feb. 28, 2025 (GB) 2502935.6

(51) Int. Cl. G06N 3/10; G06N 3/063

(52) U.S. Cl. CPC G06N 3/10; G06N 3/063

(57) ABSTRACT

Methods of evaluating neural networks and hardware implementations of neural networks are disclosed for the efficient processing of batches of input data through neural networks. A method and hardware implementation are disclosed for evaluating a neural network comprising at least a first and a second tile group. The method comprises storing parameter data for the first tile group in a low-cost memory, using the parameter data to process a first instance of the input data through the first tile group and re-using the parameter data to process a second instance of the input data through the first tile group.

### CROSS-REFERENCE TO RELATED APPLICATIONS AND CLAIM OF PRIORITY

This application claims foreign priority under 35 U.S.C. 119 from United Kingdom patent application Nos. GB2502933.1, GB2502934.9 and GB2502935.6, each filed on 28 Feb. 2025, the contents of which are incorporated by reference herein in their entirety.

### TECHNICAL FIELD

This application relates to hardware implementations of a neural network and methods of processing batches of input data through a neural network.

### BACKGROUND

The use of tiling to implement neural networks enables neural networks to be evaluated by multiple cores in parallel more efficiently.

Input data for neural networks can be a multidimensional tensor having the form [C, S₁, S₂], where C is the channel dimension and S₁, S₂ are the spatial dimensions of height and width (also labelled as H, W). Either of S₁ or S₂ can be used to refer to height or width, respectively. An example of input data having this form is image data, which can have pixels distributed across the height and width dimensions and can contain three colour channels (RGB).

Existing methods of evaluating neural networks involve defining layer groups and tile groups that contain the layers of a neural network. A layer group is a set of one or more consecutive layers of the neural network that have been grouped together. A set of layers is chosen to be grouped into a layer group if that set of layers can be evaluated without needing to write any intermediate data to memory. Intermediate data is the data produced by evaluating the first layer of the layer group up to (and including) the penultimate layer of the layer group. This intermediate data is input data for a subsequent layer of the layer group. The output of the final layer of the layer group is not intermediate data, because it is not input data for another layer in the layer group. As input data is processed through the layer group, the resultant intermediate data remains in the neural network pipeline, passing directly from one processing element to another until the layer group has been evaluated in its entirety. The output data for the layer group is stored in an on-chip memory and read later, to be used as input data for a subsequent layer group of the neural network.

A tile group refers to a set of one or more consecutive layer groups that have been grouped together. The layer groups of a tile group are chosen such that the output data of the layer groups (that is, the output data of each layer group other than the final layer group of the tile group) is sufficiently small that it can be stored on an on-chip memory and then read as input data for a subsequent layer group in the tile group. In other words, the intermediate output data produced during the evaluation of the tile group is held on-chip and is not written to an external memory (such as a DDR). The output of the tile group (that is, the output produced by the final layer group of the tile group) is stored in external memory and read later, to be used as input data for a subsequent tile group. Typically, as many layers are grouped into a layer group as is possible, and as many layer groups are grouped into a tile group as possible, to reduce the bandwidth consumed by accessing memory devices (and in particular, external memory).

In some situations, it is necessary or advantageous to process batches of input data through the neural network. A batch of input data has dimensions [N, C, . . . , S₁, S₂], with N denoting the batch size. An instance of input has dimensions [C, . . . , S₁, S₂]. The value of N is the batch size of the input data and is equal to the number of instances of input data in the batch. An example of an instance of a batch is the RGB image mentioned above.

It would be desirable to find an efficient method of processing a batch of input data through a neural network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method and hardware implementation are disclosed for evaluating a neural network comprising C″×1×1 generating layers. The method comprises transforming input data for the C″×1×1 generating layers, transforming the C″×1×1 generating layers and processing the transformed input data through the transformed layers.

A method and hardware implementation are disclosed for evaluating a neural network comprising at least a first and a second tile group. The method comprises storing parameter data for the first tile group in a low-cost memory, using the parameter data to process a first instance of the input data through the first tile group and re-using the parameter data to process a second instance of the input data through the first tile group.

A method and hardware implementation are disclosed for evaluating a neural network comprising a plurality of layers. The method comprises storing a subset of parameter data for a layer group of the neural network in a low-cost memory, performing a first pass through the layer group by processing a first instance of input data through the layer group using the subset of parameter data, and re-using the subset of parameter data to perform a second pass through the layer group by processing a second instance of input data through the layer group.

According to one aspect, there is provided a method of evaluating a neural network. The neural network comprises a plurality of layers. The plurality of layers comprises a set of consecutive layers consisting of C″×1×1 generating layers. The C″×1×1 generating layers are layers of the neural network that produce a multidimensional tensor having dimensions [N, C″, . . . , 1, 1] as their output. The set of consecutive layers are configured to receive a multidimensional tensor having dimensions [N>1, C, . . . , S₁, S₂] as input data.

The method comprises:
obtaining a control stream defining a set of transformed layers, the set of transformed layers comprising a first transformation operation and a set of consecutive transformed layers, wherein the set of consecutive transformed layers corresponds to the set of consecutive layers;
obtaining input data for the set of consecutive layers, wherein the input data is a multidimensional tensor having dimensions [N>1, C, . . . , S₁, S₂];
performing a first transformation on the input data according to the first transformation operation to produce transformed input data, wherein the transformed input data has dimensions

$$( [ {N}^{′} = 1 , {C}^{′} , … , {S}_{1}^{′} , {S}_{2}^{′} > 1 ] ,$$

wherein performing the first transformation comprises performing a batch-to-space operation; and
evaluating the set of consecutive layers by processing the transformed input data through the set of consecutive transformed layers to produce output data of the set of consecutive transformed layers;
wherein processing the transformed input data through the set of consecutive transformed layers is performed in parallel by at least PEᵢ>1 processing elements of a first core, and wherein each processing element processes a different line of the transformed input data in the S₂ dimension.

By “a control stream defining a set of transformed layers” it is meant that the control stream contains sufficient information to evaluate the set of transformed layers, including performing the first transformation operation. More generally, phrases like the control stream “comprising” or “defining” X means that the control stream contains X or contains the information needed to obtain or execute X. For example, the control stream may contain a pointer to an address in memory at which parameter data for the set of transformed layers (and more specifically, the set of consecutive transformed layers) is stored. In another example, it may contain the parameter data itself. Similarly, in an example the control stream may contain an instruction to perform the first transformation and information regarding the operations required to perform the first transformation. In another example it may contain an instruction to perform the first transformation and a pointer to an address in memory at which information regarding the operations required to perform the first transformation are stored. The control stream may comprise the input data for the set of consecutive layers.

The S₁, S₂ dimensions are spatial dimensions. For example, S₁ may be the height dimension of the input data and S₂ may be the width dimension of the input data. In another example, S₁ may be the width dimension and S₂ may be the height dimension. A line in the S₂ refers to a column of data where the S₂ dimension is the width dimension, or a row of data where the S₂ dimension is the height dimension.

The size N of the input data in the batch dimension is an integer greater than 1.

The first transformation and the set of consecutive transformed layers are related to one another, meaning that the function performed by the set of consecutive transformed layers on the transformed input data is the same as the function that the set of consecutive layers would perform on the input data for the set of consecutive layers. This means that processing the transformed input data through the set of consecutive transformed layers provides a transformed version of the output that would be provided by processing the input data for the set of consecutive layers through the set of consecutive layers. By applying a second transformation to the output of the set of consecutive transformed layers, the output that would be provided by processing the (untransformed) input data through the (untransformed) set of consecutive layers can be obtained.

A batch-to-space operation is an operation that transforms data by re-arranging values from the batch dimension into one or more of the spatial dimensions. This operation increases the size of at least one of the spatial dimensions while reducing the size of the batch dimension. In an example where S₁ is the height dimension and S₂ is the width dimension, a tensor could have dimensions [N, C, S₁, S₂] of [4, 2, 1, 1], meaning that the tensor has four batches, each batch containing two channels having a single element of data. This tensor could be transformed through a batch-to-space operation into a tensor having dimensions [1, 2, 2, 2] (that is, a single batch having two channels, each channel containing two rows and two columns of data).

The output of the set of consecutive transformed layers may have dimensions [1, C″, S₁″, S₂″].

The control stream may be generated by different hardware to the hardware used to evaluate the neural network. For example, the control stream may be generated remotely or by a separate computing device to the device used to evaluate the neural network, and said device used to evaluate the neural network may be provided with or obtain the transformed set of layers from the separate device or via the cloud.

The method is computer/machine implemented.

The method may further comprise performing a space-to-batch operation on the output data of the set of consecutive transformed layers to provide output data of the set of consecutive layers, wherein the output data of the set of consecutive layers has dimensions [N, C″, 1, 1].

The control stream may define or contain an instruction to perform a second transformation operation comprising the space-to-batch operation. In this way, the output that would be provided by processing the input data for the set of consecutive layers through the set of consecutive layers is obtained.

The size N in the batch dimension of the output of the set of consecutive layers is the same as for the input data for the set of consecutive layers and is equal to S₁″×S₂″. In some examples, the batch dimension of the input data may have been padded as part of the first transformation. In this case, the padding is removed after the space-to-batch operation by cropping out the last

$${S}_{1}^{′} \times {S}_{2}^{′} - N$$

elements to restore the original batch size N.

S₁′ may equal blockheight×ω. S₂′ may equal blockwidth×0.

$$blockheight = ceiling ( \frac{N}{P {E}_{i}} ) and blockwidth = ceiling ( \frac{N}{b ι o c k h e i g h t} ) ,$$

where N_{PE}≥PEᵢ>1 and N_{PE} is the number of processing elements present in at least the first core.

In other words, the first transformation operation is configured to transform the input data according to the above expressions.

The variable ω represents the size in the S₁ dimension of the input data to the batch-to-space operation. This may be equal to 1, for example where the input data for the set of consecutive layers has a size of one in the S₁ dimension or where the input data for the set of consecutive layers undergoes a space-to-depth operation prior to the batch-to-space operation. In other examples ω may be larger than 1.

The variable e represents the size in the S₂ dimension of the input data to the batch-to-space operation. This may be equal to 1, for example where the input data for the set of consecutive layers has a size of 1 in the S₂ dimension or where the input data for the set of consecutive layers undergoes a space-to-depth operation prior to the batch-to-space operation. In other examples θ may be larger than 1.

A consequence of this choice of size for S₂′ is that S₂ will always be less than or equal to the number of processing elements in the first core, enabling each line of the transformed input data to be processed concurrently by the processing elements.

Where S₁, S₂=1, the first transformation may be performed as a batch-to-space transformation. Where one or more of S₁, S₂>1, the first transformation may be performed in two parts. The first transformation may comprise performing a space-to-depth transformation to transform the input data [N, C, . . . , S₁, S₂] into an intermediate tensor [N, C′, . . . , 1, 1], and then performing a batch-to-space operation on the intermediate tensor to produce the transformed input data.

In some examples, N_{PE}=PEᵢ. N_{PE} may be equal to the number of cores present in the first core in a single-core implementation of the method. In multi-core implementations, N_{PE} may be equal to the number of processing elements in the multi-core implementation (that is, the sum of all processing elements in the multiple cores).

The first transformation may comprise padding the batch dimension of the input data for the set of consecutive layers so that N % (blockheight×blockwidth)=0.

In words, the batch dimension of the input data is padded such that the remainder of N (after padding) divided by the product of blockheight and blockwidth is 0. This padding ensures that the transformed input data is rectangular, which simplifies parallelisation across the processing elements. It should be understood that this padding is performed before the batch-to-space operation.

Processing the transformed input data through the set of consecutive transformed layers may comprise:
processing, by the first core, a first subset of the transformed input data through the set of consecutive transformed layers; and
processing, by a second core, a second subset of the transformed input data through the set of consecutive transformed layers,
   wherein the first subset of the transformed input data and the second subset of the input data comprise different elements of the transformed input data in the S₁ dimension.

If the transformed input data is split in the S₁ dimension to produce the first and second subsets of transformed input data when N_{PE}1<N≤N_{Cores}×N_{PE1}, the method may yield a performance improvement of up to a factor of N. If the transformed input data is split in the S₁ dimension to produce the first and second subsets of transformed input data when N>N_{Cores}×N_{PE1}, the method may yield a performance improvement of up to a factor of N_{Cores}×N_{PE1}.

If the transformed input data is split in the S₁ dimension to produce the first and second subsets of transformed input data when N≤N_{PE1}, the method may yield a performance improvement of up to a factor of N.

N_{Cores} refers to the number of cores available to process the transformed input data through the set of consecutive transformed layers. N_{PE1} refers to the number of processing elements within a single core and is greater than 1.

The processing of the first and second subsets of the transformed input data may be concurrent.

The method may further comprise:
obtaining at least a first subset of parameter data and a second subset of parameter data for the set of transformed layers, wherein the parameter data comprises data having dimensions [N_{f}, C_{f}, . . . , S_{1f}, S_{2f}] and wherein the first subset of parameter data and the second subset of parameter data comprise different elements of data in the N (batch) dimension;
processing, by the first core, the transformed input data through the set of consecutive transformed layers using the first subset of parameter data; and
processing, by a second core, the transformed input data through the set of consecutive transformed layers using the second subset of parameter data.

The control stream may comprise the first subset of parameter data and the second subset of parameter data.

The method may comprise combining the outputs of each core and performing the space-to-batch transformation on the combined output. Alternatively, each core may perform a space-to-batch operation on its partial output to produce transformed partial outputs, which may then be combined to provide the output the set of consecutive C″×1×1 generating layers.

The set of consecutive layers may consist of any one or combination of:
one or more fully connected layers, wherein each fully connected layer is configured to receive input data having spatial dimensions S₁ and S₂ of sizes S_{1_FC} and S_{2_FC}, respectively;
one or more convolution layers, wherein each convolution layer is configured to receive input data having spatial dimensions S₁ and S₂ of sizes S_{1_Conv} and S_{2_Conv}, respectively;
one or more element-wise operation layers;
one or more activation layers;
one or more batch normalisation layers;
a pooling layer; wherein the pooling layer is configured to receive input data having spatial dimensions S₁ and S₂ of sizes S_{1_Pool} and S_{2_Pool}, respectively, and is configured to perform pooling using a kernel having a kernel height K_{h_Pool} and a kernel width K_{w_Pool}; and a global pooling layer.

In some examples, the set of consecutive layers might not contain one or both of a pooling layer and a global pooling layer.

At least one of the one or more fully connected layers may have an input resolution of 1×1 (that is, S_{1_FC}=S_{2_FC}=1). However, in some examples the values of S_{1_FC} and S_{2_FC} for each of the one or more fully connected layers need not be the same.

The one or more convolution layers may be configured to perform a convolution using one or more kernels having a kernel height K_{h_Conv} and a kernel width K_{w_Conv}. The one or more convolution layers may be 1×1 convolution layers (meaning that K_{w_Conv}=K_{h_Conv}=1) configured to receive input data having spatial dimensions of size S_{1_Conv}=1 and S_{2_Conv}=1. The one or more convolution layers may comprise a 2D convolution layer or a depth-wise convolution layer configured to output data having a height of one and a width of one. The set of consecutive layers may comprise a combination of one or more of each type of convolution layer. The values S_{1_Conv} and S_{2_Conv} for each of the one or more convolution layers need not be the same. The kernel height K_{h_Conv} may be equal to S_{1_Conv}, when S₁ refers to the height dimension. The kernel height K_{h_Conv} may be equal to S_{2_Conv}, when S₂ refers to the height dimension. The kernel width K_{w_Conv} may be equal to S_{2_Conv} when S₂ refers to the width dimension. The kernel width K_{w_Conv} may be equal to S_{1_Conv} when S₁ refers to the width dimension.

The one or more activation layers may be configured to receive as an input data having a spatial dimensions S_{1_Act}=1 and S_{2_Act}=1.

The one or more element-wise operation layers may be configured to receive as an input data having spatial dimensions S_{1_ELO}=1 and S_{2_ELO}=1. The one or more element-wise operation layers may be configured to perform one or more of: element-wise addition, element-wise subtraction, element-wise multiplication and element-wise division.

The one or more batch normalisation layers may be configured to receive as an input data having spatial dimensions S_{1_BN}=1 and S_{2_BN}=1.

The pooling layer may be configured to receive input data that is not padded. The pooling layer may have a window size the same as its input resolution. By “input resolution”, it is meant the size in the height and width dimensions of the input data the pooling layer is configured to receive. The kernel height K_{h_Pool} may be equal to S_{1_Pool}, when S₁ refers to the height dimension. The kernel height K_{h_Pool} may be equal to S_{2_Pool}, when S₂ refers to the height dimension. The kernel width K_{w_Pool} may be equal to S_{2_Pool} when S₂ refers to the width dimension. The kernel width K_{w_Pool} may be equal to S_{1_Pool} when S₁ refers to the width dimension.

The global pooling layer may be configured to receive input data having spatial dimensions less than or equal to the maximum pooling window size. The maximum pooling window size may be 16×16, but could be larger or smaller in some examples.

The first layer of the set of consecutive layers may be one of:
a fully connected layer configured to receive input data having spatial dimensions of size S_{1_FC}=1 and S_{2_FC}=1;
the pooling layer;
the global pooling layer;
a 2D convolution layer; and
a depth-wise convolution layer, and
   wherein the set of consecutive layers further consists of any one or combination of:
one or more 1×1 convolution layers;
one or more batch normalisation layers;
one or more activation layers having an input resolution of 1×1; and
one or more element-wise operation layers having an input resolution of 1×1.

The set of consecutive transformed layers may correspond to the set of consecutive layers as follows:
each fully connected layer in the set of consecutive layers corresponds to a convolution layer in the set of consecutive transformed layers having a kernel height K_{hT_Conv}=1, a kernel width K_{wT_Conv}=1 and a stride of S_{1_FC}, S_{2_FC} in the spatial dimensions;
each convolution layer in the set of consecutive layers corresponds to a convolution layer in the set of consecutive transformed layers having a kernel size K_{hT_Conv}, K_{wT_Conv}=1 and a stride of S_{1_Conv}, S_{2_Conv}, in the spatial dimensions; and each pooling layer in the set of consecutive layers corresponds to a pooling layer in the set of consecutive transformed layers having a stride of S_{1_Pool}, S_{2_Pool} in the spatial dimensions, respectively.

Each activation layer in the set of consecutive layers configured to receive input data having dimensions [N, C_{act}, . . . , S_{1 act}, S_{2 act}] and produce output data having dimensions [N, C″, . . . , 1, 1] may correspond to an activation layer in the set of consecutive transformed layers configured to receive an input having dimension [1, C′, . . . , S₁′, S₂′] and produce an output having dimension [1, C″, . . . , S₁″, S₂″]. The same correspondence may apply for element-wise operations layers.

Activation, element-wise operation and batch normalisation layers might not require any transformation of the layers themselves because these layers operate on each input data element independently of any other elements. In other words, any activation, element-wise operation and batch normalisation layers of the set of consecutive layers may correspond to identical layers in the set of consecutive transformed layers.

S₁ may be greater than one, and/or S₂ may be greater than one. Performing the first transformation may comprise:
performing a space-to-depth operation on the input data for the set of consecutive layers to provide intermediate input data having dimensions [N, C′, . . . , 1, 1]; and
performing the batch-to-space operation of the intermediate input data to provide the transformed input data.

A space-to-depth operation is an operation that transforms data by re-arranging values from the spatial dimensions (the height H and width W dimensions) into the depth (channel) dimension C. This operation increases the size of the channel dimension while reducing the size of the spatial dimensions. For example, a tensor could have dimensions [N, C, S₁, S₂] of [4, 1, 2, 2], meaning that the tensor has four batches, each batch containing 1 channel having a two rows and two columns. This tensor could be transformed through a space-to-depth operation into a tensor having dimensions [4, 4, 1, 1] (that is, four batches each having four channels, each channel containing a single element of data).

The control stream may define a tile group consisting of the set of transformed layers and wherein the tile group is evaluated by performing the first transformation and processing the transformed input data through the set of transformed layers.

According to another aspect, there is provided a hardware implementation of a neural network. The neural network comprises a plurality of layers. The plurality of layers comprises a set of consecutive layers consisting of C″×1×1 generating layers. The C″×1×1 generating layers are layers of the neural network that produce a multidimensional tensor having dimensions [N, C″, . . . ,1, 1] as their output. The set of consecutive layers are configured to receive a multidimensional tensor having dimensions [N>1, C, . . . , S₁, S₂] as input data.

The hardware implementation comprises:
a data retrieval unit, configured to obtain input data for the set of consecutive layers and a control stream defining a set of transformed layers comprising a first transformation operation and a set of consecutive transformed layers, wherein the set of consecutive transformed layers corresponds to the set of consecutive layers, wherein the input data is a multidimensional tensor having dimensions [N>1, C, . . . , S₁, S₂]; and
a first core comprising a plurality of processing elements, wherein the first core is configured to:
   perform a first transformation on the input data according to the first transformation operation to produce transformed input data, wherein the transformed input data has dimensions

$$( [ {N}^{′} = 1 , {C}^{′} , … , {S}_{1}^{′} , {S}_{2}^{′} > 1 ] ,$$

wherein the first transformation comprises a batch-to-space operation; and
evaluate the set of consecutive layers by processing, in parallel using at least PEᵢ>1 of the plurality of processing elements, the transformed input data through the set of consecutive transformed layers to produce output data of the set of consecutive transformed layers, wherein each processing element processes a different line of the transformed input data in the S₂ dimension.

The data retrieval unit may reside within/be a part of the first core or may be external to the first core. The first core may be the data retrieval unit.

The first core may be further configured to perform a space-to-batch operation on the output data of the set of consecutive transformed layers to provide output data of the set of consecutive layers, wherein the output data of the set of consecutive layers has dimensions [N, C″, 1, 1].

The hardware implementation may further comprise a second core. The first core may be configured to process a first subset of the transformed input data through the set of consecutive transformed layers. The second core may be configured to process a second subset of the transformed input data through the set of consecutive transformed layers.

The first subset and the second subset of the input data may comprise different elements of data in the S₁ dimension.

S₁ may be greater than one, and/or S₂ may be greater than one. The first transformation may comprise:
a space-to-depth operation configured to provide intermediate input data having dimensions [N, C′, . . . , 1, 1]; and
the batch-to-space operation.

The first core may be configured to perform the space-to-depth operation on the input data for the set of consecutive layers to produce the intermediate data; and perform the batch-to-space operation on the intermediate data to produce the transformed input data.

Also provided is a neural network accelerator or graphics processing system comprising the hardware implementation as summarised above and/or configured to perform the method summarised above.

Also provided is a computer-implemented method of generating a control stream for evaluating a neural network. The neural network comprises a plurality of layers. The plurality of layers comprises a set of consecutive layers consisting of C″×1×1 generating layers. The C″×1×1 generating layers are layers of the neural network that produce a multidimensional tensor having dimensions [N, C″, . . . ,1, 1] as their output. The set of consecutive layers are configured to receive a multidimensional tensor having dimensions [N>1, C, . . . , S₁, S₂] as input data.

The method comprises:
determining a first transformation operation configured to transform the input data into transformed input data having dimensions

$$( [ {N}^{′} = 1 , {C}^{′} , … , {S}_{1}^{′} , {S}_{2}^{′} > 1 ] ,$$

wherein the first transformation comprises a batch-to-space operation;
mapping the set of consecutive layers to a set of consecutive transformed layers comprising the first transformation operation and the second transformation operation; and
generating a control stream defining a set of transformed layers, wherein the set of transformed layers comprises the first transformation operation and the set of consecutive transformed layers.

The method may comprise determining a second transformation operation configured to transform an output of the set of consecutive transformed layers into data having dimensions [N, C″, 1, 1], wherein the second transformation operation comprises a space-to-batch transformation. The set of transformed layers may comprise the second transformation.

The method of generating a control stream may be implemented in software. The method may be implemented on a general-purpose computer or CPU.

The first transformation operation may be configured to transform the input data according to the following expressions:

$${S}_{1}^{′} = blockheight \times ω ;$$

$${S}_{2}^{′} = blockwidth \times ω ;$$

$$blockheight = ceiling ( \frac{N}{{PE}_{i}} ) ; and$$

$$blockwidth = ceiling ( \frac{N}{blockheight} ) .$$

Mapping the set of consecutive layers to the set of consecutive transformed layers may comprise any one or combination of:
for each fully connected layer in the set of consecutive layers, mapping the fully connected layer to a convolution layer having a kernel height K_{hT_Conv}=1, a kernel width K_{wT_Conv}=1 and a stride of S_{1_FC}, S_{2_FC} in the spatial dimensions;
for each convolution layer in the set of consecutive layers, mapping the convolution layer to a convolution layer having a kernel size K_{hT_Conv}, K_{wT_Conv}=1 and a stride of S_{1_Conv}, S_{2_Conv}, in the spatial dimensions; and
mapping the pooling layer to a pooling layer having a stride of S_{1_Pool}, S_{2_Pool} in the spatial dimensions, respectively.

Mapping the set of consecutive layers to the set of consecutive transformed layers may comprise for each activation layer, mapping the activation layer from a layer configured to receive input data having dimensions [N, C_{act}, . . . , S_{1 act}, S_{2 act}] and produce output data having dimensions [N, C″, . . . , 1, 1] to an activation layer configured to receive an input having dimension [1, C′, . . . , S₁′, S₂′] and produce an output having dimension [1, C″, . . . , S₁″, S₂″]. A corresponding transformation may apply for element-wise operations layers.

The method may comprise defining a first tile group, the first tile group consisting of one or more layers of the set of transformed layers, wherein the control stream defines the first tile group.

The first tile group may contain all the layers of the set of transformed layers, or may consist of the set of consecutive transformed layers.

The set of transformed layers may comprise a second transformation operation comprising a space-to-batch transformation. Defining the first tile group may comprise:
detecting the second transformation operation;
sequentially adding each preceding layer of the set of transformed layers up to and including the first transformation operation; and
terminating the first tile group.

Defining the first tile group may comprise at least one of:
(A) determining that a bandwidth requirement parameter_{BW} for obtaining parameter data for the first tile group is greater than γ×size_{OCM}, where size_{OCM} is a memory capacity of an on-chip memory device configured to store parameter data and γ is a configurable factor;
(B) determining that a size in memory size_{T} of a predicted largest intermediate tensor that would be produced by evaluating an alternative tile group containing the set of consecutive layers is greater than

$$\frac{{size}_{OCM} - {parameter}_{BW}}{ϵ} ,$$

and determining that parameter_{BW}<σ×size_{OCM}, wherein σ and ∈ are configurable variables; and
(C) determining that Count_{cycle}×(blockwidth−1)>transform_{cycles}×φ, wherein φ is a configurable variable, Count_{cycle} is an estimation of a number of computing cycles needed to execute the first tile group, and transform_{cycles} is an estimation of a number of computing cycles needed to perform the first transformation and optionally the space-to-batch transformation, and wherein processing input data for the set of consecutive layers through the first tile comprises reading the parameter data from the on-chip memory.

Condition (A) considers whether the bandwidth needed to obtain the parameter data for the first tile group is larger compared to a configurable percentage of the memory capacity of the on-chip memory device. If the condition is satisfied, then it is a favourable trade off to store the parameter data in the on-chip memory for use in the method to save the bandwidth that would be required to read the parameter data from off-chip memory multiple times according to other methods.

The parameter γ may be equal to 30%. Because the first tile group must consist of 1×1 generating layers for the batch-to-space batching method to be used, the first tile group cannot be combined with another tile group containing non-1×1 generating layers to produce a larger tile group. In general, it is more bandwidth efficient to process larger tile groups that smaller tile groups. However, in the case of 1×1 generating layers, the batch-to-space batching method can make more efficient use of the processing elements in processing the 1×1 generating layers. Depending on the size of the first tile group, and the hardware being used, it may be more desirable to processing a large tile group that comprises (but does not consist of) 1×1 generating layers than to process two smaller tile groups, using the batch-to-space batching method for one of the tile groups. By limiting the use of the batch-to-space batching method according to condition (A), the method avoids using batch-to-space batching in scenarios where it would be more efficient to process a larger tile group using an alternative method.

The first of the tests of condition (B) considers whether intermediate data produced in the evaluation of an alternative tile group would likely be too large to store in on-chip memory, meaning that the alternative tile group would likely need to be split into multiple tile groups. The alternative tile group is the tile group containing the set of consecutive layers that would be defined if the batch-to-space batching method were not being implemented. For example, it may be the tile group that would be defined according to the tile group interleaved method. The predicted largest intermediate tensor is the predicted or estimated largest output of the layer groups in the tile group. If the first test of condition B is satisfied then it is estimated that the output of the layer group may be too large to be stored on-chip and would have to be written to external memory (such as DDR memory), meaning that the tile group would have to be split into two tile groups anyway. Given that in either method two tile groups are required, it may be beneficial to implement batch-to-space batching over an alternative method such a tile group interleaving due to the performance gain provided by batch-to-space batching. The second of the tests considers whether the bandwidth needed to obtain the parameter data for the first tile group is small compared to size of the on-chip memory. The variable σ may be equal to 10%. The variable E may be equal to 3.

Condition (C) considers whether the expected acceleration provided by the batch-to-space batching method (represented by Count_{cycle}×(blockwidth−1)) exceeds the computation cost of performing the first transformation (and optionally the space-to-batch operation), which is represented by transform_{cycles}×φ. φ may be equal to 4.

The neural network accelerator or graphics processing system may be embodied in hardware on an integrated circuit.

Also provided is a method of manufacturing, using an integrated circuit manufacturing system, a hardware implementation as summarised above or a graphics processing system or neural network accelerator as summarised above.

The method may comprise:
processing, using a layout processing system, a computer readable description of the hardware implementation or neural network accelerator or graphics processing system so as to generate a circuit layout description of an integrated circuit embodying the hardware implementation or neural network accelerator or graphics processing; and
manufacturing, using an integrated circuit generation system, the hardware implementation or neural network accelerator or graphics processing according to the circuit layout description.

Also provided is a (optionally non-transitory) computer readable storage medium having stored thereon a computer readable description of a hardware implementation as summarised above or a graphics processing system or neural network accelerator as summarised above which, when processed in an integrated circuit manufacturing system, causes the integrated circuit manufacturing system to manufacture an integrated circuit embodying the hardware implementation or neural network accelerator or graphics processing system.

The computer readable storage medium may cause the integrated circuit manufacturing system to:
process, using a layout processing system, the computer readable description of the hardware implementation or neural network accelerator or graphics processing system so as to generate a circuit layout description of an integrated circuit embodying the hardware implementation or neural network accelerator or graphics processing system; and
manufacture, using an integrated circuit generation system, the hardware implementation or neural network accelerator or graphics processing system according to the circuit layout description.

Also provided is an integrated circuit manufacturing system configured to manufacture a hardware implementation as summarised above or a neural network accelerator or graphics processing system as summarised above.

The integrated circuit manufacturing system may comprise:
a non-transitory computer readable storage medium having stored there on a computer readable description of the hardware implementation or neural network accelerator or graphics processing system;
a layout processing system configured to process the computer readable description so as to generate a circuit layout description of an integrated circuit embodying the hardware implementation or neural network accelerator or graphics processing system; and
an integrated circuit generation system configured to manufacture the hardware implementation or neural network accelerator or graphics processing system according to the circuit layout description.

The layout processing system may be configured to determine positional information for logical components of a circuit derived from the integrated circuit description so as to generate a circuit layout description of an integrated circuit embodying the hardware implementation or neural network accelerator or graphics processing system.

Also provided is computer readable code configured to cause any of the methods summarised above to be performed when the code is run.

Also provided is a computer readable storage medium having encoded thereon the computer readable code summarised above. The computer readable storage medium may be non-transitory.

Also provided is an integrated circuit definition dataset that, when processed in an integrated circuit manufacturing system, configures the integrated circuit manufacturing system to manufacture a hardware implementation as summarised above or a neural network accelerator or graphics processing system as summarised above.

The integrated circuit manufacturing system may comprise:
a non-transitory computer readable storage medium having stored thereon a computer readable description of a hardware implementation as summarised above or a neural network accelerator or graphics processing system as summarised above;
a layout processing system configured to process the computer readable description so as to generate a circuit layout description of an integrated circuit embodying the hardware implementation or neural network accelerator or graphics processing system; and
an integrated circuit generation system configured to manufacture the hardware implementation or neural network accelerator or graphics processing system according to the circuit layout description.

The layout processing system may be configured to determine positional information for logical components of a circuit derived from the integrated circuit description so as to generate a circuit layout description of an integrated circuit embodying the hardware implementation or neural network accelerator or graphics processing system.

Also provided is a computing device comprising means for performing the method summarised above.

The computing device may be a data processing system. The computing device may be a general-purpose computer. The means for performing the method may be a CPU.

According to another aspect, there is provided a method of evaluating a neural network, the neural network including a plurality of layers. The method comprises:
obtaining a control stream defining a first tile group and a second tile group, wherein:
   the first tile group consists of a first set of one or more consecutive layers of the neural network; and
   the second tile group consists of a second, different, set of one or more consecutive layers of the neural network;
providing, in a first memory device, input data for the first tile group and parameter data for the first tile group, wherein the input data for the first tile group is a multidimensional tensor having dimensions [N>1, C, . . . , H, W] and comprises at least a first instance and a second instance each having dimensions [N=1, C, . . . , H, W];
storing, in a second memory device, the parameter data for the first tile group, wherein the second memory device has a lower cost to access than the first memory device;
processing the first instance of input data through the first tile group using the parameter data stored in the second memory device, to produce a first instance of output data; and
re-using the parameter data for the first tile group stored in the second memory device by processing the second instance of the input data through the first tile group using the parameter data stored in the second memory device to produce a second instance of output data.

By “a control stream defining a first tile group and a second tile group” it is meant that the control stream contains sufficient information to evaluate the tile group and a second tile group. For example, the control stream may identify the layers in the first and second tile groups and may include or contain a pointer to the parameter data required to evaluate the tile groups. More generally, phrases like the control stream “comprising” or “defining” X means that the control stream contains X or contains the information needed to obtain or execute X.

The control stream may be generated by different hardware to the hardware used to evaluate the neural network. For example, the control stream may be generated remotely or by a separate computing device to the device used to evaluate the neural network, and said device used to evaluate the neural network may be provided with or obtain the transformed set of layers from the separate device or via the cloud.

The parameter data is maintained in the second memory device such that it can be used to process the first and second instances through the first tile group.

The first memory device may be DDR memory. The second memory device may be an on-chip memory.

“Parameter data” means the data necessary to evaluate a neural network and comprises weights, biases and coefficients for the layers of the neural network. The first memory device may also contain parameter data for the second tile group. The second memory device might not be large enough to store all the parameter data needed to evaluate the neural network.

The input data for the first tile group may be stored in the second memory device. Processing the first instance of input data through the first tile group may comprise reading, from the second memory device, the first instance of input data.

A tile group may comprise a plurality of layer groups or may consist of a single layer group. A layer group is a set of one or more consecutive layers of the neural network that, as input data is processed through the layers of the layer group, produces intermediate data that is not stored in memory. Instead, the intermediate data generated by processing input data through each layer of the layer group remains in the neural network pipeline, passing directly from one processing element to another until the layer group has been evaluated in its entirety for that input data. Output data for the layer group may then be stored in an on-chip memory, such as the second memory device.

Where a tile group comprises a plurality of layer groups, the output of a first layer group in the tile group is stored in an on-chip memory and read from the on-chip memory to be processed through the next layer group in the tile group. In this way, a plurality of layer groups can be processed without needing to access the first memory device multiple times. The output of a tile group may be stored in the first memory device.

By re-using the parameter data stored in the second memory device for two instances, the bandwidth used to obtain parameter data for evaluating the neural network as a whole is reduced.

The processing of the first instance through the first tile group may be performed by a first core and the processing of the second instance through the first tile group may be performed by a second core. Accordingly, the second memory device may be accessible by the first core and the second core, or may be two devices, each device accessible by a different one of the cores. The first core and the second core may process the first and second instances through the first tile group in parallel.

The method may comprise processing of a first part of the first instance of input data through the first tile group using a first core and processing a second part of the first instance of input data through the first tile group using a second core. The processing of the first part of the first instance of input data and a second part of the first instance of input data may be performed in parallel.

The method may comprise processing of a first part of the second instance of input data through the first tile group using a first core and processing a second part of the second instance of input data through the first tile group using a second core. The processing of the first part of the first instance of input data and the second part of the second instance of input data may be performed in parallel.

The method may comprise splitting the first instance of input data into a first part and a second part. Alternatively, the first instance of input data may have been split into a first part and a second part at an earlier time.

The first and second parts of the first and second instances may be stored in the second memory device/a shared on-chip memory.

Output data of the first tile group may be input data for the second tile group. In other words, the first and second tile groups may be consecutive.

The method is computer/machine implemented.

The method may comprise storing, in the second memory device, parameter data for the second tile group, and after processing at least the first instance and the second instance through the first tile group:
discarding the parameter data for the first tile group stored in the second memory device; and
processing the first instance of output data through the second tile group using the parameter data for the second tile group stored in the second memory device.

The method may comprise storing, in the second memory device, the first instance of output data. Processing the first instance of output data through the second tile group may comprise reading, from the first memory device, the first instance of output data.

The parameter data for the second tile group may be stored in the second memory device only after discarding the parameter data for the first tile group stored in the second memory device.

Discarding the parameter data for the first tile group stored in the second memory device may comprise overwriting the data with the parameter data for the second tile group.

The parameter data for the first tile group stored in the second memory device may be discarded after processing all instances of input data for the first tile group through the first tile group using the parameter data stored in the second memory device.

The parameter data for the second tile group may be stored in the second memory device after discarding the parameter data for the first tile group stored in the second memory device.

The method may comprise processing

$${P}_{I} = floor ( \frac{{N}_{C}}{{M}_{I}} )$$

instances of the input data through the first tile group in parallel, wherein:
each instance is processed by M_{I} of N_{C} cores; and
1≤M_{I}≤N_{C}.

Where P_{I}>1, the method comprises processing P_{I} instances of the input data through the first tile group concurrently, wherein each instance is processed by M_{I} cores.

Where P_{I}=1, the method comprises processing each instance of the input data through the first tile group consecutively, wherein each instance is processed by M_{I} cores.

M_{I} may equal any one of: 1, 2, 3, 4, 5, 6, 7, or 8, or may exceed 8. In some examples, M_{I} is equal to N_{C}. In some examples, M_{I} is less than N_{C}.

The method may comprise, where N_{C}≥M_{I}, P_{I} and M_{I}, P_{I}>1, obtaining M_{I} parts of each of the instances and processing each part of a given instance through the first layer group using My cores. In this way, P_{I} instances can be processed in parallel by P_{I}×M_{I} of the N_{C} cores.

The number of idle Cᵢ cores is equal to N_{C}−M_{I}×P_{I}, and may be greater than zero depending on the value of M_{I} chosen. Where Cᵢ>0, the idle cores may be assigned other tasks to perform.

The control stream may comprise an indication of M_{I} and P_{I}.

In some examples, N % P_{I}=0, N≥P_{I} and N_{C}% M_{I}=0.

The input data for the first tile group may comprise N>2 instances.

The number M_{I} of cores allowed to process a given instance of the input data through the first tile group (also known as the multi-instance core number) is chosen to be an integer factor of N_{C}-Similarly, the multi-instance core number is chosen such that the value P_{I} (also known as the number of parallel instances) is an integer factor of the number of instances N of the input data (also known as the batch size of the input data). The consequence of this choice of My is that the number of idle cores is zero.

In some examples:
N_{C}=M_{I}; or
M_{I}=1; or
1<M_{I}<N_{C}.

M_{I} may be chosen such that N_{C}% M_{I}=0.

N_{C}=M_{I} is a special case of the method where each instance is processed through the first layer group using all the N_{C} cores.

M_{I}=1 is a special case of the method where the cores work in parallel by each processing a different instance through the first layer group.

1<M_{I}<N_{C} describes all cases between the two special cases mentioned above. Where 1<M_{I}<N_{C}, at least two instances are processed through the first layer group in parallel and at least two cores are used to process each instance in parallel.

In some examples, M_{I}=1. The method may comprise:
processing, by a first core of the N_{C} cores, the first instance of input data through the first tile group; and
processing, by a second core of the N_{C} cores, the second instance of input data through the first tile group,
   wherein:
the first instance of input data and the second instance of input data are processed through the first tile group in parallel;
processing the first instance of input data through the first tile group comprises:
   processing the first instance of input data through a first layer group of the first tile group to produce first intermediate data;
   storing the first intermediate data in a third memory device, wherein the third memory device is only accessible to the first core and has a lower cost to access than the first memory device;
   reading, by the first core from the third memory device, the first intermediate data; and
   processing the first intermediate data through a second layer group of the first tile group, and
processing the second instance of input data through the first tile group comprises:
   processing the second instance of input data through the first layer group of the first tile group to produce second intermediate data;
   storing the second intermediate data in a fourth memory device, wherein the fourth memory device is only accessible to the second core and has a lower cost to access than the first memory device;
   reading, by the second core from the fourth memory device, the second intermediate data; and
   processing the second intermediate data through the second layer group of the first tile group.

In some examples, 1<M_{I}<N_{C} and P_{I}>1. The method may comprise:
obtaining M_{I} parts of the first instance of input data,
obtaining M_{I} parts of the second instance of input data; and
processing, in parallel, each part of the first instance of input data and the second instance of input data through the first tile group.

The method may comprise obtaining M_{I} parts of P_{I} instances, or all N instances, of input data and processing each part of P_{I} instances of input data through the first tile group in parallel using P_{I}×M_{I} cores. In other words, each of the P_{I}×M_{I} cores may be used to process a different one of the P_{I}×M_{I} parts of input data, such that all P_{I}×M_{I} parts are processed concurrently.

Where the first tile group comprises two or more layer groups, the method may comprise storing the intermediate data produced by the first layer group in the second memory device.

In some examples, M_{I}=N_{C}. The method may comprise:
obtaining M_{I} parts of the first instance of input data for the first tile group; and
processing in parallel, by each of M_{I} cores, a different part of the first instance of input data for the first tile group through the first tile group.

In other words, each core may process a different part of the first instance of input data through the first tile group concurrently.

According to another aspect there is provided a hardware implementation of a neural network. The neural network includes a plurality of layers. The hardware implementation comprises:
a data retrieval unit, configured to obtain a control stream defining a first tile group and a second tile group of the neural network, wherein:
   the first tile group consists of a first set of one or more consecutive layers of the neural network;
   the second tile group consists of a second, different, set of one or more consecutive layers of the neural network; and
   input data for the first tile group and parameter data for the first tile group are stored in a first memory device, wherein the input data for the first tile group is a multidimensional tensor having dimensions [N>1, C, . . . , H, W], and comprises a first instance and a second instance each having dimensions [N=1, C, . . . , H, W];
a second memory device, configured to store the parameter data for the first tile group, wherein the second memory device has a lower cost to access than the first memory device; and
one or more cores, configured to:
   process the first instance of the input data through the first tile group using the parameter data for the first tile group stored in the second memory device to produce a first instance of output data; and
   re-use the parameter data for the first tile group stored in the second memory device to process the second instance of the input data through the first tile group to produce a second instance of output data.

The parameter data for the first tile group is maintained in the second memory device such that the first and second instances are processed through the first tile group without needing to obtain the parameter data for the first tile group from external memory more than once. In other words, the parameter data for the first tile group is maintained in the second memory device at least until the processing of the first and second instances through the first tile group has begun, and optionally until it has completed.

The data retrieval unit may be part of one or more of the one or more cores, or may be a distinct element of hardware outside of any of the cores. The data retrieval unit may obtain the parameter data for the first tile group and store the parameter data in the second memory device. The control stream may contain the parameter data or may define the parameter data, for example by providing an address in memory from which the parameter data is obtainable.

The second memory device may be a shared on-chip memory that is shared by each of the one or more cores. The shared on-chip memory may be accessible by each of the one or more cores. The second memory device may be a set of separate memory devices (such as L2 caches). Each of the separate memory devices may be accessible by a different one of the one or more cores. Each of the separate memory devices may store the parameter data for the first tile group, and at least a portion of the input data for the first tile group. Each sub-memory may store the entirety of the input data for the first tile group.

The one or more cores may comprise a first core and a second core. The second memory device may be a shared memory device accessible by the first core and the second core or, as explained above, the second memory device may comprise separate memory devices that can each only be accessed by a different one of the cores.

The first core may be configured to process the first instance of input data through the first tile group and the second core may be configured to process the second instance of input data through the first tile group. The first core and the second core may be configured to process the first instance of input data and the second instance of input data through the first tile group in parallel.

The first core may be configured to process a first part of the first instance of the input data through the first tile group, and the second core may be configured to process a second part of the input data of the first instance through the first tile group. The first and second cores may be configured to process the first part of the first instance and the second part of the first instance in parallel.

The second memory device may be configured to:
store parameter data for the second tile group; and
discard the parameter data for the first tile group after the first instance and the second instance have been processed through the first tile group, wherein the one or more cores are configured to process the first instance of output data through the second tile group using the parameter data stored in the second memory device.

The second memory device may be configured to store the parameter data for the second tile group after the parameter data for the first tile group has been discarded.

The second memory device may be configured to discard the parameter data for the first tile group after all instances of input data have been processed through the first tile group.

In some examples, the one or more cores comprises N_{C}>1 cores. The hardware implementation may be configured to:
allocate N_{C} cores for evaluation of the neural network, wherein N_{C}>1; and
choose a number M_{I} of cores to process, in parallel, a given instance of the input data through the first tile group, wherein 1≤M_{I}≤N_{C};
determine a number P_{I} of instances of the input data for the first tile group to process in parallel through the first layer group, wherein

$${P}_{I} = floor ( \frac{{N}_{C}}{{M}_{I}} ) ,$$

wherein the N_{C} cores are configured to process

$${P}_{I} = floor ( \frac{{N}_{C}}{{M}_{I}} ) ,$$

instances of the input data through the first layer group in parallel;
each instance is processed by M_{I} of N_{C} cores; and
1≤M_{I}≤N_{C}.

Where P_{I}>1, the N_{C} cores are configured to process P_{I} instances of the input data through the first layer group concurrently, wherein each instance is processed by M_{I} of the N_{C} cores.

Where P_{I}=1, the N_{C} cores are configured to process each instance of the input data through the first layer group consecutively, wherein each instance is processed in parallel by M_{I} cores.

Where N_{C}≥M_{I}, P_{I} and M_{I}, P_{I}>1, each instance of the input data may be split into M parts. Each core may process a different one of the M_{I} parts through the first layer group.

The N_{C} cores may comprise at least a first core and a second core. The hardware implementation may comprise:
a third memory device only accessible to the first core and having a lower cost to access than the first memory device; and
a fourth memory device only accessible to the second core and having a lower cost to access than the first memory device.

In some examples M_{I}=1. The first core may be configured to:
process the first instance of input data for the first tile group through a first layer group of the first tile group to produce first intermediate data;
store the first intermediate data in the third memory device;
read the first intermediate data from the third memory device; and
process the first intermediate data through a second layer group of the first tile group.

The second core may be configured to:
process the second instance of input data for the first tile group through the first layer group of the first tile group to produce second intermediate data;
store the second intermediate data in the fourth memory device;
read the second intermediate data from the fourth memory device; and
process the second intermediate data through the second layer group of the first tile group.

In some examples, 1<M_{I}≤N_{C}. The hardware implementation may be configured to obtain M_{I} parts of the first instance of input data. Each of the M_{I} cores may be configured to process a different part of the first instance of input data through the first tile group.

The data retrieval unit may obtain the parts of the first instance of input data, and may store the parts in a shared on-chip memory.

Each of the M_{I} cores may be configured to store the output data produced by processing its part of the first instance through the first tile group in the second memory device. Each of the M_{I} cores may comprise a private memory device (like the third and fourth memory devices), and each of the M_{I} cores may store, in its private memory device, the set of output data that it produced.

Also provided is a neural network accelerator or graphics processing system configured to perform the method summarised above or comprising the hardware implementation summarised above.

The neural network accelerator or graphics processing system may be embodied in hardware on an integrated circuit.

Also provided is a method of manufacturing, using an integrated circuit manufacturing system, a hardware implementation as summarised above or a neural network accelerator or graphics processing system as summarised above.

The method may comprise:
processing, using a layout processing system, a computer readable description of the hardware implementation or neural network accelerator or graphics processing system so as to generate a circuit layout description of an integrated circuit embodying the hardware implementation or neural network accelerator or graphics processing system; and
manufacturing, using an integrated circuit generation system, the hardware implementation or neural network accelerator or graphics processing system according to the circuit layout description.

Also provided is a computer-implemented method of generating a control stream for evaluating a neural network. The neural network comprises a plurality of layers. The method comprises:
obtaining a first tile group, the first tile group consisting of a first set of one or more consecutive layers of the neural network, wherein input data for the first tile group is a multidimensional tensor having dimensions [N>1, C, . . . , H, W] and comprises at least a first instance and a second instance each having dimensions [N=1, C, . . . , H, W];
obtaining a second tile group, the second tile group consisting of a second, different, set of one or more consecutive layers of the neural network; and
generating a control stream defining the first tile group, the second tile group and comprising an instruction to:
   process the first instance of the input data through the first tile group using the parameter data for the first tile group stored in the second memory device to produce a first instance of output data; and
   re-use the parameter data for the first tile group stored in the second memory device to process the second instance of the input data through the first tile group using the parameter data for the first tile group stored in the second memory device to produce a second instance of output data.

In other words, the instructions require the parameter data for the first tile group to be maintained in the second memory device such that the processing of the first and second instances through the first tile group can use the parameter data for the first tile group stored in the second memory device.

Obtaining the first tile group may comprise grouping consecutive layers of the neural network into one or more layer groups, and grouping the one or more layer groups into the tile group.

The method may comprise:
choosing a number M_{I} of N_{C} cores to process, in parallel, a given instance of the input data through the first tile group, wherein 1≤M_{I}≤N_{C}; and
determining a number P_{I} of instances of the input data for the first tile group to process in parallel through the first tile group, wherein

$${P}_{I} = floor ( \frac{{N}_{C}}{{M}_{I}} ) ,$$

wherein the control stream comprises an indication of M_{I} and P_{I}.

The method may comprise, where N_{C}≥M_{I}, P_{I} and M_{I}, P_{I}>1, splitting the instances of the input data into M_{I} parts. In this way, P_{I} instances can be processed in parallel by P_{I}×M_{I} of the N_{C} cores.

The control stream may comprise the M_{I} parts of the instances.

The number of idle Cᵢ cores is equal to N_{C}−M_{I}×P_{I}, and may be greater than zero depending on the value of M_{I} chosen. Where Cᵢ>0, the idle cores may be assigned other tasks to perform.

In some examples, N_{C}=M_{I}. In some examples, M_{I}=1. In some examples, 1<M_{I}<N_{C}.

In some examples, M_{I} is chosen such that N % P_{I}=0, N_{C}≥P_{I} and N_{C}% M_{I}=0.

The number M_{I} of cores used to process a given instance of the input data through the first tile group (also known as the multi-instance core number) is chosen to be an integer factor of N_{C}, to maximise core utilisation. Similarly, the multi-instance core number is chosen such that the value P_{I} (also known as the number of parallel instances) is an integer factor of the number of instances N of the input data (also known as the batch size of the input data).

In some examples, N_{C}=M_{I}. In some examples, M_{I}=1. In some examples, 1<M_{I}<N_{C}.

N_{C}=M_{I} is a special case of the method where each instance is processed through the first layer group using all the N_{C} cores.

M_{I}=1 is a special case of the method where the cores work in parallel by each processing a different instance through the first layer group.

1<M_{I}<N_{C} describes all cases between the two special cases mentioned above. Where 1<M_{I}<N_{C}, at least two instances are processed through the first layer group in parallel and at least two cores are used to process each instance in parallel.

In some examples, 1<M_{I}<N_{C} and P_{I}>1. The method may comprise:
splitting the first instance of input data into My parts, and
splitting the second instance of input data into M_{I} parts.

This splitting improves core utilisation by enabling the processing, in parallel, of each part of the first instance of input data and the second instance of input data through the first tile group.

The method may comprise splitting P_{I} instances, or all N instances, of input data into My parts, and processing each part of P_{I} instances of input data through the first tile group in parallel using P_{I}×M_{I} cores. In other words, each of the P_{I}×M_{I} cores may be used to process a different one of the P_{I}×M_{I} parts of input data, such that all P_{I}×M_{I} are processed concurrently.

Where the first tile group comprises two or more layer groups, the method may comprise storing the intermediate data produced by the first layer group in the second memory device.

In some examples, M_{I}=N_{C}. The may method comprise splitting the first instance of input data for the first tile group into M_{I} parts.

Also provided is computer readable code configured to cause any of the methods summarised above to be performed when the code is run.

Also provided is a computer readable storage medium having encoded thereon the computer readable code summarised above. The computer readable storage medium may be non-transitory.

Also provided is an integrated circuit definition dataset that, when processed in an integrated circuit manufacturing system, configures the integrated circuit manufacturing system to manufacture a hardware implementation as summarised above or a neural network accelerator or graphics processing system as summarised above.

Also provided is a computer readable storage medium having stored thereon a computer readable description of a hardware implementation as summarised above or a neural network accelerator or graphics processing system as summarised above that, when processed in an integrated circuit manufacturing system, causes the integrated circuit manufacturing system to manufacture an integrated circuit embodying the hardware implementation or neural network accelerator or graphics processing system.

Also provided is a (optionally non-transitory) computer readable storage medium having stored there on a computer readable description of a hardware implementation as summarised above or a neural network accelerator or graphics processing system as summarised above which, when processed in an integrated circuit manufacturing system, causes the integrated circuit manufacturing system to:

process, using a layout processing system, the computer readable description of the hardware implementation or neural network accelerator or graphics processing system so as to generate a circuit layout description of an integrated circuit embodying the hardware implementation or neural network accelerator or graphics processing system; and manufacture, using an integrated circuit generation system, the hardware implementation or neural network accelerator or graphics processing system according to the circuit layout description.

Also provided is an integrated circuit manufacturing system configured to manufacture a hardware implementation as summarised above or a neural network accelerator or graphics processing system as summarised above.

The integrated circuit manufacturing system may comprise:
a non-transitory computer readable storage medium having stored there on a computer readable description of the hardware implementation or neural network accelerator or graphics processing system;
a layout processing system configured to process the computer readable description so as to generate a circuit layout description of an integrated circuit embodying the hardware implementation or neural network accelerator or graphics processing system; and
an integrated circuit generation system configured to manufacture the hardware implementation or neural network accelerator or graphics processing system according to the circuit layout description.

The layout processing system may be configured to determine positional information for logical components of a circuit derived from the integrated circuit description so as to generate a circuit layout description of an integrated circuit embodying the hardware implementation or neural network accelerator or graphics processing system.

Also provided is a computing device comprising means for performing the method summarised above.

The computing device may be a data processing system. The computing device may be general purpose computer. The means for performing the method may be a CPU.

According to another aspect, there is provided a method of evaluating a neural network. The neural network comprises a plurality of layers. The method comprises:
obtaining a control stream defining a layer group, the layer group consisting of one or more consecutive layers of the neural network;
providing, in a first memory device, input data for the layer group and parameter data for the layer group, wherein the input data is a multidimensional tensor having dimensions [N>1, C, . . . , H, W] and comprises at least a first instance and a second instance of data, each instance of data having dimensions [1, C, . . . , H, W];
storing, in a second memory device, a first subset of parameter data, wherein the first subset of parameter data does not contain all the parameter data for the layer group;
performing, by a first core, a first pass through the layer group by processing the first instance through the layer group using the first subset of parameter data stored in the second memory device; and
re-using the first subset of parameter data stored in the second memory device by performing, by the first core, a second pass through the layer group by processing the second instance through the layer group using the first subset of parameter data stored in the second memory device,
wherein the second memory device has a lower cost to access than the first memory device.

In other words, the first subset of parameter data is maintained in the second memory device at least until after the start of the second pass, such that the first and second passes use the parameter data stored in the second memory device.

The dimensions [N, C, . . . , H, W] refer to the batch, channel, height and width dimensions, respectively.

The second memory device may be an (optionally shared) on-chip memory (S-)OCM or a first parameter buffer of the first core, The first parameter buffer may be an on-chip memory of the first core. The first and second pass may be performed consecutively by the first core.

The parameter data for the layer group may exceed the memory capacity of the second memory device. The second memory device may store only one subset of parameter data at a time, or may store more than one subset of parameter data at a time, but may not store all of parameter data at a time.

By “maintained in the second memory device” it is meant that the first subset of parameter data is not deleted from the second memory device. In this way, the first and second passes can be performed without needing to read parameter data from the first memory device for each pass.

The first instance and/or the second instance may be stored in the second memory device or may be stored in an input buffer of the first core. The input buffer may be an on-chip memory. The input buffer may have a lower cost to access than the first memory device.

Performing the first and second passes may comprise reading the first and second instances from the second memory device or input buffer.

The first memory device may be an external memory device and the second memory device may be an on-chip memory.

The parameter data may comprise weights and/or biases for the layer group.

The control stream may be generated by different hardware to the hardware used to evaluate the neural network. For example, the control stream may be generated remotely or by a separate computing device to the device used to evaluate the neural network, and said device used to evaluate the neural network may be provided with or obtain the transformed set of layers from the separate device or via the cloud.

The method may comprise:
storing, in a third memory device, a second subset of parameter data;
performing, by a second core, a third pass through the layer group by processing the first instance through the layer group using the second subset of parameter data stored in the third memory device; and
re-using the second subset of parameter data stored in the third memory device by performing, by the second core, a fourth pass through the layer group by processing the second instance through the layer group using the second subset of parameter data stored in the third memory device,
wherein the third memory device has a lower cost to access than the one or more first memory devices.

In other words, the second subset of parameter data may be maintained in the third memory device during the third pass and at least until after the start of the fourth pass, such that it is re-used.

The second and third memory devices may be the same memory device (such as an S-OCM or a parameter buffer) or may be different memory devices.

The third and fourth passes may be performed consecutively by the second core. The third memory device may be a parameter buffer of the second core. The first core may perform the first and second passes in parallel with the second core performing the third and fourth passes. In other words, the first and/or second passes may be performed in parallel with the third and/or fourth passes.

By “maintained in the third memory device” it is meant that the second subset of parameter data is not deleted from the third memory device. In this way, the third and fourth passes can be performed without needing to read parameter data from the first memory device each time.

The first and second instances may be stored in the shared on-chip memory (S-OCM) that is accessible by the first core and the second core. The S-OCM has a lower cost to access than the first memory device. Performing the first and second passes may comprise reading the first and second instances from the S-OCM.

In some examples, each pass through the layer group performed by the first core uses the first subset of parameter data stored in the second memory device.

The first subset of parameter data may be maintained in the second memory device for the duration of the passes performed by the first core. In other words, from the beginning of the first pass through the layer group performed by the first core at least until the start of, and optionally until the completion of, the last pass through the layer group performed by the first core.

The method may comprise:
discarding the first subset of parameter data stored in the second memory device;
storing a third subset of parameter data in the second memory device; and
after completing the second pass, performing, by the first core, a fifth pass through the layer group by processing the first or second instance through the layer group using the third subset of parameter data stored in the second memory device.

The first subset of parameter data may be discarded by deleting the data or overwriting the data, for example by overwriting the data with the third subset of parameter data.

The first subset of parameter data may be discarded after the second pass has begun. The first subset of parameter data may be discarded after the second pass is completed. The first subset of parameter data may be discarded after the second pass has begun but before it has been completed. The discarding and storing may be synchronized with the passes performed by the first core, and optionally all the cores.

In some examples, the first core may perform a sixth pass through the layer group by processing the second or first instance (that is, whichever instance was not processed in the fifth pass) through the layer group using the third subset of parameter data stored in the second memory device, thereby re-using the third subset of parameter data stored in the second memory device. The fifth and sixth passes may be performed consecutively, re-using the third subset of parameter data stored in the second memory device.

The parameter data for the layer group may comprise a tensor having dimensions [N_{f}, C_{f}, . . . , H_{f}, W_{f}]. In this case, the first subset of parameter data comprises a first subset of the tensor in the batch dimension, and the second subset of parameter data comprises a second subset of the tensor in the batch dimension.

For clarity, N_{f} represents the batch dimension of the parameter data. The tensor may be or may comprise a set of filters, such as a set of convolution kernels. H_{f} and W_{f} represent the height and width dimensions of the tensor, respectively, and C_{f} represents the channel (depth) dimension of the tensor. The tensor is split in the batch dimension, meaning that the first subset of parameter data comprises a first subset of the batches of the tensor, and the second subset of parameter data comprises a second, different, subset of the batches of the tensor. For example, a set of filters (a tensor) having batches A, B, C, D may be split in the batch dimension to provide a first subset of parameter data consisting of the data in the A and B batches, and a second subset consisting of the data in the C and D batches.

The first subset of parameter data and the second subset of parameter data might not share any elements. In other words, the first and second subsets may be disjoint sets.

Performing the first pass through the layer group may comprise:
processing a first subset of the first instance through the layer group in a first sub-pass using the first subset of parameter data stored in the second memory device, to produce a first partial result;
storing, in an on-chip memory, the first partial result;
processing a second subset of the first instance through the layer group in a second sub-pass using the first subset of parameter data stored in the second memory device, to produce a second partial result; and
combining the first partial result and the second partial result to produce accumulated output data.

The first and second sub-passes may be performed by the first core.

The accumulated output data may be stored in the on-chip memory. The accumulated output data may overwrite the first partial result in the on-chip memory. Additionally, or alternatively, the accumulated output data may be written to an external memory device, such as the first memory device.

The second memory device may be the on-chip memory. The on-chip memory may be the input buffer of the first core. The on-chip memory may be an S-OCM. The first and second subsets of the first instance may be stored in the input buffer. The on-chip memory may have a lower cost to access than the first memory.

Combining the first partial result and the second partial result comprises reading the first partial result from the on-chip memory.

Performing the first pass through the layer group may comprise:
processing, by the first core in a series of consecutive sub-passes, all subsets of the first instance through the layer group using the first subset of parameter data stored in the second memory device, to produce a set of partial results; and
combining the set of partial results.

Performing the first pass through the layer group may comprise storing, in the on-chip memory, the accumulated output data. Combining the set of partial results may comprise:
for each sub-pass after the second sub-pass:
   obtaining the accumulated output data;
   updating the accumulated output data by combining the accumulated output data with output data of the current pass; and
   storing the updated accumulated output data.

The accumulated output data may be stored in the on-chip memory. Storing the accumulated output in the on-chip memory may comprise overwriting the accumulated output data already stored in the on-chip memory.

The method may comprise:
comparing a size in memory of the accumulated output data with a threshold; and
if the size in memory of the accumulated output data exceeds the threshold, either:
   stopping execution of the first layer group; or
   storing the accumulated output data in a memory device other than the on-chip memory.

The threshold may be representative of an available memory capacity of the on-chip memory, or may be a configurable percentage of the total memory capacity of the on chip memory (for example, a percentage in the range 50%-100% of the capacity of the on-chip memory).

The accumulated output data may be stored in the first memory device if the threshold is exceeded where the on-chip memory is a S-OCM, or in a S-OCM where the on-chip memory is not an S-OCM.

In some examples, each subset of the first instance is processed through the layer group by the first core.

According to another aspect, there is provided a hardware implementation of a neural network. The neural network comprises a plurality of layers. The hardware implementation comprises:
a data retrieval unit configured to obtain a control stream defining a layer group of the neural network, the layer group consisting of one or more consecutive layers of the neural network;
a first memory device configured to store input data for the layer group and parameter data for the layer group, wherein the input data is a multidimensional tensor having dimensions [N>1, C, . . . , H, W] and comprises at least a first instance and a second instance of data, each instance of data having dimensions [1, C, . . . , H, W];
a second memory device configured to store a first subset of parameter data; and
a first core configured to:
   in a first pass, process the first instance through the layer group using the first subset of parameter data stored in the second memory device; and
   in a second pass, process the second instance through the layer group using the first subset of parameter data stored in the second memory device,
      wherein:
the second memory device is configured to maintain the first subset of parameter data at least until after the start of the second pass, thereby re-using the first subset of parameter data stored in the second memory device; and
the second memory device has a lower cost to access than the first memory device.

The second memory device may be an on-chip memory. The second memory device may be a parameter buffer and may reside in and/or be accessible only to the first core. The splitting unit may reside in the first core. The first parameter buffer may be accessible only to the first core.

The hardware implementation may comprise a second core and a third memory device, wherein:
the third memory device is configured to store the second subset of parameter data;
the second core is configured to:
   in a third pass, process the first instance through the layer group using the second subset of parameter data stored in the third memory device; and
   in a fourth pass, process the second instance through the layer group using the second subset of parameter data stored in the third memory device;
the third memory device is configured to maintain the second subset of parameter data during the third pass and at least until after the start of the fourth pass, thereby re-using the second subset of parameter data stored in the third memory device; and
the third memory device has a lower cost to access than the first memory device.

The third memory device may be a parameter buffer of the second core.

The first core may be configured to:
process a first subset of the first instance through the layer group in a first sub-pass using the first subset of parameter data stored in the second memory device, to produce a first partial result;
process a second subset of the first instance through the layer group in a second sub-pass using the first subset of parameter data stored in the second memory device, to produce a second partial result; and
combine the first partial result and the second partial result to produce accumulated output data, and
the hardware implementation may further comprise an on-chip memory configured to store the first partial result.

The first subset of the first instance may be stored in an input buffer of the first core. The input buffer may be the on-chip memory.

The first instance of input data may be split in the channel dimension. That is, the first subset of the first instance and the second subset of the first instance may comprise different elements of data in the channel dimension.

The on-chip memory may have a lower cost to access than the first memory. Combining the first partial result and the second partial result comprises reading the first partial result from the on-chip memory.

The first core may be configured to:
compare a size in memory of the accumulated output data with a threshold; and
if the size in memory of the accumulated output data exceeds the threshold either:
   stop execution of the first layer group; or
   store the accumulated output data in a memory device other than the on-chip memory.

Stopping execution of the first layer group means to stop processing the first instance of input data through the layer group.

Also provided is a neural network accelerator or graphics processing system configured to perform the method summarised above and/or comprising the hardware implementation summarised above.

The neural network accelerator or graphics processing system may be embodied in hardware on an integrated circuit.

Also provided is a method of manufacturing, using an integrated circuit manufacturing system, a hardware implementation as summarised above or a neural network accelerator or graphics processing system as summarised above.

The method may comprise:
processing, using a layout processing system, a computer readable description of the hardware implementation or neural network accelerator or graphics processing system so as to generate a circuit layout description of an integrated circuit embodying the hardware implementation or neural network accelerator or graphics processing system; and
manufacturing, using an integrated circuit generation system, the hardware implementation or neural network accelerator or graphics processing system according to the circuit layout description.

Also provided is a computer-implemented method of generating a control stream for evaluating a neural network. The neural network comprises a plurality of layers. The method comprises:
obtaining a layer group, the layer group consisting of one or more consecutive layers of the neural network, wherein input data for the layer group is a multidimensional tensor having dimensions [N>1, C, . . . , H, W] and comprises at least a first instance and a second instance each having dimensions [1, C, . . . , H, W]; and
generating a control stream defining the layer group and comprising an instruction to:
   obtain a first subset of parameter from a first memory device and store the first subset of parameter data in a second memory device, wherein the second memory device has a lower cost to access than the first memory device;
   perform a first pass through the layer group by processing the first instance through the layer group using the first subset of parameter data stored in the second memory device; and
   re-use the first subset of parameter data stored in the second memory device to perform a second pass through the layer group by processing the second instance through the layer group using the first subset of parameter data stored in the second memory device.

The control stream may comprise an instruction to maintain the first subset of parameter data in the memory device at least until the completion of the second pass.

The method may comprise splitting the parameter data for the layer group into the first subset of parameter data and a second subset of parameter data. Splitting the parameter data may comprise identifying the first subset of parameter data and the second subset of parameter data and providing, in the control stream, a pointer to an address in memory from which the first subset of parameter data can be obtained. Alternatively, the control stream may comprise the first subset of parameter data, meaning that the first subset of parameter data may be encoded in the control stream.

By “defining the layer group” it is meant that the control stream indicates which layers of the neural network are part of the layer group.

The method may comprise detecting that the parameter data for the layer group has a size in memory greater than a threshold and splitting the parameter data for the layer group into the first subset of parameter data and a second subset of parameter data in response to the detecting.

The threshold may represent a memory capacity of the memory device (that is, the second memory device mentioned above). The threshold may be a configurable percentage of the memory capacity of the memory device, such as between 50% and 100% of the memory capacity of the memory device.

The parameter data may comprise a tensor having dimensions [N_{f}, C_{f}, . . . , H_{f}, W_{f}]. The parameter data may be split in the batch dimension such that the first subset of parameter data comprises a first subset of the tensor in the batch dimension and the second subset of parameter data comprises a second subset of the tensor in the batch dimension.

In other words, the first subset of parameter data may comprise a first subset of batches of the tensor and the second subset of parameter data comprises a second, different, subset of batches of the tensor.

The method may comprise splitting the first instance of input data in the channel dimension into at least a first subset of the first instance and a second subset of the second instance.

The method may comprise splitting the first instance of the input data if a size in memory of the first instance of input data exceeds a second threshold.

The second threshold may be indicative of an available memory capacity of the input buffer. The second threshold may be a configurable percentage of the memory capacity of the input buffer.

Also provided is computer readable code configured to cause the method summarised above to be performed when the code is run.

Also provided is a computer readable storage medium having encoded thereon the computer readable code summarised above. The computer readable storage medium may be non-transitory.

Also provided is an integrated circuit definition dataset that, when processed in an integrated circuit manufacturing system, configures the integrated circuit manufacturing system to manufacture a hardware implementation as summarised above or a neural network accelerator or graphics processing system as summarised above.

Also provided is a computer readable storage medium having stored there on a computer readable description of a hardware implementation as summarised above or a neural network accelerator or graphics processing system as summarised above that, when processed in an integrated circuit manufacturing system, causes the integrated circuit manufacturing system to manufacture an integrated circuit embodying the hardware implementation or neural network accelerator or graphics processing system.

Also provided is a (optionally non-transitory) computer readable storage medium having stored there on a computer readable description of a hardware implementation as summarised above or a neural network accelerator or graphics processing system as summarised above which, when processed in an integrated circuit manufacturing system, causes the integrated circuit manufacturing system to:
process, using a layout processing system, the computer readable description of the hardware implementation or neural network accelerator or graphics processing system so as to generate a circuit layout description of an integrated circuit embodying the hardware implementation or neural network accelerator or graphics processing system; and
manufacture, using an integrated circuit generation system, the hardware implementation or neural network accelerator or graphics processing system according to the circuit layout description.

Also provided is an integrated circuit manufacturing system configured to manufacture a hardware implementation as summarised above or a neural network accelerator or graphics processing system as summarised above.

The integrated circuit manufacturing system may comprise:
a non-transitory computer readable storage medium having stored there on a computer readable description of the hardware implementation or neural network accelerator or graphics processing system;
a layout processing system configured to process the computer readable description so as to generate a circuit layout description of an integrated circuit embodying the hardware implementation or neural network accelerator or graphics processing system; and
an integrated circuit generation system configured to manufacture the hardware implementation or neural network accelerator or graphics processing system according to the circuit layout description.

The layout processing system may be configured to determine positional information for logical components of a circuit derived from the integrated circuit description so as to generate a circuit layout description of an integrated circuit embodying the hardware implementation or neural network accelerator or graphics processing system.

Also provided is a computing device comprising means for performing the method summarised above. The computing device may be a data processing system. The computing device may be general purpose computer. The means for performing the method may be a CPU.

There may be provided an integrated circuit manufacturing system comprising: a non-transitory computer readable storage medium having stored thereon a computer readable description of the hardware implementation, graphics processing system or NNA; a layout processing system configured to process the computer readable description so as to generate a circuit layout description of an integrated circuit embodying the hardware implementation, graphics processing system or NNA; and an integrated circuit generation system configured to manufacture the hardware implementation, GPU or NNA according to the circuit layout description.

There may be provided computer program code for performing any of the methods described herein. There may be provided a non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 depicts an exemplary instance of input data for a neural network, and two tiles making up the instance of input data;

FIG. 2 depicts an exemplary neural network and the flow of data through an exemplary hardware implementation implementing the neural network;

FIG. 3 depicts an example of a batch of input data for a neural network;

FIG. 4 is a block diagram of a computing system comprising an example of a multi-core hardware implementation of a neural network;

FIG. 5A is a flowchart showing an exemplary method of generating a control stream;

FIG. 5B is an exemplary method of evaluating a neural network according to the control stream of FIG. 5A;

FIG. 6 depicts three variations of tile interleaved batching applied to the processing of the batch of input data of FIG. 3;

FIG. 7 is a block diagram of a computing system comprising an example of a multi-core hardware implementation of a neural network according to a second example;

FIG. 8A is a flowchart showing another example of a method of generating a control stream;

FIG. 8B is a flowchart showing an example of a method of evaluating a neural network according to the control stream of FIG. 8A;

FIG. 9 is a block diagram of a hardware accelerator for implementing a convolutional neural network, according to an example;

FIG. 10 is a block diagram of a computing system comprising an example of a multi-core hardware implementation of a neural network according to a third example;

FIG. 11A is a flowchart showing another example of a method of generating a control stream;

FIG. 11B is a flowchart showing another example of a method of evaluating a neural network;

FIG. 11C is a flowchart showing another example of a method of evaluating a neural network;

FIG. 12A depicts a neural network according to an example;

FIG. 12B depicts a neural network comprising a set of transformed layers according to an example;

FIG. 13A depicts input data for a set of C″×1×1 generating layers according to an example;

FIG. 13B depicts the input data of FIG. 13A after undergoing an example of a space-to-depth transformation;

FIG. 13C depicts the data of FIG. 13B after having undergone an example of a batch-to-space transformation;

FIG. 13D depicts an example of output data of a set of transformed layers after having undergone a space-to-batch transformation;

FIG. 14 depicts the distribution of the data of FIG. 13C amongst processing engines of a an exemplary core;

FIG. 15 shows a computer system in which a hardware implementation is implemented; and

FIG. 16 shows an integrated circuit manufacturing system for generating an integrated circuit embodying a graphics processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

### Tile Group Interleaved Batching

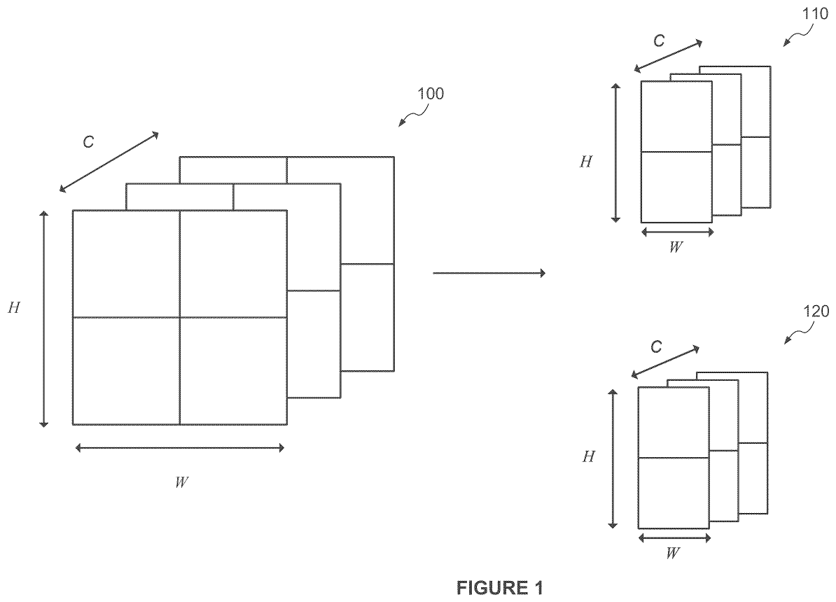

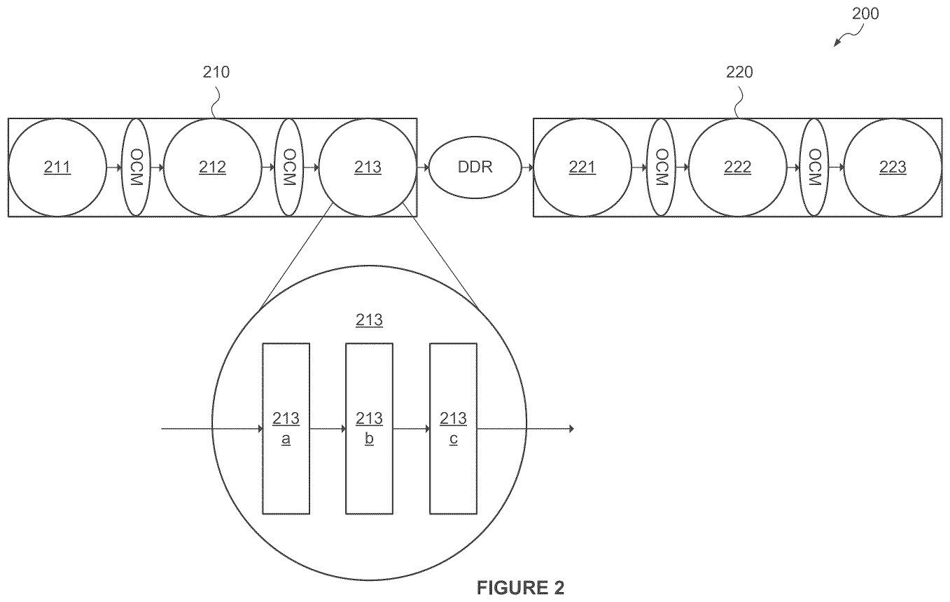

A comparative example of a method of processing an instance of input data through a tile group of a neural network is described below with reference to FIGS. 1 and 2.

An exemplary instance 100 of input data is depicted in FIG. 1. This instance 100 can be split into two (or more) tiles 110, 120 along one of channel or spatial dimensions. In other words, the instance can be thought of as being made up of the two tiles 110, 120. These tiles 110, 120 are also referred to as ‘parts’ or ‘subsets’ of the instance. In the example of FIG. 1, the instance 100 of input data is split in the width dimension to provide tiles 110 and 120. In other examples, the instance 100 may be split in the height dimension. When processing the input data 100 through a neural network, each tile 110, 120 can be processed through the tile groups of the neural network to thereby evaluate the neural network.

FIG. 2 depicts an exemplary neural network 200, comprising two tile groups 210 and 220, each tile group consists of three layer groups. In the present example, layer group 213 contains layers 213a, 213b and 213c.

One approach to processing the instance 100 through neural network 200 (that is, evaluating neural network 200 for instance 100) using multiple cores involves processing each tile of the instance through the tile groups using the multiple cores. In a corresponding single-core implementation, each tile is processed through the neural network in turn (that is, one tile is processed through the tile groups and then the next tile is processed through the tile group).

Some layers of a neural network implement windowed operations. Windowed operations are operations that apply a filter to a portion of the input data. The filter may be traversed in strides across one or more of the dimensions of the input data (known as traversed dimensions). The traversed dimensions may be the spatial dimensions. An example of a layer that implements a windowed operation is a convolution layer. If the input data for such a layer is larger than a threshold size in one of the traversed dimensions, an efficient implementation of tiling is to split the input data into tiles along that traversed dimension and evaluate the tile group using depth-first tiling. Depth-first tiling refers to the technique in which a core processes a tile of input data through multiple consecutive layer groups of a tile group before processing any other tiles of data.

If the input data is not larger than a threshold in said dimension, then the choice of dimension along which to split the input data is less important. The input data can be split along any of its dimensions and the resulting tiles can be processed through a given tile group in passes. A pass refers to processing a tile (or an instance in its entirety) through a tile group using a subset of the parameter data for that tile group. For example, an instance might be processed through a tile group in two passes by evaluating the tile group using a first subset of the parameter data and then evaluating the tile group using a second of the parameter data. Parameter data refers to the data needed to evaluate the tile group, such as the weights and biases of the layers of the tile group.

When evaluating a neural network, each tile of input data must be processed through the same layer(s) in each tile group. Consequently, the core evaluating a given tile group requires access to the same parameter data in order to process each tile through that tile group. To reduce the cost (in terms of time and bandwidth) associated with a core obtaining the parameter data, which is often stored in an external memory, the parameter data can be copied from external memory and stored in an on-chip memory (OCM). The core can then access the OCM to obtain the parameter data as needed. If the core accesses the OCM for the parameter data more than once then a bandwidth saving has been made because the cost to access the on-chip memory is lower than the cost to access the external memory. In other words, the parameter data for a tile group can be loaded into the on-chip memory once, and re-used by the core for multiple tiles, thereby reducing the resources spent accessing external memory. This efficiency gain can be magnified in multi-core systems in which the parameter data can be stored on a shared on-chip memory (S-OCM) that is accessible by more than one core.

In some examples of multi-core systems, each core may comprise a private (not accessible to any other core) on-chip memory for storing parameter data, known as a parameter buffer (PBUF). Parameter data can be copied from external memory into a S-OCM, from which the cores can obtain the parameter data and store it in their PBUFs for use evaluating the tile group. Once the evaluation of a tile group is complete, the parameter data for that tile group is no longer required by any of the cores, and so can be removed from the S-OCM. Parameter data for the next tile group can then be stored in the S-OCM, ready for the evaluation of the next tile group.

This approach to processing input data through a neural network is effective when the input data contains only a single instance (in other words, when the batch size of the input data is 1). The approach can be extended to processing batches of input data by processing a first instance through the neural network as described above, and then processing a subsequent instance through the neural network in the same manner. However, this is inefficient because there is no re-use of data between instances, meaning that the parameter data for each tile group must be freshly obtained from external memory for each instance. Consequently, the bandwidth used in accessing external memory to process N instances is approximately N lots of the bandwidth used to process a single instance. Tile group interleaved batching provides a more efficient approach to processing batches of data through a neural network.

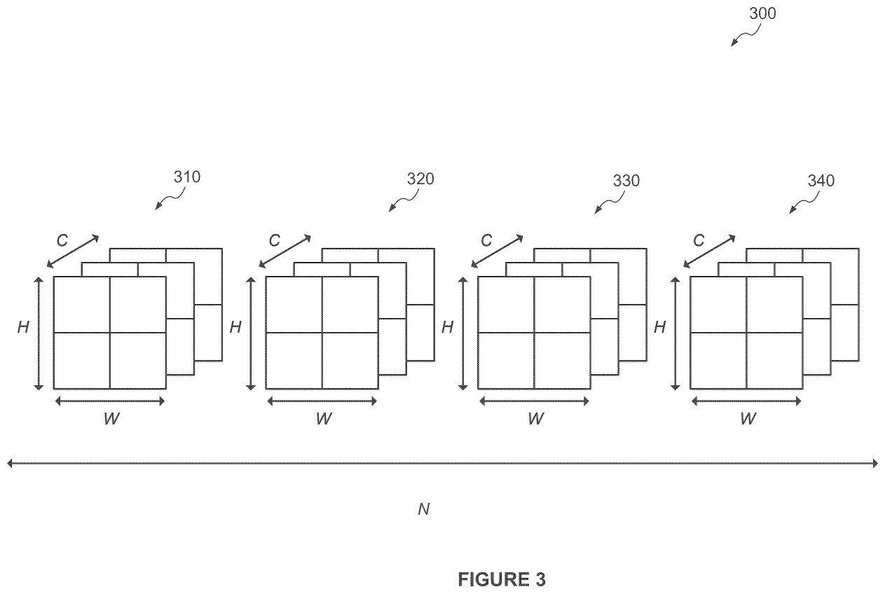

An exemplary batch 300 of input data is depicted in FIG. 3. In this example, the batch size (N) is 4, with each instance 310, 320, 330, 340 of the batch 300 having the same dimensionality as the instance 100 shown in FIG. 1.

As mentioned above, a simple (but less efficient) approach to processing this batch 300 of input data through the neural network 200 of FIG. 2 is to process each instance 310, 320, 330, 340 through the entire neural network in turn. For example, according to a comparative method, the first instance 310 is processed through the tile groups 210 and 220 of the neural network 200, then the second instance 320 is processed through the tile groups 210 and 220 of the neural network 200, and so on until the batch is fully processed. At the start of the evaluation of the first tile group 210, parameter data for the first tile group 210 is stored on-chip as described above. Tiles of the first instance are then processed through the first tile group 210 using the parameter data stored on-chip. Once the evaluation of the first tile group 210 for instance 310 is completed, the parameter data stored on-chip is discarded and parameter data for the second tile group 220 is stored on-chip. The core can then evaluate the second tile group 220 for that instance. This approach can be extended to multiple cores by using a S-OCM as described above, or with each core storing the parameter data for a tile group directly from external memory into a private OCM.

While this approach has the benefit of re-using parameter data stored on-chip for different tiles of a given instance, the approach requires that the parameter data for each tile group is read from the external memory and stored on-chip N times. This is because, between two instances, there is no re-use of the parameter data stored on-chip when evaluating a given tile group.

Tile group interleaved batching provides a more efficient method of evaluating a neural network for a batch of input data. In tile group interleaved batching, more than one instance of input data is processed through a given tile group using the parameter data stored on-chip. In other words, multiple instances are processed through a tile group using the parameter data stored on-chip before the next tile group is evaluated. For example, at least two instances may be processed through the first tile group 210 before any data is processed through the second tile group 220. Once at least two instances have been processed through the first tile group 210, the parameter data for the first tile group 210 stored on-chip can be replaced with the parameter data for the second tile group 220 and the second tile group 220 can be evaluated. By re-using parameter data between more than one instance, the number of times the parameter data is read from external memory is reduced, improving performance and reducing bandwidth consumption.

A method of evaluating a neural network using a tile group interleaved batching method will now be explained in more detail with reference to FIGS. 2-5. In the example described below, the batch 300 of input data of FIG. 3 is processed through the neural network 200 of FIG. 2.

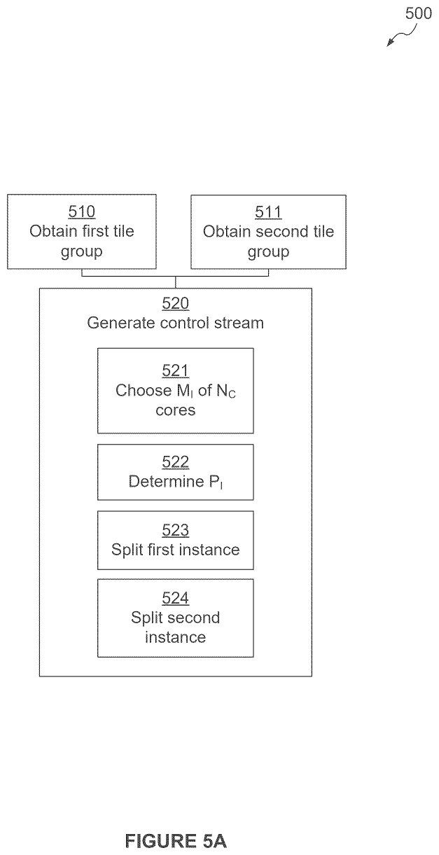

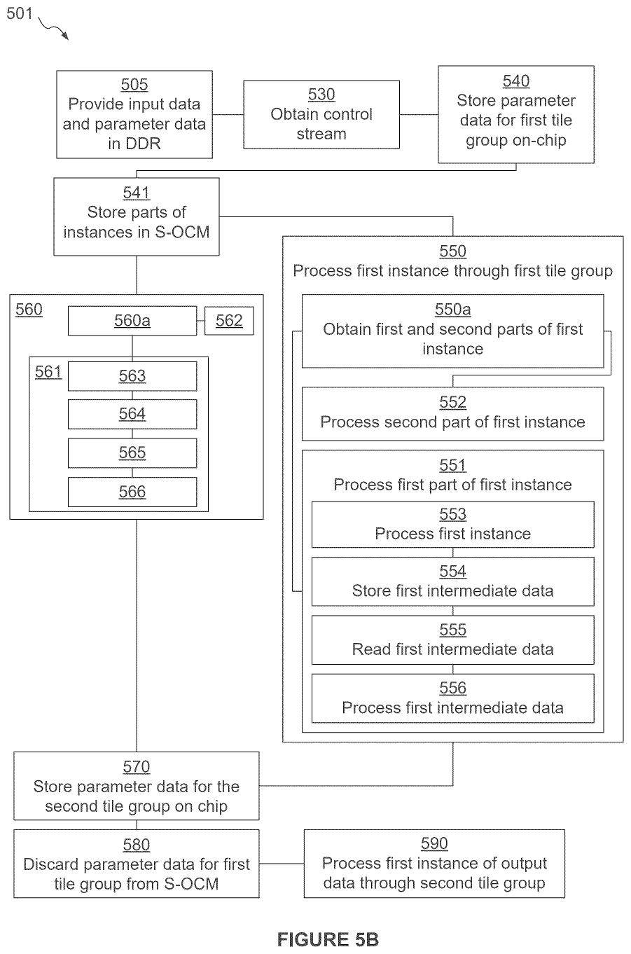

First, a method 500 of generating a control stream will be described with reference to FIG. 5A. The control stream defines the tile groups of the neural network 200 and indicates how the input data 300 should be processed through the neural network 200.

In steps 510 and 511, a computing device 410 obtains first tile group 210 and second tile group 220 of neural network 200. Obtaining the tile groups comprises grouping the layers of the neural network 200 into layer groups and grouping those layer groups into tile groups to thereby define the tile groups, based on the specifications of hardware implementation 401. In the present example this grouping is based on the memory capacity of the S-OCM 430 of the hardware implementation and of the capacities of the private OCMs 470. To efficiently evaluate the neural network, the S-OCM 430 and/or the private OCMs 470 need to be able to store all the parameter data required to evaluate a single tile group, such that each core 460, 461, 462, 463 can obtain the required parameter data from the S-OCM 430 and/or from its private OCM 470. Accordingly, the sizes of the tile groups are limited by the memory capacities of the on-chip memories.

In step 520, the computing device 410 generates a control stream defining the first tile group and the second tile group and containing instructions on how to evaluate the tile groups. The control stream contains information that tells the hardware implementation which layers make up each layer group and tile group, as well as where in DDR 420 the parameter data for each tile group and the input data for the first tile group 210 can be found.

Generating 520 the control stream comprises choosing 521 a number M_{I} of the N_{C} cores in the hardware implementation to process, in parallel, a given instance of the input data through the first tile group, wherein 1≤M_{I}≤N_{C}. In the present example the hardware implementation comprises four cores so N_{C}=4. Choosing 521 a value for My means choosing between (and including) 1 to N_{C} cores to process a given instance through the first tile group in parallel. Wherein M_{I}=1, an instance is processed by one core. Where M_{I}>1, an instance is processed in parallel by M_{I} of the cores using tiling. In the present example, M_{I}=2, meaning a given instance will be processed through a tile group using two cores.

Next, in step 522 the number P_{I} of instances of the input data to be processed in parallel through the first tile group 210 is determined using the equation

$${P}_{I} = floor ( \frac{{N}_{C}}{{M}_{I}} ) .$$

The use of this equation aims to avoid underutilising cores in the hardware implementation by ensuring that the number of instances processed in parallel (with each instance being processed by My cores) is one that can be distributed evenly across all the N_{C} cores such that all cores are utilised evenly. Given that, in this example, M_{I}=2 and N_{C}=4, P_{I} has a value of 2. This means that two instances of input data can be processed at any given time. Because M_{I}=2, two of the cores will work in parallel to process one instance of input data through a tile group while the other two cores work in parallel to process another instance of input data through the tile group.

The above-mentioned choices of M_{I}, N_{C} and P_{I} are particularly efficient because they satisfy the conditions N % P_{I}=0, N≥P_{I}, N_{C}% M_{I}=0 and N_{C}=M_{I}×P_{I}. The condition N>P_{I} ensures that that the hardware implementation is not attempting to process in parallel more instances than exist in the input data. The condition N_{C}% M_{I}=0 means that the number of cores allocated to process a given instance is a factor of the total number of cores, enabling all of the cores to be utilised in processing instances through the neural network (provided that that the value of P_{I} is large enough that N_{C}=M_{I}×P_{I}) and helping to ensure that each group of cores takes approximately the same length of time to process an instance (if enough instances are processed in parallel to utilised each group of cores). The condition N % P_{I}=0 ensures that that the batch size N of the input data is an integer multiple of the number of parallel instances P_{I}, which avoids cores being left idle as the final instances of input data are processed.

The control stream includes an indication of the values of M_{I} and P_{I}, which are used by the hardware implementation to evaluate the neural network 200.

Because, in this example, M_{I}=P_{I}=2, the first and second instances of input data each need to be split into two parts (tiles) such that each instance can be processed through the first tile group by two cores. Accordingly, in step 523 the first instance is split into M_{I}=2 parts and in step 524 the second instance is split into M_{I}=2 parts. The first and second instances may be split in the height, width or channel dimension. In the present example the instances are split in the width dimension, as shown in FIG. 1. The splitting may be implemented by determining where in DDR 420 each part of the instances is stored ad providing in the control stream an indication of where in DDR 420 the first and second parts of the first and second instances can be found.

Now turning to the method 501 of evaluating the neural network in FIG. 5B, in step 505 input data for the first tile group and parameter data for the first tile group are provided in DDR 420. This step may be performed before, or in parallel with, method 500.

In step 530, data retrieval unit 435 obtains the control stream described above. As mentioned above, the control stream defines the first and second tile groups, as well as providing an indication of M_{I} and P_{I} and containing information about where in memory the parts of the first and second instances can be obtained.

In step 540, the parameter data for the first tile group is obtained from DDR 420 and stored on-chip (that is, in the on-chip memory of the hardware implementation 401). In the present example, the parameter data is stored in S-OCM 430, from which the cores store the parameter data in their private OCMs 470-473 for use in evaluating the first tile group. In some other examples the S-OCM may not be present, and the parameter data may be stored directly in the private OCMs 470-473. In other examples, the cores may use the parameter data directly from S-OCM 430.

In step 541, the first and second parts of the first and second instances are stored in S-OCM 430. In examples in which S-OCM 430 is not present the first and second parts of the first instance may be stored in a different on-chip memory for use evaluating the tile groups. Alternatively, the first and second parts of the first and second instances may be obtained by the cores directly from DDR 420 as needed.

Based on the control stream, in step 550 the first instance 310 of input data is processed through the first tile group 210 using the parameter data stored on-chip. In the present example, because M_{I}=2 and the first instance 310 has been split into two parts, processing 550 the first instance through the first tile group comprises obtaining 550a the first and second parts of the first instance and using core 0 460 to process 551 the first part of the first instance through the first tile group and using core 1 461 to process 552 the second part of the first instance through the first tile group 210. Cores 460 and 461 operate in parallel, each processing a different part of the first instance through the first tile group concurrently. In this way, a first instance of output data for the first tile group is produced.

Similarly, processing 560 the second instance through the first tile group comprises obtaining 560a the first and second parts of the second instance. In step 561 core 2 462 processes the first part of the second instance through the first tile group using the parameter data stored on-chip and in step 562 core 3 463 processes the second part of the second instance through the first tile group using the parameter data stored on-chip. Importantly, the processing of the second instance through the first tile group occurs before the evaluation of the second tile group, meaning that the parameter data for the first tile group that is stored on-chip is re-used between two instances. Cores 462 and 463 operate in parallel, processing different parts of the second instance through the first tile group concurrently. In this way, a second instance of output data for the first tile group is produced.

In step 570, parameter data for the second tile group is stored on-chip. In the present example, it is stored in S-OCM 430.

In step 580, the parameter data for the first tile group 210 stored in S-OCM 430 is discarded. This discarding happens only after the stored parameter data has been re-used at least once. In some examples, the discarding may only occur once every instance of the input data has been processed through the first tile group 210. While step 580 is depicted in FIG. 5B as occurring after step 570, step 580 may be performed before or after step 570. The parameter data for the first tile group 210 may be overwritten by the parameter data for the second tile group 220. The same storing and discarding may be performed for private OCMs 470-473, replacing the parameter data for the first tile group with the parameter data for the second tile group.

In step 590, the hardware implementation 400 processes the first instance of output data through the second tile group 220. This could be done in the same way that the first instance was processed through the first tile group, (using two cores) or it could be done according to a different implementation of tile group interleaving, such as by using all four cores or by using only core 0 460.

In some examples, a multi-core hardware implementation might not comprise a S-OCM. In such examples, each core may have only a private OCM (which, in some examples is an L2 cache). To ensure the re-use of parameter data in these examples, at least one core (and preferably all of the cores) may process more than one instance of input data (and/or more than one part of one or more instances) through a given tile group.

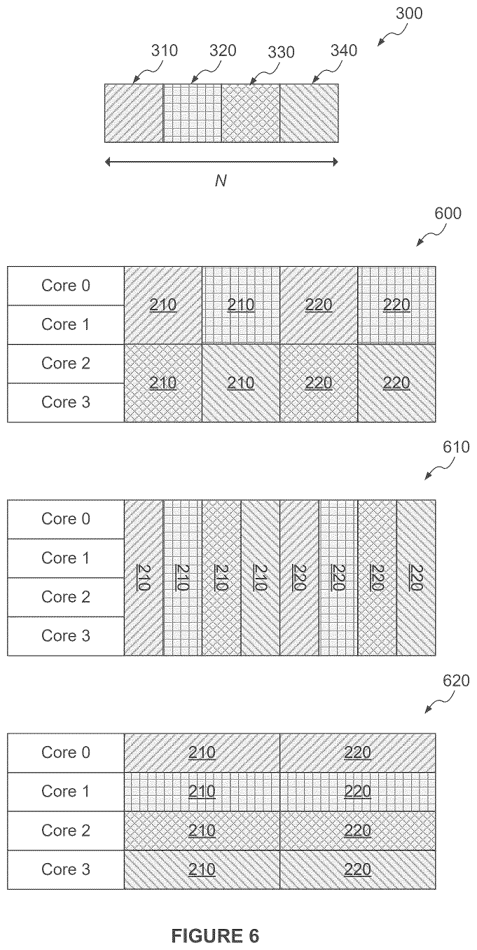

Depending on the values of M_{I}, N_{C} and P_{I}, the neural network can be evaluated according to three variations of tile group interleaving. These three variations are depicted in FIG. 6, for the batch 300 of input data of FIG. 3. The three variations are unified in that, in each variation, parameter data stored on-chip is re-used at least once. In other words, at least two instances are processed through a given tile group before the parameter data for that tile group stored on-chip is replaced by parameter data for a subsequent tile group.

The example described above, where M_{I}=2, N_{C}=4 and P_{I}=2 is an example of ‘type B’ multi-instance batching 600. Type B multi-instance batching 600 refers to an implementation in which more than one instance is processed at a time (in other words, P_{I}>1 and N_{C}>1), and in which more than one core is used in the processing of a given instance (M_{I}≥2). Other evaluation methods that fall under the umbrella of tile group interleaving are single-instance batching 610 and ‘type A’ multi-instance batching 620.

In single-instance batching 610, the hardware implementation processes one instance at a time (P_{I}=1). This can be implemented in single-core hardware implementation (where N_{C}=M_{I}=1) or in multi-core implementation (where N_{C}≥M_{I}>1). In multi-core implementations of single-instance batching 610, as depicted in FIG. 6, each core (or at least two cores) processes a different part of a given instance in parallel through a given tile group.

In type A multi-instance batching 620, each core processes a different instance of input data (M_{I}=1). In a single-core implementation, this becomes the same as single-instance batching. However, in a multi-core implementation the cores can be used concurrently to process different instances through the tile groups (N_{C}≥P_{I}>1).

Returning to the method of FIG. 5B, the processing 550 of the first instance through the first tile group will be explained in more detail. As explained above with reference to FIG. 2, the first tile group 210 contains three layer groups 211-213. Processing an instance (or a part of an instance, as is discussed below) of input data through the first tile group 210 therefore comprises processing each layer group of the tile group in turn.

Processing 553 the first instance 310 through the first layer group 211 of the first tile group 210 produces first intermediate data. This first intermediate data is the input data for the second layer group 212 and is stored 554 on-chip. In the example described above, core 0 460 processed the first part of the first instance 310 through the first tile group 210. Accordingly, the result of processing 553 the first part of the first instance 310 through the first layer group 211 is first intermediate data and is stored 554 in the private OCM 470 (and/or in S-OCM 430).

To continue evaluating the first tile group, core 0 460 then reads 555 the first intermediate data from its private OCM 470 and processes 556 the first intermediate data through the second layer group of the first tile group. This process continues until the first tile group has been evaluated for the first instance (or, where the instance is split, the part of the instance being processed by that core). Corresponding processing 563, storing 564, reading 565 and processing 566 steps are performed by core 2 462 for the first part of the second instance. While not depicted in FIG. 5B, where the first instance is split as described above, corresponding steps may be performed in the processing 552 of the second part of the first instance through the first tile group 210 and for the processing 562 of the second part of the second instance through the first tile group.

In the examples described above, the memory 420 is an external memory and the memories 430 and 470-473 are on-chip memory. However, in other examples the memories 420, 430 and 470-473 can be external or internal, so long as the memories 430 and 470-473 have a lower cost (in terms of time and/or bandwidth) to access than the memory 420. The input data for the first tile group may be stored on-chip.

In the example described above, all four cores of the hardware implementation 400 were used in evaluating the first tile group 210. However, in other examples a different number of cores may be used. Furthermore, it should be understood that a different number of cores may be used to evaluate the first and second tile groups 220. In some examples, different variations of the tile interleaved batching method may be used to evaluate the first and second tile groups.

While, in the example of FIG. 5B, the method 501 included steps 541, 550a, 551-556, 560a, 561-566 and 570-590, it should be understood that these steps are not essential and that in other examples the method may consist of steps 505, 530, 540, 550 and 560.

Similarly, steps 521-524 of method 500 are optional and some examples might not include these steps. In the method 500 described above, the computing device 410 grouped the layer of the neural network into layer groups and tile groups. However, in some examples this grouping may be performed by a different device and device 410 may simply obtain definitions of the tile groups.

In some examples, the hardware implementation may be hardcoded with values for M_{I} and P_{I} or may obtain these values from a source other than the control stream. In some examples, M_{I}>1.

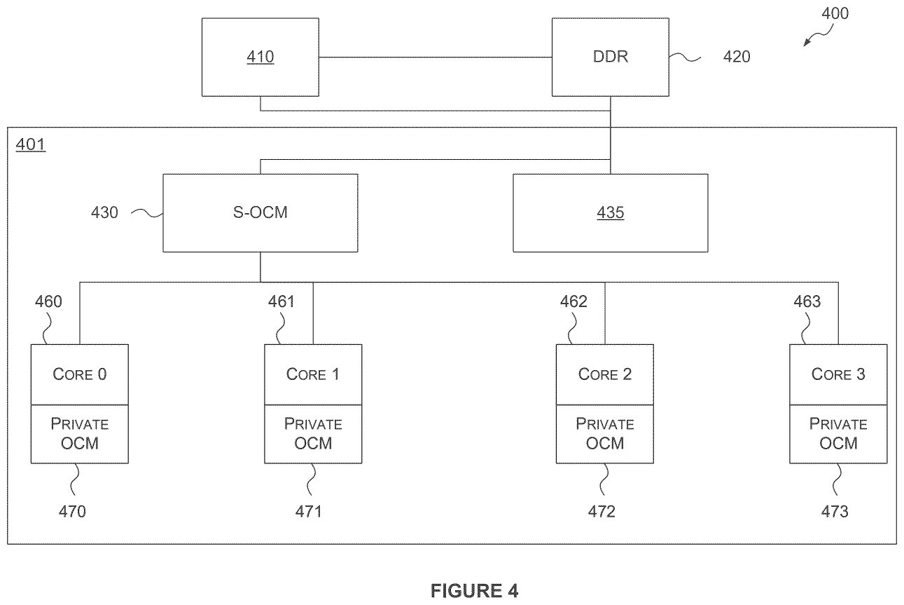

The exemplary hardware implementation of FIG. 4 comprises more than one core. However, in some examples, the hardware implementation may consist of a single core. In such examples, the S-OCM 430 of FIG. 4 may be an on-chip memory that is not shared between multiple cores or may be absent entirely. Where the hardware implementation consists of a single core, N_{C} and M_{I} must have a value of one, meaning that P_{I} must also be equal to one.

In some examples, every instance may be processed through the first tile group before any instance is processed through the second tile group.

It should be understood that, to achieve re-use of the parameter data stored on-chip, the parameter data is maintained on-chip until the series of passes using that parameter data have been completed.

In multi-core implementations, while it may be advantageous to choose a value

$${P}_{I} = floor ( \frac{{N}_{C}}{{M}_{I}} ) ,$$

in some examples a value for P_{I} may be selected within the range

$$1 \leq {P}_{I} \leq floor ( \frac{{N}_{C}}{{M}_{I}} ) .$$

In some examples, a value for P_{I} may be selected within the range 1≤P_{I}≤N. In some examples, P_{I} is chosen to be equal to

$$floor ( \frac{{N}_{C}}{{M}_{I}} ) where floor ( \frac{{N}_{C}}{{M}_{I}} ) \leq N .$$

In some examples, P_{I} may be selected such that N_{C}=M_{I}×P_{I} to ensure that all of the N_{C} cores are utilised.

As explained above, it may be advantageous for the values of M_{I}, N_{C} and P_{I} to satisfy the conditions N % P_{I}=0, N≥P_{I} and N_{C}% M_{I}=0. Preferably, the values of M_{I}, N_{C} and P_{I} are further chosen such that N_{C}=M_{I}×P_{I}. In some examples one or more of these conditions might not be satisfied. This could, potentially, lead to some cores of the hardware implementation being left idle or being underutilised. The number of idle Cᵢ cores is calculated as N_{C}−M_{I}×P_{I}. Idle cores may be assigned other tasks to perform to avoid underutilising those cores.

While the processing of the third 330 and fourth 340 instances were not described above, the method performed to process the first and second instances may also be applied in processing the third and fourth instances. Alternatively, the third and fourth instances may be processed according to a different method, such as a different tile group interleaved variation or according to the comparative tiling method. In some examples, the tile group interleaving method might only be applied to the processing of some of the instances and a different method may be applied when processing the other instances.

In some examples, the input data for the first tile group might contain only two instances, or may contain any number of instances greater than two.

In some examples, the instances of input data might not be split into parts. Each core might process a different instance of input data.

In method 500, the layers of the neural network may have already been grouped into layer and tile groups, and the step of obtaining the tile groups may comprise obtaining the pre-determined definitions of the tile groups.

### Pass Interleaved Batching

As explained above, when evaluating a neural network it can be beneficial to store parameter data on-chip to reduce the number of accesses to external memory. To summarise, parameter data may be obtained from an external memory and stored on-chip so that, when a core requires the parameter data, it can be obtained from the on-chip memory. For the same reasons as apply to the parameter data, it may also be beneficial to store input data for a layer group on-chip. As with parameter data, the input data may be obtained from external memory and stored on-chip.

However, some layer groups of a neural network have more parameter data than can be stored on-chip. A tile group may be defined containing only such a large layer group, making the terms “layer group” and “tile group” interchangeable for this method. When evaluating such a layer the core(s) being used must access external memory to obtain the required parameter data.

One approach to evaluating a layer group having more parameter data than can be stored on-chip is to simply obtain the parameter data directly from external memory as needed. Another approach is to split the parameter data into subsets, each subset being small enough to fit into the on-chip memory. For example, the parameter data for a layer group may be split into first and second subsets of parameter data, each subset being small enough to be stored on-chip. The layer group can then be evaluated in passes using the first and second subsets of parameter data. The first subset of parameter data can be stored on-chip and used to perform a first pass through the layer group by processing input data through the layer group using the first subset of parameter data, and then the second subset of parameter data can be loaded on-chip and used to perform a second pass through the layer group by processing the input data through the layer group using the second subset of parameter data. For example, in a first pass the first subset of parameter data of the layer group is stored on-chip and input data is processed through the layer group using (only) the first subset of parameters stored on-chip. Then, in the second pass the second subset of parameter data is stored on-chip and the input data is processed through the layer group using (only) the second subset of parameters stored on-chip. This process can repeat for each subset of parameter data until the layer group is fully evaluated.

This approach can be extended to processing batches of input data by processing an instance of the batch through the layer group in passes, and then once the layer group has been fully evaluated for an instance repeating the process for the next instance. However, this approach requires new subsets of parameter data to be read from external memory for each successive pass. A consequence of this approach is that there is no re-use of the parameter data stored on-chip, making this approach is bandwidth intensive. The cost (in terms of time and bandwidth) of obtaining the subsets of parameter data grows with the batch size of the input data because each subset must be obtained from external memory once per instance.

The bandwidth used in processing a batch of input data through a layer group in passes can be reduced by using the pass interleaved batching method. In pass interleaved batching a first pass is performed, in which a first instance is processed through the layer group using a first subset of parameter data, and then a second pass is performed in which a second instance is processed through the layer group using the same subset of parameter data. In this way at least two passes can be performed using the subset of parameter data stored on-chip, reusing the stored parameter data. This reuse of the stored parameter data reduces the number of times that the core needs to obtain new subsets of parameter data when evaluating the layer group, reducing the bandwidth consumed by processing the batch through the layer group. The re-use of a subset of parameter data can be achieved between cores where a first core processes a first instance through a layer group using a subset of parameter data stored in an S-OCM and a second core processes a second instance through the layer group using the subset of parameter data stored in the S-OCM. The re-use of parameter data can also be achieved within a single core (in single core implementations or where a multi-core system does not comprise a S-OCM) by storing the subset of parameter data in a PBUF of a core (or more generally, in a private OCM of that core like an L2 cache) and using the core to perform the first and second passes mentioned above. By maintaining the parameter data on-chip between the two passes and using the subset of parameter data stored on-chip for the two passes, two instances can be processed through the layer group with only one access to external memory for parameter data. This can be extended to an arbitrary number of instances, reducing the number of accesses to external memory for parameter data by up to a factor of the batch size.

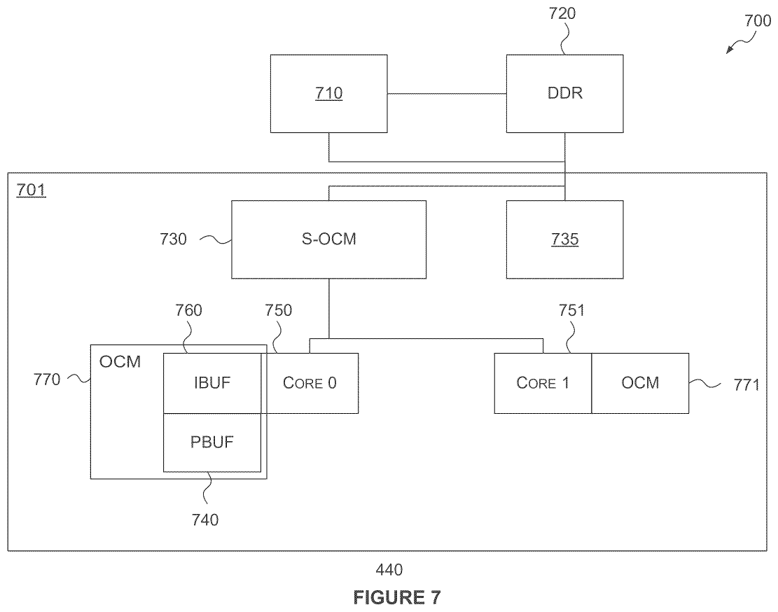

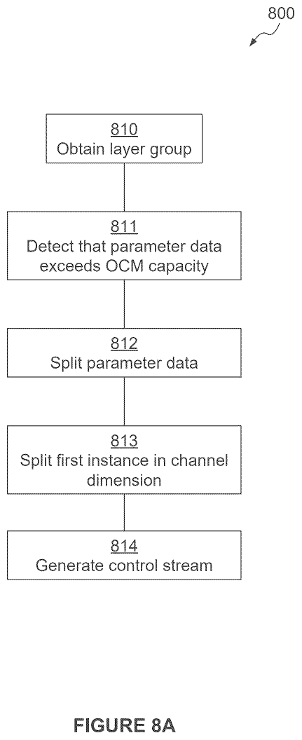

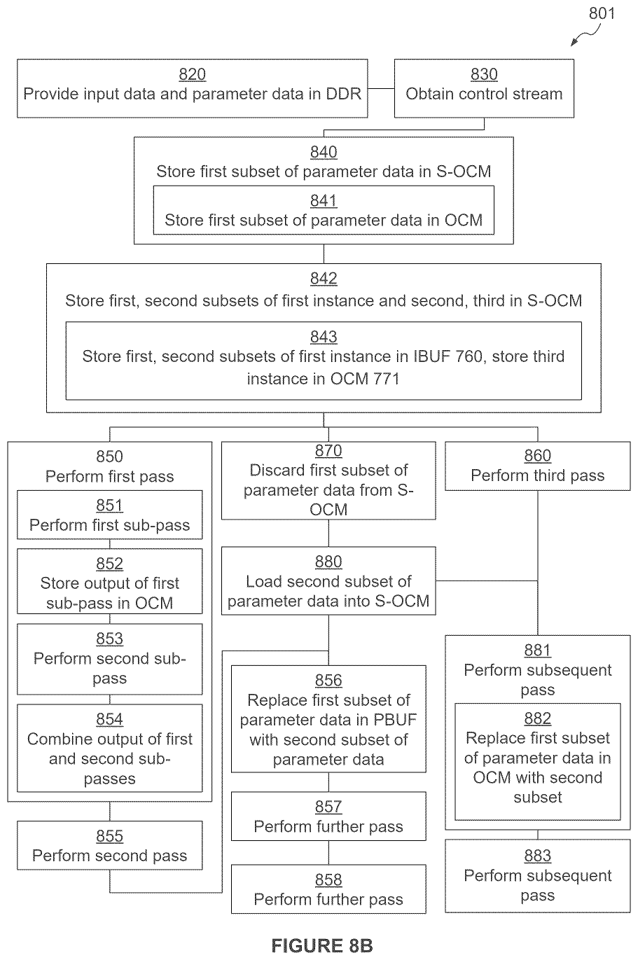

A method of evaluating a neural network using pass interleaved batching is described in detail below, with reference to the computing device 700 depicted in FIG. 7 and the flowchart of FIG. 8.

First, a method 800 of generating a control stream for evaluating the neural network will be described.

In step 810, computing device 710 obtains a layer group of the neural network that has more parameter data than can be stored on-chip in hardware implementation 701. Obtaining the layer group comprises defining the layer group by grouping together layers of the neural network. As explained above, a layer group is a set of consecutive layers that have been grouped together, the layers being able to be evaluated without needing to write intermediate data to an OCM. In the present example, a tile group is defined containing only the layer group, and so the terms “tile group” and “layer group” can be used interchangeably because the output of the layer group is the output of the tile group and is stored in external memory. The parameter data for the layer group exceeds the capacity of the on-chip memory. As with the tile group interleaved method, the input data for the layer group is a multi-dimensional tensor having dimension [N>1, C, . . . , H, W], comprising multiple instances. In this example, data 300 of FIG. 3 will be taken as the input data for the layer group.

In step 811, the computing device 710 detects that the parameter data for the layer group is larger in size than the on-chip memory capacity of OCM 770 and, in response, in step 812 the computing device 710 splits the parameter data for the layer group into a first subset of parameter data and a second subset of parameter data.

In the present example, the parameter data comprises data having dimensions [N_{f}, C_{f}, . . . , H_{f}, W_{f}]. More specifically, the parameter data contains N_{f} batches of filters and is split in the batch dimension (also known as an “F-split”). This provides a first subset of parameter data comprising a first subset of the filters in the batch dimension and a second subset of parameter data comprising a second subset of the filters in the batch dimension. In other words, each subset of parameter data contains different filters of the batch of filters. More generally, the subsets can be said to comprise different subsets of parameter data in the batch dimension. In the present example splitting the parameter data is achieved by locating in the DDR 720 the address of the first subset of parameter data and the second subset of parameter data and providing these addresses in the control stream.

In step 813 the computing device 710 splits the first instance 310 in the channel dimension to provide a first subset of the first instance and a second subset of the first instance. This is achieved by locating in DDR 720 the address of the first subset of the first instance and the second subset of the first instance.

In step 814, the computing device 710 generates a control stream defining the layer group and comprising instructions to perform a first pass through the layer group by processing the first instance through the layer group using a first subset of parameter data stored on-chip; and perform a second pass through the layer group by processing the second instance through the layer group using the first subset of parameter data stored on-chip. The control stream includes an indication of where in DDR 720 the first and second subsets of parameter data are stored, wherein in DDR 720 the first and second subsets of the first instance are stored and where in DDR 720 the second instance is stored.

Now turning to the method 801 of evaluating the neural network, in step 820, input data for the layer group and parameter data for the layer group are provided in DDR 720. As mentioned above the input data has the form [N>1, C, H, W].

In step 830, data retrieval unit 735 obtains the control stream defining the layer group and containing instructions for how to evaluate the layer group.

In step 840 the first subset of parameter data is stored on-chip (in the present example, in S-OCM 730). In step 841 the first subset of parameter data is stored in OCM 770 (in particular, in parameter buffer (PBUF) 740) and in OCM 771. In step 842, the first and second subsets of the first instance and the second and third instances are stored on-chip in S-OCM 730. In step 843 the first and second subsets of the first instance are stored in input buffer (IBUF) 760 of core 0 750 and the third instance is stored in OCM 771 of core 1 751. The OCMs 770 and 771 have a lower cost to access by their respective cores than S-OCM 730, which in turn has a lower cost to access than DDR 720.

Considering first the operation of core 0 750, the core performs a first pass 850 that processes the first instance through the layer group using the first subset of parameter data. The first pass is implemented as a series of sub-passes. In step 851, core 0 750 performs a first sub-pass through the layer group by processing the first part of the first instance through the layer group using the first subset of parameter data stored in PBUF 740 and the first subset of the first instance stored in IBUF 760. The output of the first sub-pass is stored 852 in OCM 770

The first subset of the parameter is maintained in PBUF 740 and is re-used to perform 853 a second sub-pass that processes the second subset of the first instance through the layer group. The output of the first and second sub-passes are combined 854 to produce accumulated output data that is the output of processing the first instance through the layer group using the first subset of parameter data.

With the first pass completed, in step 855 core 0 750 performs a second pass that processes the second instance through the layer group using the first subset of parameter data maintained in PBUF 740, thereby re-using the subset of parameter data stored in PBUF 740 in the processing of two instances. The second pass may comprise storing the second instance in IBUF 760. Alternatively, core 0 750 may obtain the second instance directly from S-OCM 730.

Turning now to core 1 751, in step 860, which in the present example occurs in parallel to step 850, core 1 751 performs a third pass through the layer group that processes the third instance through the layer group using the first subset of parameter data stored in OCM 771. In the present example the third instance is not split into subsets; however, in some examples the third instance may be split into subsets and the third pass may be implemented as a series of sub-passes as was described above for the first instance. By performing the first and third passes using the first subset of parameter data stored on-chip, the first subset of parameter data is re-used between cores in the processing of two different instances at the cost of a single access to external memory.

In the present example, after the first subset of parameter data has been stored in OCMs 770, 771 it is discarded 870 from S-OCM 730 to free up space for the next subset of parameter data. At (or before) the time that the second or third pass is completed, a DMA is performed to load 880 the second subset of parameter data into S-OCM 730. In this way, core 1 751 can perform subsequent passes 881, 883 to process instances of input data through the layer group using the second subset of parameter data without needing to access external memory. In the present example, passes 881 and 883 are performed by core 1 751, and performing pass 881 may comprise discarding 882 the first subset of parameter data stored in OCM 771 and replacing it with the second subset of parameter data. This may be achieved by overwriting the data in OCM 771.

Returning to core 0 750, after the second pass is completed the first subset of parameter data stored in PBUF 740 is discarded and replaced 856 with the second subset of parameter data stored in S-OCM 730. This may be achieved by overwriting the parameter data stored in PBUF 740.

Core 0 750 can then perform further passes 857 and 858 by processing the first and second instances through the layer group using the second subset of parameter data stored in PBUF 740.

The first subset of parameter data stored in S-OCM 730 can be discarded and replaced with the second subset of parameter data before the cores complete the second and/or third passes. This helps to avoid or reduce delays in subsequent passes that would occur if the second subset of parameter data were only obtained after each core had completed all passes using the first subset of parameter data. However, the parameter data cannot be replaced too early, as it would lead to errors if a core tried to obtain the first subset of parameter data from S-OCM 730 for a pass but instead obtained the second subset of parameter data (or found no parameter data). Consequently, to reduce delays and avoid errors, the replacing of the subset of parameter data stored on-chip is synchronized with the passes performed by the cores.

The synchronization ensures that a subset of parameter data stored in the S-OCM is replaced only after it is no longer needed by the cores, but before the replacement subset is needed. In other words, the synchronization prevents replacement too early (which would cause errors) or too late (which would lead to cores being idle, or being idle for longer than necessary).

In the present example each core has its own on-chip memory in which the first subset of parameter data can be stored. This means that the first subset of parameter data stored in S-OCM 730 can be replaced once each core (more generally, each core requiring the first subset) stores the first subset in its OCM, as none of the cores will try to access S-OCM 730 for the first subset of parameter data after this time.

In examples in which the parameter data is stored only in a S-OCM, the parameter data cannot be replaced until each core begun its final pass using that subset of parameter data. This is because each core will need to obtain the first subset of parameter data from the S-OCM to perform the final pass.

In examples in which there is no S-OCM and each core stores subsets of parameter data in a private OCM, the subset of parameter data stored in the private OCM of a core may be replaced independently of the needs of any other cores. The subset of parameter data may be replaced only after the core has begun the final pass it will perform using that subset of parameter data.

Using a DMA (direct memory access) to obtain parameter data reduces the time taken to obtain the parameter data, making synchronization easier.

In some examples, the method 800 may consist of steps 810 and 814. In other words, steps 811-813 are optional and some or all of steps 811-813 might not be performed.

It should be understood that, in some examples, method 801 may consist of steps 820, 830, 840/841, 850 and 855. In other words, all other steps mentioned are optional and in some examples some or all of the optional steps might be omitted.

In the example of FIG. 8, the first pass 850 was split into two sub-passes. However, in some examples a pass may be split into more than two sub-passes by splitting an instance into more than two subsets. Performing such a pass may comprise performing a series of consecutive sub-passes, each sub-pass processing a different subset of the instance. Each sub-pass may produce a partial result, and the partial results may be combined to provide the result of the pass. The partial results may be combined by, as described above, combining the partial results of the first two sub-passes to produce accumulated output data, and then combining the accumulated output data with the partial result of each subsequent sub-pass to update the accumulated output data. After each update, the accumulated output data may be stored on-chip, such as in an OCM of the core (such as in an IBUF) or in a S-OCM. In this way, the partial results can be accumulated until the output of the pass is obtained. If the output of the pass is larger than the memory capacity of the OCM used to store the accumulated output data, then at some point in the accumulation process the accumulated output data will exceed the memory capacity of the OCM. To avoid an error, updating the accumulated output data may comprise comparing a size in memory of the updated accumulated output data and, if the size is greater than the capacity of the OCM, storing the updated accumulated output data in a larger memory. Where the OCM is an IBUF, the updated accumulated output data may be stored in the S-OCM (if one is present) or in external memory. Where the OCM is a S-OCM, the updated accumulated output data may be stored in external memory.

In the example described above, subsets of parameter data and input data were obtained from DDR 720 and stored in S-OCM 730. However, in some examples the hardware implementation might not include a S-OCM 730. In such examples, a core may obtain a subset of parameter data from DDR 720 and store it directly in its OCM for use in performing passes. In these example, the splitting of the parameter data may be based on detecting that the parameter data for the layer group is too large to be stored in OCM, and the splitting may ensure that the resultant subsets of parameter data are sufficiently small that a subset can be stored in OCM. In some examples, S-OCM 730 may be replaced with a series of caches, such as L2 caches, each cache only accessible to one core. A core may obtain a subset of parameter data from DDR 720 and store the data in its L2 cache. The core may further store the subset of parameter data in a PBUF or other OCM for use in at least two consecutive passes, or read the subset of parameter data directly from the cache for at least two consecutive passes. In the latter case, the subset of parameter data is maintained in the cache for at least the two passes.

In some examples, the hardware implementation might not include private OCMs 770 and 771. Instead, the cores may access the S-OCM 730 to obtain parameter data and input data as needed to perform passes. In these examples, the splitting of the parameter data may be based on detecting that the parameter data for the layer group is too large to be stored in the S-OCM and the splitting may ensure that the resultant subsets of parameter data are sufficiently small that a subset can be stored in the S-OCM.

In some examples, the parameter data may be split into more than two subsets. The S-OCM may be sufficiently large to store, and may store, more than one of the (but not all of the) subsets of parameter data. The cores may obtain subsets of parameter data from the S-OCM to perform passes.

In some examples, the hardware implementation may consist of a single core, or comprise more than two cores. Where the hardware implementation consists of a single core the S-OCM may be replaced with an L2 cache, or may simply be absent. In single core implementations the core performs all necessary passes to evaluate the layer group and re-uses at least one subset of parameter data stored on-chip in at least two passes that process different instances.

In the example of FIG. 8, the batch of input data had a batch size of four, however, in other examples the batch size may be any number greater than or equal to 2. In some examples, each instance of input data is processed through the layer group using one subset of parameter data stored on-chip, before any other parameter data is obtained and used. This increases the amount of data re-use. In other examples the re-use of subsets of parameter data may not be maximised. For example, the processing of the third and fourth instances might not involve the re-use of any parameter data.

In some examples, each core of the hardware implementation may obtain and re-use a different subset of parameter data. For example, the first core may store and use the first subset of parameter data to process all four instances of input data while the second core stores and uses the second subset of parameter data to process all four instances.

In the example of FIG. 8, the first instance was split into two subsets. However, in some examples the first instance might not be split. In other examples, the first instance may be split into more than two subsets. Where the first instance is split into more than two subsets, a single core may process each of these subsets consecutively in a series of sub-passes and combine the resultant set of partial results. Combining the set of partial results may comprise storing the accumulated output data in OCM 770 and, for each sub-pass after the second sub-pass, updating the accumulated output data. Updating the accumulated output data may be achieved by appending the output data produced by the current sub-pass to the accumulated output data stored in OCM 770. By using the same core to processes all sub-passes for a given instance, the partial results can all be stored in the OCM of that core instead of in a S-OCM. The memory space in the S-OCM that is not occupied by partial results can be used to store larger subsets of parameter data.

As the accumulated output data grows with each sub-pass, it may at some point exceed the capacity of OCM 770. To avoid the capacity of the OCM 770 being exceeded, updating the accumulated output data may comprise comparing a size in memory of the updated accumulated output data with an available memory capacity of OCM 770. If the updated accumulated output data is larger than the available memory capacity, the updated accumulated output data may be stored in a different, larger, OCM (such as S-OCM 721) or may be written to DDR 720. Additionally, or alternatively, the evaluation of the first pass may be halted and an error message may be printed.

While, in the example of FIG. 8, the parameter data for the layer group was split in response to determining that the size of the parameter data exceeded a threshold (the available memory capacity of S-OCM 730), this need not always be the case. In some examples, the threshold may be a configurable percentage of the total memory capacity of S-OCM 730 or of OCM 770.

In the example of FIG. 8, the first instance was split along the channel dimension. However, in other examples the first instance (and more generally, any instance) may be split along any of the height, width and channel dimensions. Furthermore, in some examples the first instance might not be split in any dimension.

In some examples, the control stream may indicate which core should perform which passes and/or sub-passes. However, in other examples this information may not be included in the control stream.

In method 800, the step of obtaining the layer group might not comprise grouping layers together to define the layer group. The layer group may have already been defined and a pre-determined definition of the layer group may be obtained.

Input data for the passes might not be stored on-chip. In some examples, for each pass, a core may obtain input data directly from external memory.

When replacing subsets of parameter data stored on chip, in some examples a DMA might not be used. Instead, other known data transfer techniques may be used.

### Batch-to-Space Batching

Some neural networks contain layers that that receive input data having dimensions [N, C, S₁, S₂] and produce output data having dimensions [N, C, 1, 1] (that is, output data with a size of one in the spatial dimensions). These layers are referred to herein as C″×1×1 generating layers, and include layers that receive input data having spatial dimensions with a size of one (referred to herein a “type 1 1×1 generating layers” or simply “type 1 layers”), and layers that receive input data having one or more spatial dimension with a size greater than one (referred to herein as “type 2 1×1 generating layers” or simply “type 2 layers”).

Examples of type 1 layers include convolution layers, where the input data and convolution kernel each have a size of 1×1 in the spatial dimensions; activation layers, where the input resolution is 1×1; element-wise operation layers (such as element-wise addition layers), where the input has a resolution of 1×1 and, if there is more than one input tensor, they are all 1×1 or all a scalar value; activation layers and batch normalisation layers.

Examples of type 2 layers include fully connected layers; 2D convolution layers, where the output tensor produce by the layer is 1×1, the input tensor is not padded, and the kernel size is the same as the input tensor resolution; and 2D depth-wise or group convolution layers, where the output tensor is 1×1 and the input tensor is not padded; pooling layers (where the output tensor is 1×1 and the input tensor is not padded) and global pooling layers.

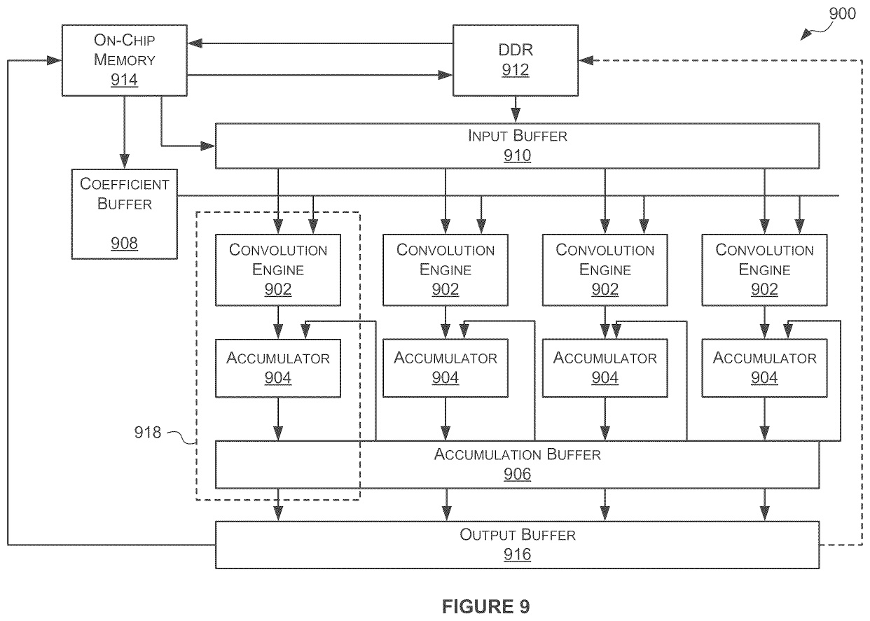

FIG. 9 is a block diagram of an exemplary hardware implementation configured to evaluate a convolution layer. The hardware implementation 900 comprises a plurality of convolution engines 902, a plurality of accumulators 904, an accumulation buffer 906, a coefficient buffer 908, and an input buffer 910. Each convolution engine 902, together with its respective accumulator 904 and its share of the resources of the accumulation buffer 906, represents a processing element 918. The hardware implementation further comprises a double data rate (DDR) SDRAM 912, which is an off-chip memory; an on-chip memory (OCM) 914, and an output buffer 916.

Efficient implementations of convolution layers parallelise the evaluation of the convolution layer over the multiple convolution engines present in the hardware implementation. However, some hardware implementations may be configured to parallelise convolution calculations over one of the spatial dimensions. We label this dimension the “S₂” dimension, with the other spatial dimension being the “S₁” dimension. It should be understood that the S₂ dimension may refer to the height or width dimension, with the S₁ dimension referring to the counterpart width or height dimension. Such hardware implementations are not able to parallelise the evaluation of convolution layers that are C″×1×1 generating layers because the output of these layers has a size of one in the spatial dimensions. These convolution layers do not make efficient use of the available processing elements. The same is true for the other types of C″×1×1 generating layers mentioned above—the evaluation of these layers cannot be parallelised over the spatial dimensions and so the processing elements in a hardware implementation cannot be fully utilised.

Batch-to-space batching provides a method that allows the evaluation of C″×1×1 generating layers to be parallelised over one of the spatial dimensions, better utilising the available hardware to evaluate the C″×1×1 generating layers more quickly and efficiently.

The batch-to-space batching methods transforms input data for a C″×1×1 generating layer into transformed input data by transposing the batch dimension into the spatial dimensions. The method also maps the C″×1×1 generating layer to a transformed layer, through which the transformed input data is processed. The mapping of the layer corresponding to the transformation of the input data, such that when a second transformation is performed on the output of the transformed layer the result is the same as would have been obtained by processing the untransformed data through the untransformed layers. Because the transformed input data has a size greater than one in at least one spatial dimension, the evaluation of the transformed layer can be parallelised over multiple processing elements.

The transformation performed on the input data has a computational cost. The return on this cost (in terms of improved efficiency due to increased parallelisation) can be increased by applying the batch-to-space batching method to a series or set of consecutive C″×1×1 generating layers (each layer of which is mapped to a corresponding transformed layer). Only the input data for the first of the set of layers needs to undergo a transformation, meaning the one transformation can lead to efficiency gain through parallelisation for multiple layers.

In other words, input data for the set of consecutive C″×1×1 generating layers undergoes a transformation to provide transformed input data and the set of consecutive C″×1×1 generating layers is mapped to a set of consecutive transformed layers. The transformed input data can then be processed through the consecutive transformed layers, with the evaluation of each transformed layer being parallelised over one of the spatial dimensions. As mentioned above, to maintain the function of the C″×1×1 generating layers the mapping of the C″×1×1 generating layers to the transformed layers corresponds to the transformation applied to the input data. The transformation of the input data can be treated as a layer of the neural network, and the transformation and the set of consecutive transformed layers can be referred to as “a set of transformed layers”.

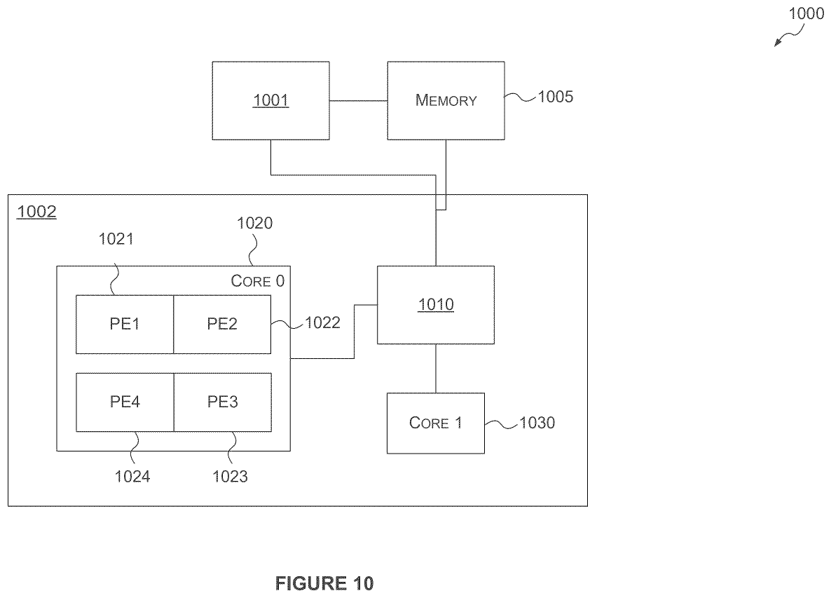

An exemplary implementation of batch-to-space batching is described below with reference to FIGS. 10-13.

FIG. 10 depicts a computing system 1000 comprising a computing device 1001, a hardware implementation 1002 of a neural network and a memory 1005. The hardware implementation comprises a data retrieval unit 1010, a first core 1020 comprising four processing elements 1021, 1022, 1023, 1024, and a second core 1030.

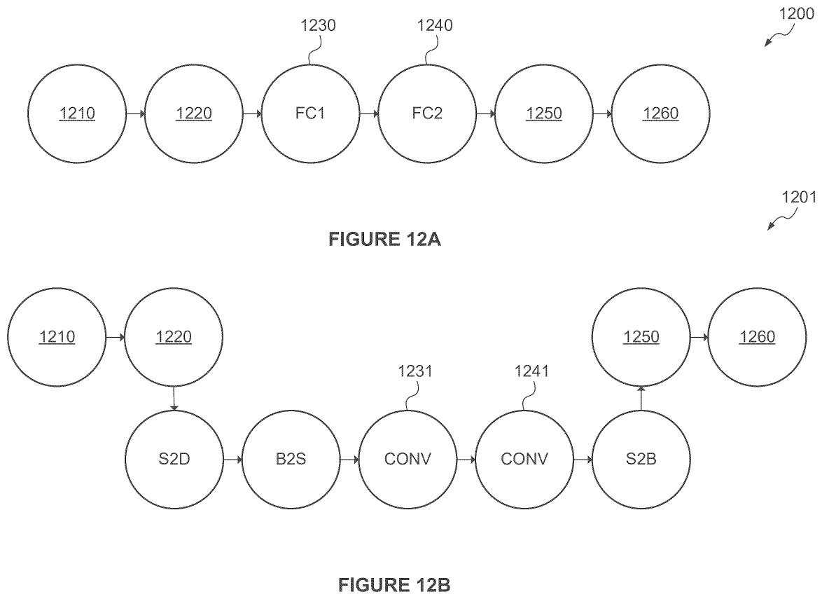

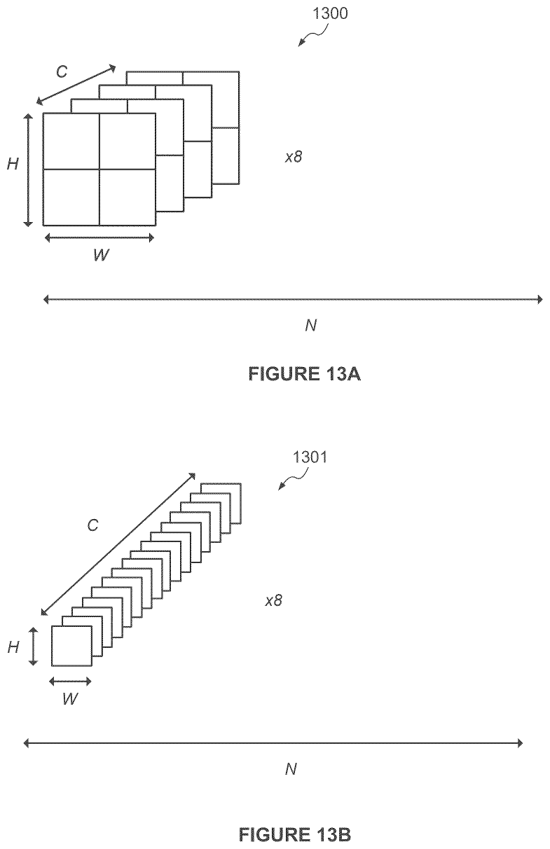

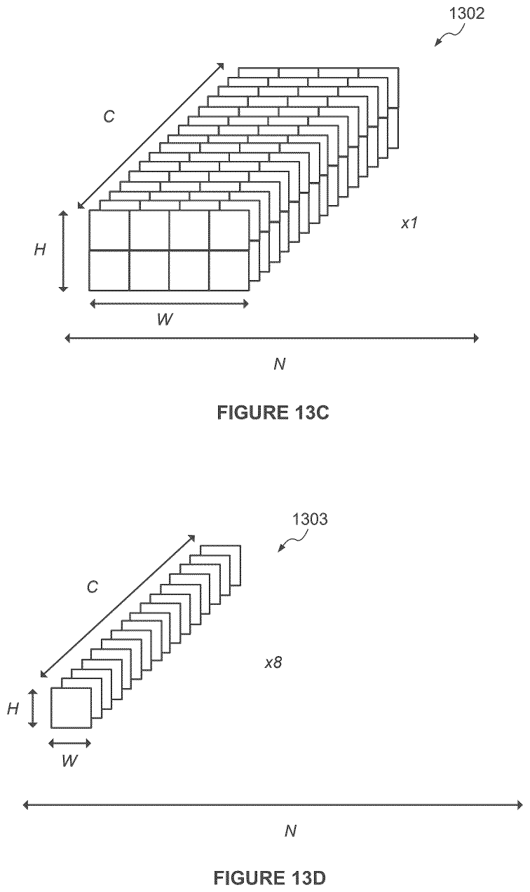

FIG. 12A depicts a neural network 1200, comprising layers 1210, 1220, 1230, 1240, 1250 and 1260. Layers 1230 and 1240 of the neural network are both C″×1×1 generating layers, and more specifically are both fully connected layers. Layers 1230 and 1240 form a set of consecutive C″×1×1 generating layers. Layer 1230 is configured to receive input data 1300 (shown in FIG. 13A) having dimensions [N, C, S₁, S₂] of [8, 4, 2, 2], to apply 8 filters to the input data and to output data having dimensions [8, 8, 1, 1]. Layer 1240 is configured to receive the output data of layer 1230 as input data, apply 16 filters to the data and output data having dimensions [8, 16, 1, 1].

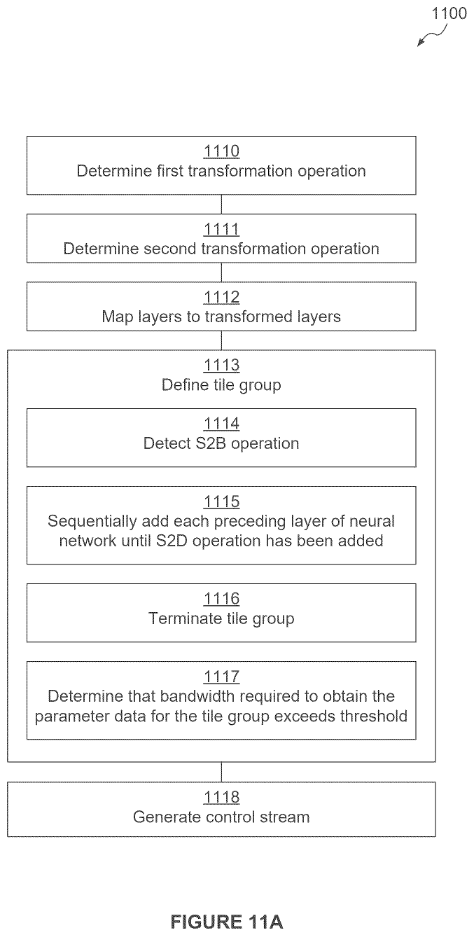

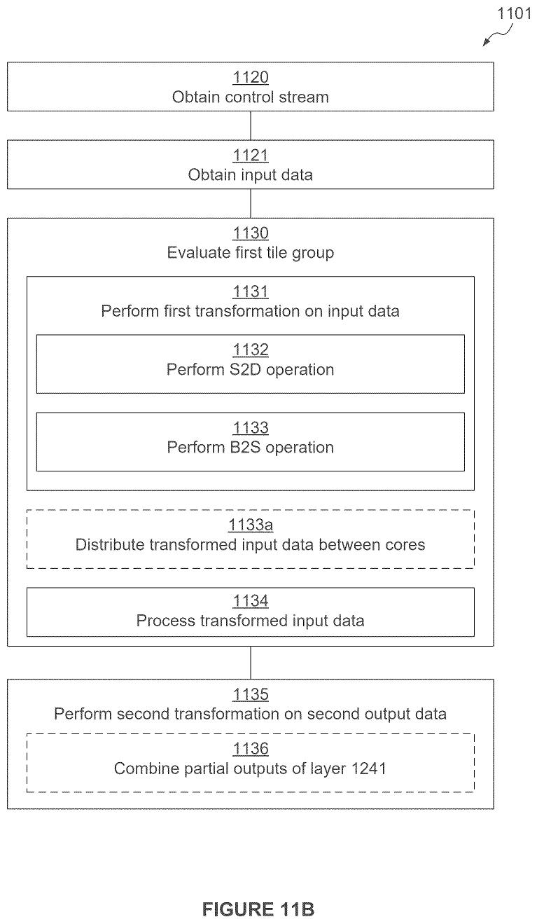

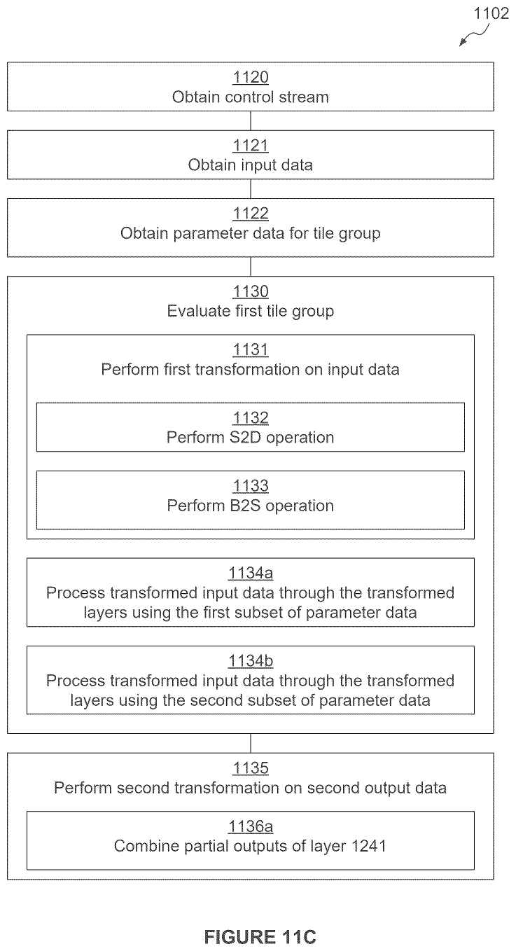

Referring now to FIG. 11A, a method 1100 of generating a control stream will be described. This method is performed by computing device 1001 of FIG. 10.

In step 1110 the computing device 1001 determines a first transformation operation for the input data to the set of consecutive C″×1×1 generating layers. The first transformation operation comprises a space-to-depth operation (S2D) followed by a batch-to-space operation (B2S).

The space-to-depth operation is configured to reshape the input data by rearranging (transposing) data from the spatial dimensions into the depth (channel) dimension. The result of the space-to-depth operation is an intermediate tensor having spatial dimensions of size 1×1. In the present invention, space-to-depth operations are used to reduce the size of the spatial dimensions to one by transposing the spatial dimensions into the channel dimension. In some examples the input data to the set of consecutive C″×1×1 generating layers may already have a size of 1 in the spatial dimensions, in which case a space-to-depth operation might not be performed.

The batch-to-space transformation is configured to reshape the intermediate tensor by rearranging (transposing) data from the batch dimension into one or more of the spatial dimensions to provide transformed input data having a batch size of 1 and at least one spatial dimension with a size greater than 1. In particular, the batch-to-space operation produces a tensor having spatial dimensions of the following sizes:

$${S}_{1}^{′} = blockheight \times ω = ceiling ( \frac{N}{{N}_{PE}} ) \times ω and {S}_{2}^{′} = blockwidth \times θ = ceiling ( \frac{N}{blockheight} ) \times θ .$$

N_{PE} is the number of processing elements that will be used to evaluate the set of consecutive layers, and in this example is the number of processing elements in core 0 1020. Core 0 1020 contains four processing elements 1011, 1012, 1013, 1014, therefore N_{PE}=4. N is the batch size of the input data, and in the present example is equal to 8. The variable ω represents the size in the S₁ dimension of the input data to the batch-to-space operation. In the present example this is equal to 1 because of the space-to-depth operation. In other examples ω may be larger than 1. The variable θ represents the size in the S₂ dimension of the input data to the batch-to-space operation. Again, this is equal to 1 in the present example, but may be greater than one in other examples.

In step 1111 computing device 1001 determines a second transformation operation that should be applied to the output of the transformed layers. The second transformation is a space-to-batch (S2B) operation configured to transpose the spatial dimensions of the output of the transformed layers into the batch dimension to reduce the size of the spatial dimensions to 1. The second transformation can also be considered to be a layer of the neural network and may be one of the set of transformed layers.

In step 1112 the set of consecutive C″×1×1 generating layers is mapped to a set of consecutive transformed layers. In particular, the mapping unit 1001 maps layer 1230 to a 1×1 convolution layer 1231 configured to apply 8 filters to its input data, and maps layers 1240 to a 1×1 convolution layer 1241 configured to apply 16 filters to its input data. More specifically, the transformation of a fully connected layer to a convolution layer is as follows:

Original FC layer:
Number of filters N_{filters};
Input data dimensions [N, C, S_{1_FC}, S_{2_FC}]; and
Output data dimensions [N, N_{filters}, 1, 1],
   Transformed convolution layer:
Number of filters (convolution kernels) N_{filters};
Filter size [1,1] (in the spatial dimensions);
Stride [S_{1_FC}, S_{2_FC}]; and
Output data dimensions [N, N_{filters}, S₁′, S₂′].

As mentioned above, the transformations and the set of consecutive transformed layers can be grouped together under the label of a set of transformed layers. By processing the input data for the set of consecutive C″×1×1 generating layers through the set of transformed layers, the batch-to-space batching method will be performed. FIG. 12B depicts neural network 1201, which is neural network 1200 with layers 1230 and 1240 replaced with the set of transformed layers.

In step 1113, the computing device 1001 defines a tile group that consists of the set of transformed layers. Defining the tile group comprises detecting 1114 the S2B operation and sequentially adding 1115 each preceding (parent) layer of neural network 1201 until the S2D operation has been added, at which point the tile group is terminated 1116 and a new tile group is started for the parent layer of the S2D layer. In the present example this would result in neural network 1201 being split into three tile groups—a first tile group consisting of layers 1210 and 1220, a second tile group consisting the set of transformed layers, and a third tile group consisting of layers 1250 and 1260.

In step 1117 the computing device 1001 determines that the bandwidth required to obtain the parameter data for the tile group consisting of the set of transformed layers is larger than 30% of the memory capacity of an on-chip memory used to store parameter data. This test estimates whether it would be more efficient to evaluate the set of consecutive C″×1×1 generating layers using batch-to-space batching or whether an alternative tiling method like tile group interleaving would be more efficient. If the parameter data for the tile group is larger than 30% of the memory capacity of the on-chip memory then the bandwidth needed to evaluate the set of transformed layers is significant in size. It is likely that to use an alternative tiling method (such as tile group interleaving) to evaluate the set of consecutive C″×1×1 generating layers would require the creation of multiple tile groups and consume more bandwidth, meaning that the batch-to-space batching method is the more efficient choice.

In step 1118, the computing device 1001 generates the control stream. The control stream defines the tile group (which, in the present example consists of the set of transformed layers), by which it is meant that the control stream contains all the information necessary for a hardware implementation to evaluate the tile group. The control stream may also provide the address in memory 1005 from which the input data for the set of consecutive layers can be obtained.

Turning now to hardware implementation 1002 and method 1101 of FIG. 11B, in step 1120 the data retrieval unit 1010 obtains the control stream.

In step 1121 the data retrieval unit 1010 obtains input data for the set of consecutive layers. As mentioned above, in the present example the input data has dimensions [N=8, C=4, S₁=2, S₂=2].

In step 1130, the first tile group is evaluated. This comprises performing 1131, by core 0 1003, the first transformation on the input data to provide transformed input data. As mentioned above, the first transformation involves performing 1132 a space-to-depth operation, and then performing 1133 a batch-to-space transformation.

The space-to-depth operation reshapes the input data by rearranging (transposing) data from the spatial dimensions into the depth (channel) dimension. The result of the space-to-depth operation is an intermediate tensor 1301 (shown in FIG. 13B) having dimensions [8, 16, 1, 1].

The batch-to-space transformation then reshapes the intermediate tensor 1301 by rearranging data from the batch dimension into the spatial dimensions to provide transformed input data 1302 (shown in FIG. 13C) having dimensions [1, 16, S₁′, S₂′]. More specifically, the batch-to-space operation produces a tensor having spatial dimensions of the following sizes:

$${S}_{1}^{′} = blockheight \times ω = ceiling ( \frac{N}{{N}_{PE}} ) \times ω and {S}_{2}^{′} = blockwidth \times θ = ceiling ( \frac{N}{blockheight} ) \times θ .$$

N_{PE} is the number of processing elements present in core 0 1003. In the present example, core 0 1003 contains four processing elements 1011, 1012, 1013, 1014, therefore N_{PE}=4. N is the batch size of the input data, and in the present example is equal to 8. As explained above the variables ω and θ represent the size in the spatial dimensions of the input to the batch-to-space operation. In the present example, the input to the batch-to-space operation is intermediate tensor 1301, which has a size of one in the spatial dimensions so both variables are equal to one. By inputting these values to the above equations, values of S₁′=2 and S₂′=4 are found. Consequently, the transformed input data 1302 has dimensions [1, 16, 2, 4]. Notably, the size of the transformed input data in the S₂ dimension is the same as the number of processing elements in core 0 1020.

The space-to-depth and batch-to-space operations are transformations of the shape of the input data and do not change the values of the elements of the input data nor the number of elements.

In step 1134 the set of consecutive C″×1×1 generating layers is evaluated by processing the transformed input data 1302 through layers 1231, 1241 using the processing elements of core 0 1020 to produce output data. More specifically, the evaluation is parallelised over the four processing elements 1021, 1022, 1023 and 1024, reducing the time taken to evaluate the tile group.

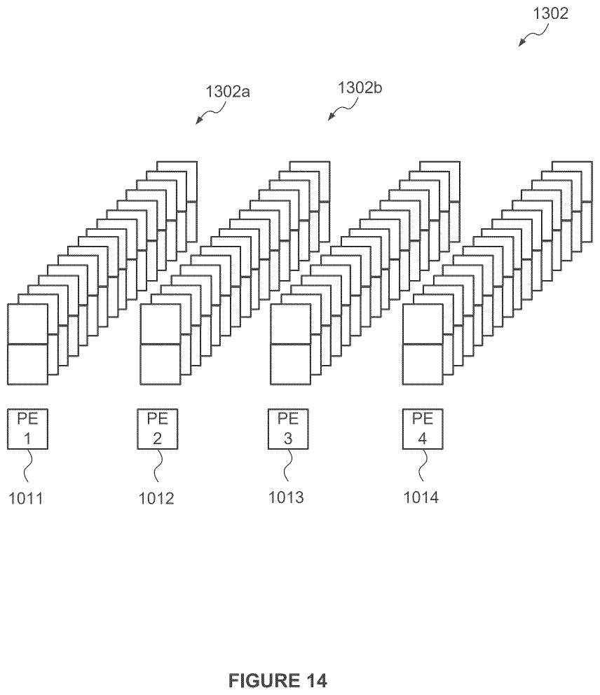

Because the transformed input data has the same size in the S₂ dimension as the number of processing elements in core 0 1020 1021. 1022, 1023, 1024, each processing element (in this case, convolution engine) within the core is utilised in the evaluation of layer 1231. In particular, each convolution engine applies the filters (1×1 convolution kernels) to a different line of the transformed input data. By “line”, it is meant that each processing element processes only the elements of data having the same position in the S₂ dimension (in other words, a row or a column of data, depending on whether the S₂ dimensions refers to the width dimension or the height dimension). In this way, the processing of the transformed input data is parallelised over the S₂ dimension. This is depicted in FIG. 14, which shows that PE1 1021 processes the line 1302a of elements in tensor 1302 having position S₂=1. PE2 1022 processes the line 1302b of elements in tensor 1302 having position S₂=2, and so on for the remaining processing elements and lines of data. Where layer 1230 was only able to be evaluated using one convolution engine in other methods, layer 1231 can be evaluated by four convolution engines in parallel with batch-to-space batching, improving performance.

As mentioned above, layer 1231 is configured to apply 8 filters in 1×1 convolutions to the input data, producing first output data having dimensions [1, 8, 2, 4]. In other words, the parameter data for layer 1231 has a batch size of 8. This data is then processed through layer 1241, and again is parallelised over the four processing elements of core 0 1020. The output of layer 1241 is second output data having dimensions [1, 16, 2, 4].

In step 1135 the second output data undergoes the second transformation (a space-to-batch operation). The second transformation reshapes the second output data to provide the output of the set of consecutive layers (that is, the output that would have been obtained by processing the untransformed input data through layers 1230 and 1240). Because layer 1240 is a C″×1×1 generating layer, its output should have a size of one in the spatial dimensions. Therefore, the space-to-batch operation rearranges the tensor to have a size of one in the spatial dimensions by transposing data into the batch dimension. The output of the space-to-batch operation is a tensor 1303 (shown in FIG. 13D) having dimensions [8, 16, 1, 1].

While the hardware implementation 1002 contains two cores, the method described above is a single-core method of batch-to-space batching that made no use of the second core and could have been implemented in a single-core hardware implementation. A multi-core method of batch-to-space batching will now be described with reference to FIGS. 11A and 11B.

Further parallelisation and resulting performance gains can be achieved by utilising both core 0 1020 and core 1 1030 in the batch-to-space batching method. Because this example utilises multiple cores, when determining 1110 the first transformation operation the equation that defines blockheight is modified to account for the total number of processing elements in core 0 1020 and core 1030. While not shown in FIG. 10, core 1 1006 also contains four processing elements. Accounting for these processing elements increases the value of N_{PE} to 8. Method 1100 may include a step of selecting a number of cores to be used to evaluate the set of consecutive layers, in which case N_{PE} will be the number of processing elements contained in the selected cores.

The dashed boxes of FIG. 11B indicate additional steps that provide a multi-core implementation of batch-to-space batching. Because both core 0 1020 and core 1 1030 are utilised in the multi-core implementation, N_{PE} is larger than in the single-core implementation described above. The larger value of N_{PE} causes the first transformation to produce transformed data having dimensions [1, 16, 1, 8]. In step 1133a the transformed input data (in particular, the lines of transformed data) is distributed (split) between the two cores, and more specifically between the eight processing elements of the two cores. The set of consecutive layers is then evaluated in step 1134, with each processing element processing a different line of the transformed input data through layers 1231 and 1241. In this way, the evaluating of the set of consecutive layers is parallelised over 8 processing elements between two cores, with the transformed input data being split in the S₂ dimension such that each processing element processing data having dimensions [1, 16, 1, 1].

A similar result can be achieved by retaining the original transformation of the input data (that is, keeping N_{PE}=4). As mentioned above, this produces transformed input data having dimensions [1, 16, 2, 4]. The transformed input data can then be split in the S₁ dimension to produce two subsets of the transformed input data, each subset having dimensions [1, 16, 1, 4]. Each core can then process a different one of the subsets in parallel, with each processing element again processing data having dimensions [1, 16, 1, 1].

Performing 1135 the second transformation comprises combining 1136 the partial outputs of layer 1241 produced by each of the cores to produce an output of layer 1241. This combined output then undergoes the space-to-batch operation to provide the output of layer 1240.

FIG. 11C shows an alternative method 1102 by which the parallelisation of the evaluation of the transformed set of layers can be extended to multiple cores. In this method, instead of modifying the first transformation to allow the transformed input data to be distributed over more processing elements, the parameter data is split in the batch dimension into two subsets of filters and each core evaluates the transformed set of layers using a different subset of the filters. In other words, because each core is operating independently, N_{PE} is again set to 4 and each core will process the entirety of the transformed input data.

Many of the steps of the method 1102 are the same as those described above for FIG. 11B, for which the description will not be repeated. In step 1122, parameter data for the tile group is obtained. While not shown in FIG. 11B, this step is implicitly disclosed as the parameter data is needed to evaluate the tile group. The parameter data contains the convolution kernels for layer 1231 and layer 1241, and can be thought of as being made up of a first subset of the kernels in the batch dimension and a second subset of the kernels in the batch dimension. In the present example, the first subset contains the first four kernels for layer 1231 and the first eight kernels of layer 1241. The second subset contains the remaining kernels for each of layers 1231 and 1241. Method 1100 may comprise a step of splitting the parameter data for layers 1231 and 1241 (more generally, for the set of consecutive layers) into the first and second subsets.

In step 1130 the first tile group is evaluated. In the present example, each core will be used to process the transformed input data through layers 1231 and 1241 using a different subset of the parameter data. While the cores are operating in parallel, the transformed input data is not distributed over the cores as was described above in step 1133a. For this reason, N_{PE} is set to 4 (more generally, to the number of processing elements in a single core).

In step 1134a, core 0 1020 processes the transformed input data 1302 through the set of transformed layers using the first subset of parameter data, and in step 1134b core 1 1030 processes the transformed input data through the set of transformed layers using the second subset of parameter data. Steps 1134a and 1134b may be performed in parallel.

The partial outputs of layer 1241 produced by each of the cores are combined 1136a to produce an output of layer 1241, which undergoes 1135 the space-to-batch operation to provide the output of layer 1240. Alternatively, each core may perform a space-to-batch operation on its partial output to produce transformed partial outputs, which may then be combined to provide the output of layer 1240.

As mentioned above, there any many kinds of C″×1×1 generating layers. The properties of each layers, and the associated transformed layer, are provided below.

| | | | | Corresponding | |
|---|---|---|---|---|---|
| | | | | transformed | |
| Category | Layer | Properties | Restrictions | layer | Properties |
| Type 2 | Fully | Input data size = | None | Convolution | Kernel size = |
| generating | connected | [Nᵢₙ, Cᵢₙ, S₁_{ᵢₙ}, S₂_{ᵢₙ}] | | | 1 × 1 (in the |
| layer | | | | | spatial |
| | | | | | dimensions); |
| | | | | | Convolution |
| | | | | | stride = |
| | | | | | [S₁_{ᵢₙ}, S₂_{ᵢₙ}] |
| | | | | | (in the spatial |
| | | | | | dimensions). |
| Type 2 | 2D | Input data | Kernel size is | Convolution | Kernel size = |
| generating | convolution | size: | the same as | | [N_{K}, C_{K} × |
| layer | | [Nᵢₙ, Cᵢₙ, S₁_{ᵢₙ}, S₂_{ᵢₙ}] | input tensor | | K_{S1} × |
| | | Kernel size = | resolution. | | K_{S2}, 1, 1] |
| | | [N_{K}, C_{K}, K_{S1}, K_{S2}] | Input tensor is | | (1 × 1 in the |
| | | (in the spatial | not padded | | spatial |
| | | dimensions); | | | dimensions); |
| | | Any convolution | | | Convolution |
| | | stride | | | stride = |
| | | | | | [S₁_{ᵢₙ}, S₂_{ᵢₙ}] |
| | | | | | (in the spatial |
| | | | | | dimensions) |
| Type 2 | 2D depth- | Input data size = | Kernel size is | Group | Kernel size = |
| generating | wise | [Nᵢₙ, Cᵢₙ, S₁_{ᵢₙ}, S₂_{ᵢₙ}]; | the same as | Convolution | [B, K_{S1} × |
| layer | convolution | Kernel size = | input tensor | | K_{S2}, 1, 1] |
| | | [B, 1, K_{S1}, K_{S2}]. | resolution. | | (size 1 × 1 in |
| | | B is the number of | Input tensor is | | the spatial |
| | | groups in the group | not padded | | dimensions); |
| | | convolution, and is | | | Convolution |
| | | equal to Cᵢₙ. | | | stride = |
| | | K_{S1}, K_{S2} is the size | | | [S₁_{ᵢₙ}, S₂_{ᵢₙ}] |
| | | of the kernel in the | | | (in the spatial |
| | | spatial dimensions. | | | dimensions) |
| | | Any convolution | | | |
| | | stride | | | |
| Type 2 | Group | Input data size = | Kernel size is | Group | Kernel size is |
| generating | convolution | [Nᵢₙ, Cᵢₙ, S₁_{ᵢₙ}, S₂_{ᵢₙ}] | the same as | convolution | [B, K_{S1} × |
| layer | | Kernel size = | input tensor | | K_{S2} × |
| | | [B, Cₖ, K_{S1}, K_{S2}]. | resolution. | | Cₖ, 1, 1] |
| | | | Input tensor is | | (1 × 1 in the |
| | | | not padded | | spatial |
| | | | | | dimensions) |
| | | | | | Convolution |
| | | | | | stride = |
| | | | | | [S₁_{ᵢₙ}, S₂_{ᵢₙ}] in |
| | | | | | the spatial |
| | | | | | dimensions. |
| Type 2 | Global | Input data size = | | Pooling | Kernel size = |
| generating | pooling | [Nᵢₙ, Cᵢₙ, S₁_{ᵢₙ}, S₂_{ᵢₙ}]; | | | [K_{S1}, K_{S2}] = |
| layer | | Kernel size = | | | [S₁_{ᵢₙ}, S₂_{ᵢₙ}] |
| | | [K_{S1}, K_{S2}] = | | | (in the spatial |
| | | [S₁_{ᵢₙ}, S₂_{ᵢₙ}] (in the | | | dimensions; |
| | | spatial dimensions); | | | Stride = |
| | | Any stride | | | [K_{S1}, K_{S2}] (in |
| | | | | | the spatial |
| | | | | | dimensions) |
| Type 2 | Pooling | Input data size = | Window size | Pooling | Kernel size = |
| generating | | [Nᵢₙ, Cᵢₙ, S₁_{ᵢₙ}, S₂_{ᵢₙ}]; | is the same | | [K_{S1}, K_{S2}] = |
| layer | | Kernel size = | as input | | [S₁_{ᵢₙ}, S₂_{ᵢₙ}] |
| | | [K_{S1}, K_{S2}] = | tensor | | (in the spatial |
| | | [S₁_{ᵢₙ}, S₂_{ᵢₙ}] (in the | resolution. | | dimensions; |
| | | spatial dimensions); | Input tensor is | | Stride = |
| | | Any stride | not padded | | [K_{S1}, K_{S2}] (in |
| | | | | | the spatial |
| | | | | | dimensions) |
| Type 2 | Fully | | Input | Convolution | Kernel size = |
| generating | connected | | resolution is | | 1 × 1 (in the |
| layer | | | 1 × 1 (in the | | spatial |
| | | | spatial | | dimensions); |
| | | | dimensions) | | Convolution |
| | | | | | stride = |
| | | | | | [S₁_{ᵢₙ}, S₂_{ᵢₙ}] |
| | | | | | (in the spatial |
| | | | | | dimensions) |
| Type 1 | Convolution | | Input tensor | Convolution | Kernel size = |
| generating | | | has size of | | 1 × 1 (in the |
| layer | | | 1 × 1 (in spatial | | spatial |
| | | | dimensions) | | dimensions); |
| | | | Kernel has | | Convolution |
| | | | size 1 × 1 (in | | stride = |
| | | | spatial | | [S₁_{ᵢₙ}, S₂_{ᵢₙ}] |
| | | | dimensions) | | (in the spatial |
| | | | | | dimensions) |
| Type 1 | Activation | | Input | Activation | |
| generating | | | resolution is | | |
| layer | | | 1 × 1 (in the | | |
| | | | spatial | | |
| | | | dimensions) | | |
| Type 1 | Element- | | Input | Element-wise | |
| generating | wise | | resolution is | operations | |
| layer | operations | | 1 × 1 (in the | | |
| | | | spatial | | |
| | | | dimensions). | | |
| | | | If there is | | |
| | | | more than | | |
| | | | one tensor, | | |
| | | | each tensor | | |
| | | | must be a 1 × 1 | | |
| | | | tensor (in the | | |
| | | | spatial | | |
| | | | dimensions) | | |
| | | | or a scalar | | |
| | | | value. | | |
| Type 1 | Batch | | Input | Batch | |
| generating | normalisation | | resolution is | normalisation | |
| layer | | | 1 × 1 (in the | | |
| | | | spatial | | |
| | | | dimensions) | | |

Considering the transformation of a fully connected layer where S₁_{ᵢₙ} and/or S₂_{ᵢₙ} are greater than 1, transforming the input data for the layer comprises performing a space-to-depth operation. In this case, the transformation of the weight matrix of the fully connected layer into a 1×1 convolution kernel (in the spatial dimensions) comprises performing a corresponding space-to-depth transformation of the weight matrix. In other words, the spatial dimensions of the weight matrix are reduced to 1 by moving weights into the channel dimension. For example, a weight matrix of dimensions [1, 1, 2, 2] would be transformed into a 1×1 kernel having dimensions [1, 4, 1, 1]. To ensure that the convolution of the kernel with the transformed input data is equivalent to the application of the weight matrix to the input data, the weights should be re-arranged in the same pattern in the channel (depth) dimension as was used for the space-to-depth transformation of the input data. The same consideration applies when transforming the convolution kernel of a convolution layer into a 1×1 kernel.

Batch-to-space batching can be implemented when processing a set of consecutive C″×1×1 generating layers containing combinations of the above layers. However, the set of consecutive C″×1×1 generating layers must contain no more than one type 2 generating layer, and this layer must be the first layer of the set of consecutive C″×1×1 generating layers.

In some examples, pooling layers and/or global pooling layers might be excluded from the set of consecutive C″×1×1 generating layers. That is, these layer types might not be treated as C″×1×1 generating layers.

In the table above, some layers are shown to be identical as the corresponding transformed layers. This is because these layers act element-by-element on the input data, and therefore require no transformation to account for a different ordering of the elements.

In the examples described above, the transformed layers 1231 and 1241 and the first and second transformations were grouped into a single tile group. However, in some examples this might not be the case. In some examples one or both transformations might not be included in the tile group, which may consist of the transformed layers of the neural network.

In some examples the tile group might not be able to include all the transformed layers in the set of transformed layers due to on-chip memory constraints. If it is predicted that the capacity of the on-chip memory used to store the output of a layer group would be exceeded by a tile group containing the entire set of transformed layers, the set of transformed layers may be split between two or more tile groups.

In an example described above, step 1117 determined that the bandwidth required to obtain the parameter data for a new tile group consisting of the set of data transformations and the set of transformed layers is larger than 30% of the memory capacity of an on-chip memory used to store the output of layer groups. In other examples, different tests may be used to determine the suitability of batch-to-space batching. In one example, computing device 1001 may determine that a size in memory size_{T} of a predicted largest intermediate tensor that would be produced by evaluating an alternative tile group containing the set of consecutive layers is greater than

$$\frac{{size}_{OCM} - {parameter}_{BW}}{ϵ} ,$$

and that parameter_{BW}<σ×size_{OCM}, wherein σ and ϵ are configurable variables. This test considers whether intermediate data produced in the evaluation of an alternative tile group (that is, a tile group containing the set of consecutive layers that would be generated by is the batch-to-space batching method was not used) would likely be too large to store in on-chip memory, meaning that the alternative tile group would likely need to be split into multiple tile groups. In an example, the alternative tile group is the tile group that would be defined according to the tile group interleaved method. The predicted largest intermediate tensor is the predicted or estimated largest output of any of the layer groups in the alternative tile group. If the first test of condition B is satisfied then the output of the layer group is too large to be stored on-chip and would have to be written to external memory, meaning that the tile group would have to be split into two tile groups. Given that in either method at least two tile groups are required, this test indicates that using the batch-to-space batching method may be more efficient. The second of the tests considers whether the bandwidth needed to obtain the parameter data for the first tile group is small compared to size of the on-chip memory. The variable σ may be equal to 10%. The variable ϵ may be equal to 3. In another alternative test, computing device 1001 may determine that Count_{cycle}×(blockwidth−1)>transform_{cycles}×φ, wherein φ is a configurable variable, Count cycle is an estimation of a number of computing cycles needed to execute the first tile group, and transform_{cycles} is an estimation of a number of computing cycles needed to perform the first transformation and optionally the second transformation, wherein processing input data for the set of consecutive layers through the first tile comprises reading the parameter data from the on-chip memory. The expression Count_{cycle}×(blockwidth−1) is an estimation of the performance gain achievable by using batch-to-space batching, and the expression transform_{cycles}×φ is an estimation of the computational cost of performing the first and second transformations.

In an example described above, the variables ω and θ were equal to one because the input to the batch-to-space operation had a size of one in the spatial dimensions. ω represents the size of the data in the S₁ dimensions and θ represents the size of the data in the S₂ dimension. In some examples, ω and/or θ may have values greater than one. In some examples, the first transformation might not comprise a space-to-depth operation.

In some examples, the first transformation may comprise a padding operation. The padding operation may be configured to pad the batch dimension of the input data for the set of consecutive layers so that N % (blockheight×blockwidth)=0. This padding ensures that that the remainder of N (after padding) divided by the product of blockheight and blockwidth is 0, which results in the transformed input data being rectangular. By rectangular, it is meant that each row of the transformed input data contains the same number of elements, and that each column of the transformed input data contains the same number of elements. The number of elements in the rows may be different to the number of elements in the columns. Having rectangular transformed input data simplifies parallelisation across the processing elements and improves utilisation of the processing elements by avoiding some elements becoming idle while others are still working.

In the examples of batch-to-space batching described above, the equation for blockheight used the variable N_{PE}. This is a special case of the first transformation, in which all of the processing elements of the cores being used to process the transformed input data through the set of transformed layers are utilised. However, in other examples, only a subset of the processing elements of the cores might be utilised. In these examples, in equation for blockheight the variable N_{PE} may be substituted for the variable PEᵢ. PEᵢ represents the number of processing elements actually used, and can have a value in the range N_{PE}≥PEᵢ>1. The method 1100 may comprise a step of selecting the number of cores to be used in the method, and/or a step of selecting the number of processing elements to be used.

As mentioned above, in some examples the transformed input data may be split in the S₁ dimension. In some examples, the product of the sizes of the channel and S₂ dimensions may be too large for the transformed input data to be stored on-chip due to limitations of the format by which data is stored in the on-chip memory. This problem could be overcome by splitting the input data in the S₂ dimension into subsets to reduce the width of the data stored on-chip and performing multiple passes using the subsets; however, it may be preferable to avoid a split entirely by modifying the first transformation operation to reduce the width of the transformed input data. The method 1100 may comprise a step of determining whether transformed input data would fit in on-chip memory. This may comprise determining whether τ×C×S₁×S₂×blockwidth<buffersize. τ is a variable known as the “double buffer factor” and is equal to 2 where blockheight is greater than 1, otherwise it is equal to 1. The double buffer factor accounts for double buffering of the transformed input data, which is a technique in which both the data currently being processed and the next set of data to be processed are buffered to reduce latency caused by loading input data. In the present case, the ‘set’ of data being processed is the first row of the transformed input data, and the next ‘set’ is the second row of the transformed input data. The variable “buffersize” refers to the memory capacity of the on-chip memory used to store the transformed input data, in bytes. If the condition above is satisfied, then the transformed input data will fit in the on-chip memory. If the condition is not satisfied, then the following modified equations for blockwidth and blockheight may be used in the first transformation:

$$blockwidth = floor ( \frac{buffersize}{2 \times C \times {S}_{1} \times {S}_{2}} ) and blockheight = ceiling ( \frac{N}{blockwidth} ) .$$

These modified equations reduce the size of transformed input data in the S₂ dimension to a size that will fit in the on-chip memory, avoiding the need to perform a split in the S₁ dimension.

In the example described above, in step 1131 the input data was transformed to produce transformed input data, and then in step 1133a the transformed input data was then split and distributed between the cores (and by extension the processing elements of the cores). However, in other examples the input data may be split and distributed amongst the cores, which may then each transform their subset of input data. Each core may implement the transformation by accounting only for its processing elements. The output of each core may undergo the second transformation, and then be combined. Alternatively, the output of each core may be combined and then undergo the second transformation. In either case, the end result should be the same.

In the example described above, in step 1131 core 0 performed the first transformation. However, in some examples the first transformation may be evaluated by more than one core in parallel.

In some examples, the input data or the transformed input data may be split in the S₁ dimensions as well as/instead of in the S₂ dimension.

It should be understood that the notation S₂ and S₂′ refer to the same dimension, the ′ symbol simply indicates that the size of the dimension may differ. The same applies for the other dimensions.

In some examples, it might not be necessary to perform the second transformation. For example, where the set of consecutive layers includes the penultimate layer of the neural network, the final layer of the neural network could also be mapped to a transformed layer that is configured to receive and process the output data of the set of transformed layers.

In some examples, the method 1100 may consist of steps 1110 and 1112 and 1118. In other words, steps 1111 and 1113-1117 are optional and some or all of these steps might not be performed.

In some examples, method 1101 may consist of steps 1120, 1121, 1131 and 1134. In other words, steps 1130, 1132, 1133, 1133a, 1135 and 1136 are optional and one or more of these steps might not be performed.

Any of the method of tile group interleaved batching, batch-to-space batching and pass interleaved batching may be used to process image data and/or audio data. In other words, the input data for any of the methods described in the application may comprise image data and/or audio data. Any of the hardware implementations described above may be implemented using fixed function hardware. “Fixed-function” in this context refers to the property of the hardware that the logic it implements cannot be reconfigured after manufacture (or at least cannot be reconfigured extensively). This is in contrast to field programmable logic, for example, which is reconfigurable.

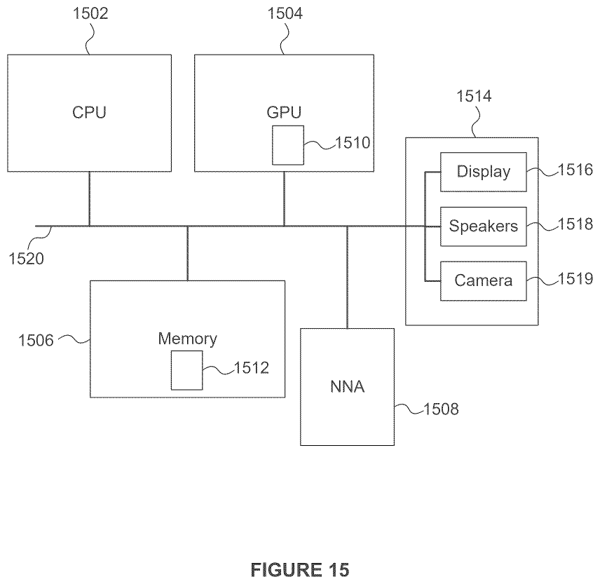

FIG. 15 shows a computer system in which the graphics processing systems described herein may be implemented. The computer system comprises a CPU 1502, a GPU 1504, a memory 1506, a neural network accelerator (NNA) 1508 and other devices 1514, such as a display 1516, speakers 1518 and a camera 1522. Any of hardware implementations 401, 701 and 1002 may be implemented in processing block 1510 on the GPU 1504. In other examples, one or more of the depicted components may be omitted from the system, and/or the processing block 1510 may be implemented on the CPU 1502 or within the NNA 1508. The components of the computer system can communicate with each other via a communications bus 1520. A store 1512 (corresponding to any of memories 420, 720 and 1005) is implemented as part of the memory 1506. Computing devices 410, 710 and 1001 may be implemented on CPU 1502.

The hardware implementations of FIGS. 4, 7 and 10 are shown as comprising a number of functional blocks. This is schematic only and is not intended to define a strict division between different logic elements of such entities. Each functional block may be provided in any suitable manner. It is to be understood that intermediate values described herein as being formed by a hardware implementation need not be physically generated by the hardware implementation at any point and may merely represent logical values which conveniently describe the processing performed by the hardware implementation between its input and output.

The hardware implementations described herein may be embodied in hardware on an integrated circuit. The hardware implementations described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, computing device, hardware implementation or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors. The hardware implementations described in this application may be implemented in a GPU or NNA. The hardware implementations described in this application may be implemented in fixed-function hardware.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a hardware implementation configured to perform any of the methods described herein, or to manufacture a hardware implementation comprising any apparatus described herein. An integrated circuit definition dataset may be, for example, an integrated circuit description.

Therefore, there may be provided a method of manufacturing, at an integrated circuit manufacturing system, a hardware implementation, NNA or GPU as described herein. Furthermore, there may be provided an integrated circuit definition dataset that, when processed in an integrated circuit manufacturing system, causes the method of manufacturing a hardware implementation, NNA or GPU to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

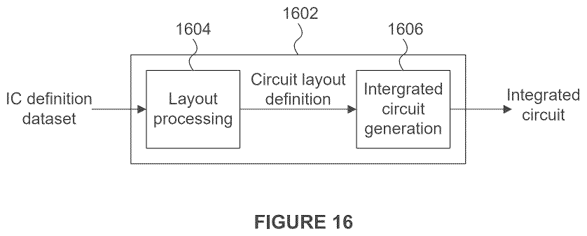

An example of processing an integrated circuit definition dataset at an integrated circuit manufacturing system so as to configure the system to manufacture a hardware implementation, NNA or GPU will now be described with respect to FIG. 16.

FIG. 16 shows an example of an integrated circuit (IC) manufacturing system 1602 which is configured to manufacture a hardware implementation, NNA or GPU as described in any of the examples herein. In particular, the IC manufacturing system 1602 comprises a layout processing system 1604 and an integrated circuit generation system 1606. The IC manufacturing system 1602 is configured to receive an IC definition dataset (e.g. defining a hardware implementation, NNA or GPU as described in any of the examples herein), process the IC definition dataset, and generate an IC according to the IC definition dataset (e.g. which embodies a hardware implementation, NNA or GPU as described in any of the examples herein). The processing of the IC definition dataset configures the IC manufacturing system 1602 to manufacture an integrated circuit embodying a hardware implementation, NNA or GPU as described in any of the examples herein.

The layout processing system 1604 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1604 has determined the circuit layout it may output a circuit layout definition to the IC generation system 1606. A circuit layout definition may be, for example, a circuit layout description.

The IC generation system 1606 generates an IC according to the circuit layout definition, as is known in the art. For example, the IC generation system 1606 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1606 can use to form a suitable mask for use in generating an IC.

The different processes performed by the IC manufacturing system 1602 may be implemented all in one location, e.g. by one party. Alternatively, the IC manufacturing system 1602 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a hardware implementation, NNA or GPU without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 16 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 16, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description, it will be evident to a person skilled in the art that various modifications may be made within the scope of the invention.

Also disclosed are the following embodiments:
A1. A method (1101) of evaluating a neural network (1200) comprising a plurality of layers, wherein:
the plurality of layers comprises a set of consecutive layers consisting of C″×1×1 generating layers; and
the C″×1×1 generating layers are layers of the neural network that produce a multidimensional tensor having dimensions [N, C″, . . . ,1, 1] as their output,
   the method comprising:
obtaining (1120) a control stream defining a set of transformed layers, the set of transformed layers comprising a first transformation operation and a set of consecutive transformed layers, wherein the set of consecutive transformed layers corresponds to the set of consecutive layers;
obtaining (1121) input data for the set of consecutive layers, wherein the input data is a multidimensional tensor having dimensions [N>1, C, . . . , S₁, S₂];
performing (1131) a first transformation on the input data according to the first transformation operation to produce transformed input data, wherein the transformed input data has dimensions

$$[ {N}^{′} = 1 , {C}^{′} , … , {S}_{1}^{′} , {S}_{2}^{′} > 1 ] ,$$

wherein performing the first transformation comprises performing (1133) a batch-to-space operation; and
evaluating (1134) the set of consecutive layers by processing the transformed input data through the set of consecutive transformed layers to produce output data of the set of consecutive transformed layers;
wherein processing the transformed input data through the set of consecutive transformed layers is performed in parallel by at least PEᵢ>1 processing elements of a first core (1020), and wherein each processing element processes a different line of the transformed input data in the S₂ dimension.
   A2. The method of A1, further comprising performing (1135) a space-to-batch operation on the output data of the set of consecutive transformed layers to provide output data of the set of consecutive layers, wherein the output data of the set of consecutive layers has dimensions [N, C″, 1, 1].
   A3. The method of any one of the preceding embodiments, wherein:

$${S}_{1}^{′} = blockheight \times ω ;$$

$${S}_{2}^{′} = blockwidth \times θ ;$$

$$blockheight = ceiling ( \frac{N}{{PE}_{i}} ) ;$$

$$blockwidth = ceiling ( \frac{N}{blockheight} ) ;$$

$${N}_{PE} \geq {PE}_{i} > 1 ;$$

and
N_{PE} is the number of processing elements present in at least the first core.
   A4. The method of A3, wherein the first transformation comprises padding the batch dimension of the input data for the set of consecutive layers so that N % (blockheight×blockwidth)=0.
   A5. The method of any one of A3-A4, wherein processing the transformed input data through the set of consecutive transformed layers comprises:
processing, by the first core, a first subset of the transformed input data through the set of consecutive transformed layers; and
processing, by a second core, a second subset of the transformed input data through the set of consecutive transformed layers,
   wherein the first subset of the transformed input data and the second subset of the input data comprise different elements of the transformed input data in the S₁ dimension.
   A6. The method of any one of A3-A5, further comprising:
obtaining at least a first subset of parameter data and a second subset of parameter data for the set of transformed layers, wherein the parameter data comprises data having dimensions [N_{f}, C_{f}, . . . , S_{1f}, S_{2f}] and wherein the first subset of parameter data and the second subset of parameter data comprise different elements of data in the N dimension;
processing (1134a), by the first core, the transformed input data through the set of consecutive transformed layers using the first subset of parameter data; and
processing (1134b), by a second core, the transformed input data through the set of consecutive transformed layers using the second subset of parameter data.
   A7. The method of any of the preceding embodiments, wherein the set of consecutive layers consists of any one or combination of:
one or more fully connected layers, wherein each fully connected layer is configured to receive input data having spatial dimensions of size S_{1_FC} and S_{2_FC};
one or more convolution layers, wherein each convolution layer is configured to receive input data having spatial dimensions of size S_{1_Conv} and S_{2_Conv};
one or more element-wise operation layers;
one or more activation layers;
one or more batch normalisation layers;
a pooling layer; wherein the pooling layer is configured to receive input data having spatial dimensions of size S_{1_Pool} and S_{2_Pool}, and is configured to perform pooling using a kernel having a kernel height K_{h_Pool} and a kernel width K_{w_Pool}; and
a global pooling layer.
   A8. The method of A7, wherein a first layer of the set of consecutive layers is one of:
a fully connected layer configured to receive input data having spatial dimensions of size S_{1_FC}=1 and S_{2_FC}=1;
the pooling layer;
the global pooling layer;
a 2D convolution layer; and
a depth-wise convolution layer, and
   wherein the set of consecutive layers further consists of any one or combination of:
one or more 1×1 convolution layers;
one or more batch normalisation layers;
one or more activation layers having an input resolution of 1×1; and
one or more element-wise operation layers having an input resolution of 1×1.
   A9. The method of any of A7-A8, wherein the set of consecutive transformed layers corresponds to the set of consecutive layers in the following ways:
each fully connected layer in the set of consecutive layers corresponds to a convolution layer in the set of consecutive transformed layers having a kernel height K_{hT_Conv}=1, a kernel width K_{wT_Conv}=1 and a stride of S_{1_FC}, S_{2_FC} in the spatial dimensions;
each convolution layer in the set of consecutive layers corresponds to a convolution layer in the set of consecutive transformed layers having a kernel size K_{hT_Conv}, K_{wT_Conv}=1 and a stride of S_{1_Conv}, S_{2_Conv}, in the spatial dimensions; and
each pooling layer in the set of consecutive layers corresponds to a pooling layer in the set of consecutive transformed layers having a stride of S_{1_Pool}, S_{2_Pool} in the spatial dimensions, respectively.
   A10. The method of any of the preceding embodiments, wherein S₁>1 and/or S₂>1, and wherein performing the first transformation comprises:
performing (1132) a space-to-depth operation on the input data for the set of consecutive layers to provide intermediate input data having dimensions [N, C′, . . . , 1, 1]; and
performing the batch-to-space operation of the intermediate input data to provide the transformed input data.
   A11. The method of any of the preceding embodiments, wherein the control stream defines a tile group consisting of the set of transformed layers and wherein the tile group is evaluated by performing the first transformation and processing the transformed input data through the set of transformed layers.
   A12. A hardware implementation (1002) of a neural network (1200), the neural network comprising a plurality of layers, wherein:
the plurality of layers comprises a set of consecutive layers consisting of C″×1×1 generating layers; and
the C″×1×1 generating layers are layers of the neural network that produce as an output a multidimensional tensor having dimensions [N, C″, . . . ,1, 1],
   the hardware implementation comprising:
a data retrieval unit (1010), configured to obtain input data for the set of consecutive layers and a control stream defining a set of transformed layers comprising a first transformation operation and a set of consecutive transformed layers, wherein the set of consecutive transformed layers corresponds to the set of consecutive layers, wherein the input data is a multidimensional tensor having dimensions [N>1, C, . . . , S₁, S₂]; and
a first core (1020) comprising a plurality of processing elements (1021, 1022, 1023, 1024), wherein the first core is configured to:
   perform a first transformation on the input data according to the first transformation operation to produce transformed input data, wherein the transformed input data has dimensions

$$[ {N}^{′} = 1 , {C}^{′} , … , {S}_{1}^{′} , {S}_{2}^{′} > 1 ] ,$$

wherein the first transformation comprises batch-to-space operation; and
evaluate the set of consecutive layers by processing, in parallel using at least PEᵢ>1 of the plurality of processing elements, the transformed input data through the set of consecutive transformed layers to produce output data of the set of consecutive transformed layers, wherein each processing element processes a different line of the transformed input data in the S₂ dimension.
   A13. The hardware implementation of A12, wherein the first core is further configured to perform a space-to-batch operation on the output data of the set of consecutive transformed layers to provide output data of the set of consecutive layers, wherein the output data of the set of consecutive layers has dimensions [N, C″, 1, 1].
   A14. The hardware implementation of any of A12-A13, wherein:

$${S}_{1}^{′} = blockheight \times ω ;$$

$${S}_{2}^{′} = blockwidth \times θ ;$$

$$blockheight = ceiling ( \frac{N}{{PE}_{i}} ) ;$$

$$blockwidth = ceiling ( \frac{N}{blockheight} ) ; and$$

$${N}_{PE} \geq {PE}_{i} > 1 ;$$

and
N_{PE} is the number of processing elements present in at least the first core.
   A15. The hardware implementation of any of A12-A14, further comprising a second core (1030), wherein:
the first core is configured to process a first subset of the transformed input data through the set of consecutive transformed layers; and
the second core is configured to process a second subset of the transformed input data through the set of consecutive transformed layers; and
the first subset and the second subset of the input data comprise different elements of data in the S₁ dimension.

A16. The hardware implementation of any of A12-A15, wherein the set of consecutive layers consists of any one or combination of:
one or more fully connected layers, wherein each fully connected layer is configured to receive input data having spatial dimensions of size S_{1_FC} and S_{2_FC};
one or more convolution layers, wherein each convolution layer is configured to receive input data having spatial dimensions of size S_{1_Conv} and S_{2_Conv};
one or more element-wise operation layers;
one or more activation layers;
one or more batch normalisation layers;
a pooling layer; wherein the pooling layer is configured to receive input data having spatial dimensions of size S_{1_Pool} and S_{2_Pool}, and is configured to perform pooling using a kernel having a kernel height K_{h_Pool} and a kernel width K_{w_Pool}; and
a global pooling layer.
   A17. The hardware implementation of A16, wherein the set of consecutive transformed layers corresponds to the set of consecutive layers in the following ways:
each fully connected layer in the set of consecutive layers corresponds to a convolution layer in the set of consecutive transformed layers having a kernel height K_{hT_Conv}=1, a kernel width K_{wT_Conv}=1 and a stride of S_{1_FC}, S_{2_FC} in the spatial dimensions;
each convolution layer in the set of consecutive layers corresponds to a convolution layer in the set of consecutive transformed layers having a kernel size K_{hT_Conv}, K_{wT_Conv}=1 and a stride of S_{1_Conv}, S_{2_Conv}, in the spatial dimensions; and
each pooling layer in the set of consecutive layers corresponds to a pooling layer in the set of consecutive transformed layers having a stride of S_{1_Pool}, S_{2_Pool} in the spatial dimensions, respectively.
   A18. The hardware implementation of any one of A12-A17, wherein S₁>1 and/or S₂>1, and wherein the first transformation comprises:
a space-to-depth operation configured to provide intermediate input data having dimensions [N, C′, . . . , 1, 1]; and
the batch-to-space operation,
   wherein the first core is configured to:
perform the space-to-depth operation on the input data for the set of consecutive layers to produce the intermediate data; and
perform the batch-to-space operation on the intermediate data to produce the transformed input data.
   A19. A neural network accelerator or graphics processing system comprising the hardware implementation of any of A12-A18 and/or configured to perform the method of any of A1 to A11.
   A20. A computer-implemented method (1100) of generating a control stream for evaluating a neural network; the neural network comprising a plurality of layers, wherein:
the plurality of layers comprises a set of consecutive layers consisting of C″×1×1 generating layers;
the C″×1×1 generating layers are layers of the neural network that produce a multidimensional tensor having dimensions [ . . . , C″, . . . ,1, 1] as their output; and
the set of consecutive layers are configured to receive a multidimensional tensor having dimensions [N>1, C, . . . , S₁, S₂] as input data,
   the method comprising:
determining (1110) a first transformation operation configured to transform the input data into transformed input data having dimensions

$$[ {N}^{′} = 1 , {C}^{′} , … , {S}_{1}^{′} , {S}_{2}^{′} > 1 ] ,$$

wherein the first transformation comprises a batch-to-space operation;
mapping (1112) the set of consecutive layers to a set of consecutive transformed layers comprising the first transformation operation and the second transformation operation; and
generating (1118) a control stream defining a set of transformed layers, wherein the set of transformed layers comprises the first transformation operation and the set of consecutive transformed layers.
   A21. The method of A20, wherein mapping the set of consecutive layers to the set of consecutive transformed layers comprises any one or combination of:
for each fully connected layer in the set of consecutive layers, mapping the fully connected layer to a convolution layer having a kernel height K_{hT_Conv}=1, a kernel width K_{wT_Conv}=1 and a stride of S_{1_FC}, S_{2_FC} in the spatial dimensions;
for each convolution layer in the set of consecutive layers, mapping the convolution layer to a convolution layer having a kernel size K_{hT_Conv}, K_{wT_Conv}=1 and a stride of S_{1_Conv}, S_{2_Conv}, in the spatial dimensions; and
mapping the pooling layer to a pooling layer having a stride of S_{1_Pool}, S_{2_Pool} in the spatial dimensions, respectively.
   A22. The method of any of A20-A21, further comprising defining (1113) a first tile group, the first tile group consisting of one or more layers of the set of transformed layers, wherein the control stream defines the first tile group.
   A23. The method of A22, wherein the set of transformed layers further comprises a second transformation operation comprising a space-to-batch transformation, and wherein defining the first tile group comprises:
detecting (1114) the second transformation operation;
sequentially adding (1115) each preceding layer of the set of transformed layers up to and including the first transformation operation; and
terminating (1116) the first tile group.
   A24. The method of any of A23, wherein defining the first tile group further comprises at least one of:
(A) determining (1117) that a bandwidth requirement parameter_{BW} for obtaining parameter data for the first tile group is greater than γ×size_{OCM}, where size_{OCM} is a memory capacity of an on-chip memory device configured to store parameter data and γ is a configurable factor;
(B) determining that a size in memory size of a predicted largest intermediate tensor that would be produced by evaluating an alternative tile group containing the set of consecutive layers is greater than

$$\frac{{size}_{OCM} - {parameter}_{BW}}{ϵ} ,$$

and determining that parameter_{BW}<σ×size_{OCM}, wherein σ and ϵ are configurable variables; and
(C) determining that Count_{cycle}×(blockwidth−1)>transform_{cycles}×φ, wherein φ is a configurable variable, Count_{cycle} is an estimation of a number of computing cycles needed to execute the first tile group, and transform_{cycles} is an estimation of a number of computing cycles needed to perform the first transformation and optionally the space-to-batch transformation,
   and wherein processing input data for the set of consecutive layers through the first tile comprises reading the parameter data from the on-chip memory.
   A25. A method of manufacturing, using an integrated circuit manufacturing system, a hardware implementation as specified in any of A12-18 or a graphics processing system or neural network accelerator as specified in A19.
   A26. Computer readable code configured to cause the method of any of embodiments A1-A12 or A20-A24 to be performed when the code is run.
   A27. A computer readable storage medium having encoded thereon the computer readable code of A26.
   A28. An integrated circuit definition dataset that, when processed in an integrated circuit manufacturing system, configures the integrated circuit manufacturing system to manufacture a hardware implementation as specified in any of A12-A18 or a neural network accelerator or graphics processing system as specified in A19.
   A29. An integrated circuit manufacturing system configured to manufacture a hardware implementation as specified in any of A12-A18 or a neural network accelerator or graphics processing system as specified in A19.
   A30. A computing device (1001) comprising means for performing the method of any of A20-A24.
   C1. A method (801) of evaluating a neural network, the neural network comprising a plurality of layers, the method comprising:
obtaining (830) a control stream defining a layer group, the layer group consisting of one or more consecutive layers of the neural network;
providing (820), in a first memory device, input data for the layer group and parameter data for the layer group, wherein the input data is a multidimensional tensor having dimensions [N>1, C, . . . , H, W] and comprises at least a first instance and a second instance of data, each instance of data having dimensions [1, C, . . . , H, W];
storing (840, 841), in a second memory device, a first subset of parameter data, wherein the first subset of parameter data does not contain all the parameter data for the layer group;
performing, by a first core (750), a first pass (850) through the layer group by processing the first instance through the layer group using the first subset of parameter data stored in the second memory device; and
re-using the first subset of parameter data stored in the second memory device by performing, by the first core (750), a second pass (855) through the layer group by processing the second instance through the layer group using the first subset of parameter data stored in the second memory device,
wherein the second memory device has a lower cost to access than the first memory device.
   C2. The method of C1, further comprising:
storing (880), in a third memory device, a second subset of parameter data;
performing, by a second core (751), a third pass (881) through the layer group by processing the first instance through the layer group using the second subset of parameter data stored in the third memory device; and
re-using the second subset of parameter data stored in the third memory device by performing, by the second core (751), a fourth pass (883) through the layer group by processing the second instance through the layer group using the second subset of parameter data stored in the third memory device,
wherein the third memory device has a lower cost to access than the one or more first memory devices.
   C3. The method of any of the preceding embodiments, wherein each pass through the layer group performed by the first core uses the first subset of parameter data stored in the second memory device.
   C4. The method of any of C1-C2, wherein the method further comprises:
discarding (856, 870, 882) the first subset of parameter data stored in the second memory device;
storing (880) a third subset of parameter data in the second memory device; and
after completing the second pass, performing, by the first core, a fifth pass (857) through the layer group by processing the first or second instance through the layer group using the third subset of parameter data stored in the second memory device.
   C5. The method of any of the preceding embodiments, wherein:
the parameter data for the layer group comprises a tensor having dimensions [N_{f}, C_{f}, . . . , H_{f}, W_{f}];
the first subset of parameter data comprises a first subset of the tensor in the batch dimension; and
the second subset of parameter data comprises a second subset of the tensor in the batch dimension.
   C6. The method of C5, wherein performing the first pass (850) through the layer group comprises: processing a first subset of the first instance through the layer group in a first sub-pass (851) using the first subset of parameter data stored in the second memory device, to produce a first partial result;
storing (852), in an on-chip memory, the first partial result;
processing a second subset of the first instance through the layer group in a second sub-pass (853) using the first subset of parameter data stored in the second memory device, to produce a second partial result; and
combining (854) the first partial result and the second partial result to produce accumulated output data.
   C7. The method of C6, wherein performing the first pass (850) through the layer group further comprises:
processing, by the first core in a series of consecutive sub-passes, all subsets of the first instance through the layer group using the first subset of parameter data stored in the second memory device, to produce a set of partial results; and
combining the set of partial results.
   C8. The method of C7, wherein:
performing the first pass through the layer group further comprises storing, in the on-chip memory, the accumulated output data; and
combining the set of partial results comprises:
   for each sub-pass after the second sub-pass:
      obtaining the accumulated output data;
      updating the accumulated output data by combining the accumulated output data with output data of the current pass; and
      storing the updated accumulated output data.
         C9. The method of any of C7-C8, further comprising:
comparing a size in memory of the accumulated output data with a threshold; and
if the size in memory of the accumulated output data exceeds the threshold, either:
   stopping execution of the first layer group; or
   storing the accumulated output data in a memory device other than the on-chip memory.
      C10. The method of any of C6-C9, wherein each subset of the first instance is processed through the layer group by the first core.
      C11. A hardware implementation (701) of a neural network, the neural network comprising a plurality of layers, the hardware implementation comprising:
a data retrieval unit (735) configured to obtain a control stream defining a layer group of the neural network, the layer group consisting of one or more consecutive layers of the neural network;
a first memory device (720) configured to store input data for the layer group and parameter data for the layer group, wherein the input data is a multidimensional tensor having dimensions [N>1, C, . . . , H, W] and comprises at least a first instance and a second instance of data, each instance of data having dimensions [1, C, . . . , H, W];
a second memory device (730, 770) configured to store a first subset of parameter data; and
a first core (750) configured to:
   in a first pass, process the first instance through the layer group using the first subset of parameter data stored in the second memory device; and
   in a second pass, process the second instance through the layer group using the first subset of parameter data stored in the second memory device,
      wherein:
the second memory device (730, 770, 771) is configured to maintain the first subset of parameter data at least until after the start of the second pass, thereby re-using the first subset of parameter data stored in the second memory device; and
the second memory device (730, 770, 771) has a lower cost to access than the first memory device (720).
   C12. The hardware implementation (701) of C11, further comprising a second core (751) and a third memory device (730, 771), wherein:
the third memory device (730, 771) is configured to store the second subset of parameter data;
the second core (751) is configured to:
   in a third pass, process the first instance through the layer group using the second subset of parameter data stored in the third memory device (730, 771); and
   in a fourth pass, process the second instance through the layer group using the second subset of parameter data stored in the third memory device (730, 771);
the third memory device (730, 771) is configured to maintain the second subset of parameter data during the third pass and at least until after the start of the fourth pass, thereby re-using the second subset of parameter data stored in the third memory device; and
the third memory device (730, 771) has a lower cost to access than the first memory device (720).
   C13. The hardware implementation (701) of any of C11-C12, wherein:
the parameter data for the layer group comprises a tensor having dimensions [N_{f}, C_{f}, . . . , H_{f}, W_{f}];
the first subset of parameter data comprises a first subset of the tensor in the batch dimension; and
the second subset of parameter data comprises a second subset of the tensor in the batch dimension.
   C14. The hardware implementation (701) of C13 wherein:
the first core (750) is configured to:
   process a first subset of the first instance through the layer group in a first sub-pass using the first subset of parameter data stored in the second memory device (730, 770), to produce a first partial result;
   process a second subset of the first instance through the layer group in a second sub-pass using the first subset of parameter data stored in the second memory device (730, 770), to produce a second partial result; and
   combine the first partial result and the second partial result to produce accumulated output data, and
the hardware implementation further comprises an on-chip memory (730, 770) configured to store the first partial result.
   C15. The hardware implementation (701) of C14, wherein the first core (750) is configured to:
compare a size in memory of the accumulated output data with a threshold; and
if the size in memory of the accumulated output data exceeds the threshold either:
   stop execution of the first layer group; or
   store the accumulated output data in a memory device other than the on-chip memory.
      C16. A neural network accelerator or graphics processing system configured to perform the method of any of C1 to C10 and/or comprising the hardware implementation of any of C11-C15.
      C17. A method of manufacturing, using an integrated circuit manufacturing system, a hardware implementation as specified in any of C11-C15 or neural network accelerator or graphics processing system as specified in C16.
      C18. A computer-implemented method (800) of generating a control stream for evaluating a neural network, the neural network comprising a plurality of layers, the method comprising:
obtaining (810) a layer group, the layer group consisting of one or more consecutive layers of the neural network, wherein input data (300) for the layer group is a multidimensional tensor having dimensions [N>1, C, . . . , H, W] and comprises at least a first instance (310) and a second instance (320) each having dimensions [1, C, . . . , H, W]; and
generating (814) a control stream defining the layer group and comprising an instruction to:
   obtain a first subset of parameter from a first memory device and store the first subset of parameter data in a second memory device, wherein the second memory device has a lower cost to access than the first memory device;
   perform a first pass through the layer group by processing the first instance through the layer group using the first subset of parameter data stored in the second memory device; and
   re-use the first subset of parameter data stored in the second memory device to perform a second pass through the layer group by processing the second instance through the layer group using the first subset of parameter data stored in the second memory device.
      C19. The method of C18, further comprising detecting (811) that the parameter data for the layer group has a size in memory greater than a threshold and splitting (812) the parameter data for the layer group into the first subset of parameter data and a second subset of parameter data in response to the detecting.
      C20. The method of any of C18-C19, wherein:
the parameter data comprises a tensor having dimensions [N_{f}, C_{f}, . . . , H_{f}, W_{f}]; and
the parameter data is split in the batch dimension such that the first subset of parameter data comprises a first subset of the tensor in the batch dimension and the second subset of parameter data comprises a second subset of the tensor in the batch dimension.
   C21. The method of C20, further comprising splitting (813) the first instance of input data in the channel dimension into at least a first subset of the first instance and a second subset of the second instance.
   C22. Computer readable code configured to cause the method of any of C1 to C10 or C18-C21 to be performed when the code is run.
   C23. A computer readable storage medium having encoded thereon the computer readable code of C22.
   C24. An integrated circuit definition dataset that, when processed in an integrated circuit manufacturing system, configures the integrated circuit manufacturing system to manufacture a hardware implementation as specified in any of C11-C15 or neural network accelerator or graphics processing system as specified in C16.
   C25. A computer readable storage medium having stored there on a computer readable description of a hardware implementation as specified in any of C11-C15 or neural network accelerator or graphics processing system as specified in C16 that, when processed in an integrated circuit manufacturing system, causes the integrated circuit manufacturing system to manufacture an integrated circuit embodying the hardware implementation or neural network accelerator or graphics processing system.
   C26. An integrated circuit manufacturing system configured to manufacture a hardware implementation as specified in any of C11-C15 or neural network accelerator or graphics processing system as specified in C16.
   C27. A computing device (710) comprising means for performing the method of any of C18-C21.

What is claimed is:

1. A method of evaluating a neural network, the neural network including a plurality of layers, the method comprising:
obtaining a control stream defining a first tile group and a second tile group, wherein:
the first tile group consists of a first set of one or more consecutive layers of the neural network, and
the second tile group consists of a second, different, set of one or more consecutive layers of the neural network;
providing, in a first memory device, input data for the first tile group and parameter data for the first tile group, wherein the input data for the first tile group is a multidimensional tensor having dimensions [N>1, C, . . . , H, W] and comprises at least a first instance and a second instance each having dimensions [N=1, C, . . . , H, W];
storing, in a second memory device, the parameter data for the first tile group, wherein the second memory device has a lower cost to access than the first memory device;
processing the first instance of input data through the first tile group using the parameter data stored in the second memory device, to produce a first instance of output data; and
re-using the parameter data for the first tile group stored in the second memory device by processing the second instance of the input data through the first tile group using the parameter data stored in the second memory device to produce a second instance of output data.

2. The method of claim 1, further comprising storing, in the second memory device, parameter data for the second tile group, and after processing at least the first instance and the second instance through the first tile group:
discarding the parameter data for the first tile group stored in the second memory device; and
processing the first instance of output data through the second tile group using the parameter data for the second tile group stored in the second memory device.

3. The method of claim 2, wherein the parameter data for the first tile group stored in the second memory device is discarded after processing all instances of input data for the first tile group through the first tile group using the parameter data stored in the second memory device.

4. The method of claim 1, further comprising processing
$${P}_{I} = floor ( \frac{{N}_{C}}{{M}_{I}} )$$
instances of the input data through the first tile group in parallel, wherein:
each instance is processed by M_{I} of N_{C} cores; and
1≤M_{I}≤N_{C},
optionally wherein N % P_{I}=0, N≥P_{I} and N_{C}% M_{I}=0.

5. The method of claim 4, wherein:
N_{C}=M_{I}; or
M_{I}=1; or
1<M_{I}<N_{C}.

6. The method of claim 4, wherein M_{I}=1, the method further comprising:
processing, by a first core of the N_{C} cores, the first instance of input data through the first tile group; and
processing, by a second core of the N_{C} cores, the second instance of input data through the first tile group,
wherein:
the first instance of input data and the second instance of input data are processed through the first tile group in parallel;
processing the first instance of input data through the first tile group comprises:
processing the first instance of input data through a first layer group of the first tile group to produce first intermediate data;
storing the first intermediate data in a third memory device, wherein the third memory device is only accessible to the first core and has a lower cost to access than the first memory device;
reading, by the first core from the third memory device, the first intermediate data; and
processing the first intermediate data through a second layer group of the first tile group, and
processing the second instance of input data through the first tile group comprises:
processing the second instance of input data through the first layer group of the first tile group to produce second intermediate data;
storing the second intermediate data in a fourth memory device, wherein the fourth memory device is only accessible to the second core and has a lower cost to access than the first memory device;
reading, by the second core from the fourth memory device, the second intermediate data; and
processing the second intermediate data through the second layer group of the first tile group.

7. The method of claim 4, wherein N % P_{I}=0, N≥P_{I}, N_{C}% M_{I}=0, 1<M_{I}<N_{C} and P_{I}>1, the method further comprising:
obtaining M_{I} parts of the first instance of input data,
obtaining M_{I} parts of the second instance of input data; and
processing, in parallel, each part of the first instance of input data and the second instance of input data through the first tile group.

8. The method of claim 4, wherein M_{I}=N_{C}, the method further comprising:
obtaining (560a) M_{I} parts of the first instance of input data for the first tile group; and
processing in parallel, by each of M_{I} cores, a different part of the first instance of input data for the first tile group through the first tile group.

9. A hardware implementation of a neural network, the neural network including a plurality of layers, the hardware implementation comprising:
a data retrieval unit, configured to obtain a control stream defining a first tile group and a second tile group of the neural network, wherein:
the first tile group consists of a first set of one or more consecutive layers of the neural network,
the second tile group consists of a second, different, set of one or more consecutive layers of the neural network, and
input data for the first tile group and parameter data for the first tile group are stored in a first memory device, wherein the input data for the first tile group is a multidimensional tensor having dimensions [N>1, C, . . . , H, W], and comprises a first instance and a second instance each having dimensions [N=1, C, . . . , H, W];
a second memory device, configured to store the parameter data for the first tile group, wherein the second memory device has a lower cost to access than the first memory device; and
one or more cores, configured to:
process the first instance of the input data through the first tile group using the parameter data for the first tile group stored in the second memory device to produce a first instance of output data, and
re-use the parameter data for the first tile group stored in the second memory device to process the second instance of the input data through the first tile group to produce a second instance of output data.

10. The hardware implementation of claim 9, wherein:
the one or more cores comprises N_{C}>1 cores;
the hardware implementation is configured to:
allocate N_{C} cores for evaluation of the neural network, wherein N_{C}>1; and
choose a number M_{I} of cores to process, in parallel, a given instance of the input data through the first tile group, wherein 1≤M_{I}≤N_{C};
determine a number P_{I} of instances of the input data for the first tile group to process in parallel through the first layer group, wherein
$${P}_{I} = floor ( \frac{{N}_{C}}{{M}_{I}} ) ,$$
wherein the N_{C} cores are configured to process
$${P}_{I} = floor ( \frac{{N}_{C}}{{M}_{I}} )$$
instances of the input data through the first layer group in parallel;
each instance is processed by M_{I} of N_{C} cores; and
1≤M_{I}≤N_{C}.

11. The hardware implementation of claim 10, wherein the N_{C} cores comprise at least a first core and a second core, and wherein the hardware implementation comprises:
a third memory device only accessible to the first core and having a lower cost to access than the first memory device; and
a fourth memory device only accessible to the second core and having a lower cost to access than the first memory device,
wherein:
M_{I}=1
the first core is configured to:
process the first instance of input data for the first tile group through a first layer group of the first tile group to produce first intermediate data;
store the first intermediate data in the third memory device;
read the first intermediate data from the third memory device; and
process the first intermediate data through a second layer group of the first tile group; and
the second core is configured to:
process the second instance of input data for the first tile group through the first layer group of the first tile group to produce second intermediate data;
store the second intermediate data in the fourth memory device;
read the second intermediate data from the fourth memory device; and
process the second intermediate data through the second layer group of the first tile group.

12. The hardware implementation of claim 10, wherein:
1<M_{I}≤N_{C}
the hardware implementation is configured to obtain M_{I} parts of the first instance of input data; and
each of the M_{I} cores is configured to process a different part of the first instance of input data through the first tile group.

13. A method of manufacturing, using an integrated circuit manufacturing system, a hardware implementation as set forth in claim 9, the method comprising:
processing, using a layout processing system, a computer readable description of the hardware implementation so as to generate a circuit layout description of an integrated circuit embodying the hardware implementation; and
manufacturing, using an integrated circuit generation system, the hardware implementation according to the circuit layout description.

14. A computer-implemented method of generating a control stream for evaluating a neural network, the neural network comprising a plurality of layers, the method comprising:
obtaining a first tile group, the first tile group consisting of a first set of one or more consecutive layers of the neural network, wherein input data for the first tile group is a multidimensional tensor having dimensions [N>1, C, . . . , H, W] and comprises at least a first instance and a second instance each having dimensions [N=1, C, . . . , H, W];
obtaining a second tile group, the second tile group consisting of a second, different, set of one or more consecutive layers of the neural network; and
generating a control stream defining the first tile group, the second tile group and comprising an instruction to:
process the first instance of the input data through the first tile group using the parameter data for the first tile group stored in the second memory device to produce a first instance of output data, and
re-use the parameter data for the first tile group stored in the second memory device to process the second instance of the input data through the first tile group using the parameter data for the first tile group stored in the second memory device to produce a second instance of output data.

15. The method of claim 14, further comprising:
choosing a number M_{I} of N_{C} cores to process, in parallel, a given instance of the input data through the first tile group, wherein 1≤M_{I}≤N_{C}; and
determining a number P_{I} of instances of the input data for the first tile group to process in parallel through the first tile group, wherein
$${P}_{I} = floor ( \frac{{N}_{C}}{{M}_{I}} ) ,$$
wherein the control stream comprises an indication of M_{I} and P_{I}.

16. The method of claim 14, wherein M_{I} is chosen such that N % P_{I}=0, N≥P_{I} and N_{C}% M_{I}=0,
optionally wherein:
1<M_{I}<N_{C} and P_{I}>1; and
the method further comprises:
splitting the first instance of input data into M_{I} parts, and
splitting the second instance of input data into M_{I} parts.

17. The method of claim 14, wherein M_{I}=N_{C}, the method further comprising splitting the first instance of input data for the first tile group into M_{I} parts.

18. A non-transitory computer readable storage medium having stored thereon computer readable code configured to cause the method of claim 1 to be performed when the code is run.

19. A non-transitory computer readable storage medium having stored thereon computer readable code configured to cause the method of claim 14 to be performed when the code is run.

20. An integrated circuit manufacturing system configured to manufacture a hardware implementation as set forth in claim 9, the integrated circuit manufacturing system comprising:
a non-transitory computer readable storage medium having stored thereon a computer readable description of the hardware implementation;
a layout processing system configured to process the computer readable description so as to generate a circuit layout description of an integrated circuit embodying the hardware implementation; and
an integrated circuit generation system configured to manufacture the hardware implementation according to the circuit layout description.
